(19) United States
(12) Patent Application Publication
(10) Pub. No.: US 2017/0357943 A1
(43) Pub. Date: Dec. 14, 2017

(54) METHOD AND APPARATUS FOR INTEGRATING AUTOMATED WORKFORCE MANAGEMENT SYSTEMS AND WORK INTERMEDIATION PLATFORMS

(71) Applicant: BEELINE.COM, Jacksonville, FL (US)

(72) Inventors: Colleen TINER, Atlantic Beach, FL (US); William Atkins, Jacksonville, FL (US); Christopher Stoner, Jacksonville, FL (US)

(73) Assignee: BEELINE.COM, Jacksonville, FL (US)

(21) Appl. No.: 15/177,098

(22) Filed: Jun. 8, 2016

(51) Int. Cl. G06Q 10/10; H04L 29/08

(52) U.S. Cl. CPC G06Q 10/1053; H04L 67/12

(57) ABSTRACT

A system assumes control over selected functionality in servers configured as a computerized work management systems (WMSs) and other servers configured as computerized work intermediation platforms (WIPs) to form communication channels therebetween. The system includes an integration platform responsive to actions at the WMS and the WIPs to communicate all data originating at the WMS and destined for the WIPs, and to communicate all data originating at the WIPs and destined for the WMS. The platform provides the WMSs with a set of same protocols and the WIPs with another set of same protocols for establishing the data communication channels with the platform as an intermediary. The system also includes an agent that embeds a sourcing GUI into the GUI suite of the WMS, and a talent architecture hosted on another server remote from those of the WMSs and the WIPs that responds to the sourcing GUI.

### RELATED APPLICATIONS

This application claims the benefit of U.S. Provisional Application No. 62/172,745, filed Jun. 8, 2015; and U.S. Provisional Application No. 62/173,122, filed Jun. 9, 2015, both of which are incorporated herein by reference.

### FIELD OF THE INVENTION

The invention relates generally to computer networks, and more particularly to a system and a method for establishing channels of communication between a special purpose server maintained in a restricted environment within a company engaged in hiring or by a software vendor contracted by a company which is engaged in hiring and publically accessible servers accessible to talented professionals seeking employment but inaccessible to the special purpose server used by the hiring company. The invention also relates to directing communications in a highly efficient way once the channels have been opened.

### BACKGROUND OF THE INVENTION

Competition for talent is fierce. While workforce capabilities are rated one of the top five most important organizational challenges today, 61% of companies are struggling to find skilled workers. These companies are experiencing delays in filling high-demand positions, with the average time-to-fill exceeding 25 calendar days. They also are facing rising talent costs with an overall wage increase of around 10% since 2006, and 3% year over year since 2012 in Information Technology (IT) alone.

Traditionally, enterprise companies that use a managed services provider (MSP), vendor management system (VMS) or the like have relied almost exclusively on staffing and service suppliers to fulfill at least their contingent workforce needs. Using the IT field again as an example, we find that the average markup, namely the cost of recruiting and paying, that is charged by a staffing company in the United States for a contingent worker is 42% or higher. Moreover, the suppliers themselves are fishing from the same “human capital ponds” (e.g. Linkedin® and Facebook®) as their competitors, and these ponds are being fished dry. By solely outsourcing the process of finding talent to suppliers, companies are limiting their pipeline of available qualified talent, missing opportunities to lower their total talent cost, and struggling to meet the resource demands of their business.

FIGS. 1 and 2 are network diagrams that show two exemplary environments for which the present invention establishes new channels of communication. We will refer to a hiring company's MSP, VMS and the like as integrated in a Work Management System (WMS). FIG. 1 shows exemplary hiring company 10 with a WMS 12 hosted on a server 20. It is understood that company 10 could license WMS 12 such that the WMS would not reside at the company but instead company 10 would access the WMS remotely. WMS 12 is shown to include a master controller 22 (e.g. CPU), memory 24, display manager 26, database interface 28, a restricted network communications interface 30, hiring functionality 32, contract work management functionality 34, managing processor 36, and one or more secure workstations 14a, 14b connected to the server through the communications interface over the internet or a local area network (LAN) 16. Interface 28 accesses databases 18a, 18b, the contents of which and processing of data from which generally are proprietary to hiring company 10 and so access to WMS 12 generally is restricted to authorized users within the company. Database 18a contains proprietary data related to hiring and employment, such data including a description of and requirements for each position required by the company 10, onboarding requirements for such position for filling the position, form contracts, forms for altering contracts and the like. Database 18b could comprise accounting records, customer lists, and other routine proprietary business data. Hiring functionality 32 contains business rules for evaluating among different job applicants, referred to as candidates, for a particular job to select and hire qualified candidates, and, frequently, further rules for distinguishing among such candidates. Hiring functionality 32 also contains business rules for evaluating responses from professionals for an “RFx”, which is a request for information, a request for proposal and the like, and responses from professionals for a statement of work (SOW). A RFx may be used to determine which professional should be engaged in a SOW in order to have project based work fulfilled. Contract work management functionality 34 contains business rules for managing the necessary fulfillment and alterations of contingent contract jobs and contract SOW engagements.

Limited access to WMS 12 is granted to authorized talent suppliers 50a, 50b, and 50c over the internet through communications interface 30. This is so that the hiring company 10 can publish job opportunities, RFxs, SOWs, hereafter collectively referred to as work opportunities, and their requirements to its traditional suppliers, and the suppliers can respond with suggested candidates, responses to RFxs, and responses to SOWs. Otherwise, public access by individuals and other machines is denied. These restrictions, however, also block access to new platforms increasingly used by skilled individuals in searching for permanent job opportunities, contingent job opportunities and SOW engagements.

FIG. 2 is a network diagram of a very important new platform known as a Work Intermediation Platform (WIP). WIPs have been described as a digital infrastructure that enables business users from hiring companies to directly locate and engage available talent to perform work for a specific time and cost. In FIG. 2, exemplary WIP 100 is shown as networking plural hiring companies 10a, 10b, 10c with each other and with hundreds or thousands of individuals (professionals) who are seeking job opportunities over the internet via personal client devices 120a, 120b, 120c etc. such as cellular phones, personal computers, tablets, personal digital assistants and the like. Each individual job seeker becomes a user, e.g. subscriber, at WIP 100 by opening an account on the WIP to publish his or her credentials and availability for work. WIPs represent a fundamental shift in how talented individuals now engage for work. For example, they are available to retirees hoping to become independent workers, as well as Generation Y workers or millennials with entrepreneurial ambitions. WIPs tend to cater to a workforce focused less on long term, full-time relationships and more on short term opportunities and experiences across different companies, geographies, and in some cases skill sets.

Exemplary WIP 100 includes a server 102 and a database 111. Server 102 includes a managing processor 104 (e.g. CPU), memory 106, hiring functionality 107, a display manager 108, contract work management functionality 109, controller 110 and a communications interface 105 for linking the WIP to the internet. WIP display manager 108 has, in addition to other functions, the function of creating graphical user interfaces on the client devices 120a, 120b etc. within their WIP subscriber accounts. Similar to that for WMS 12, WIP hiring functionality 107 contains business rules for evaluating among different applicants for a particular job to select and hire qualified candidates, and, frequently, further rules for distinguishing among such candidates. Hiring functionality 107 also contains business rules for evaluating responses from professionals to an RFx and responses from professionals to a statement of work (SOW). Contract work management functionality 109 contains business rules for managing the necessary fulfillment and alterations of contingent contract jobs and contract SOW engagements.

Database 111 stores profile data from the subscriber job seekers with accounts. The profile data identifies each professional and represents at least the professional's skills and experience. The profile data for each subscribing professional is made available to subscribing hiring companies that connect to the WIP 100 over the internet. Database 111 also stores job opportunities, RFxs and SOWs entered into the WIP by hiring companies. At the same time, job opportunities, RFxs and SOWs that are entered into the WIP by a hiring company are published by the WIP 100 to be accessible on the plural job seekers' personal client devices 120a, 120b etc. Publication on WIP 100 routinely identifies the company along with provision of a description of the work opportunity and the required skill set or qualifications. The platform now known as a WIP is relatively new, and up to now, due to the high security protections that hiring companies require for their WMS systems, direct system to system integration to WIPs like WIP 100 and like talent platforms, has been prohibited—to the detriment of these hiring companies in their searches for qualified workers.

### SUMMARY OF THE INVENTION

The present invention provides a fully interconnected system of WMSs used by hiring companies and the disparate WIPs increasingly preferred by job seekers. It vastly increases the pool of talented professionals available to hiring companies with specific needs for contractors and employees by enabling and automating communications between each WMS and the WIPs. To do this, it improves conventional computer-based systems used by hiring companies by configuring them so as to systematically access talent pools available at the WIPs that up to now have been unavailable to them. Yet it accomplishes this without compromising tight security over proprietary data processed by the WMS by providing an intermediary between WIPs accessible over the internet and WMS. The invention thereby enables the hiring companies to use their WMS systems to select from among job seekers and invite selected job seekers who are associated with different WIPs to apply for job opportunities, and to respond to RFxs and SOWs, as they become available. It further enables a hiring company, by use of its WMS, to automate the invitations of talent, negotiation of rates, negotiation of SOWs, onboarding processes, offboarding processes and billing and payment. The invention further contemplates carrying out these automated processes without interrupting the hiring company's customary referral relationships with its authorized talent suppliers.

The invention includes a server configured as a Work Integration Platform that connects multiple WMSs and WIPs, another server configured as a Sourcing Plugin that provides additional sourcing functionality to WMS users, and still another server configured as a Talent Exchange Architecture that is remote from the servers of the Work Integration Platform, each WMS, each WIP and the Sourcing Plugin. The Work Integration Platform has several functions. It has the responsibility of providing WIPs access to API specifications defining a same single array of application programming interfaces (APIs) to be implemented, adopted and hosted by all WIPs so that the WIPs can be called upon by the Work Integration Platform. This array of APIs when implemented and hosted by the selected WIPs gives them membership within a network of WMSs integrated with the Work Integration Platform and the Talent Exchange Architecture according to the invention. These WIP side APIs, when called on by the Work Integration Platform, transfer control over the hiring functionality and contract work management functionality of the WIP to the platform. Further, the same WIP side APIs provide protocols for the member WIPs to receive electronic documents with data originating from a WMS and to send electronic documents with data to a member WMS or to the Talent Exchange Architecture via the Work Integration Platform.

The Work Integration Platform also has the responsibility of providing the WMSs access to API specifications defining a same single array of WMS side APIs to be implemented, adopted and hosted by each WMS so that it can be called by the platform. The APIs of this array when implemented and hosted by a selected WMS similarly gives the WMS membership within the network of WIPs integrated with the Work Integration Platform and the Talent Exchange Architecture. As with the WIP side APIs, the WMS side APIs, when called on by the Work Integration Platform, transfer control over the hiring functionality and contract work management functionality of the WMS to the platform. The WMS side APIs, likewise provide protocols for member WMSs to receive electronic documents with data originating from a WIP and to send electronic documents with data to any member WIP, or to the Talent Exchange Architecture, always via the Work Integration Platform. In the event that there are situations in which preexisting WMS side or WIP side APIs cover some part of necessary functionality outlined in the API specifications of the platform, the platform may implement and adopt, in whole or in part, corresponding API specifications of the WMS or WIP in order to reduce the burden of a WMS or a WIP to become a member.

The Work Integration Platform thus provides a means for each WMS to effectively communicate with multiple WIPs without directly integrating with any WIP. Each participating WMS transfers control of its hiring and contract job management functionality to the Work Integration Platform for the purpose of facilitating the hiring of professionals and the subsequent management of contract work. The platform similarly provides a means for any member WIP to effectively communicate with multiple WMSs without directly integrating with any WMS. Each participating WIP likewise transfers control of its hiring and contract job management functionality to the Work Integration Platform for the purpose of facilitating the hiring of its subscribing job seekers and the subsequent management of contract work obtained by such job seekers.

Further, at the WMS side, protocols and routine sets provided in the Sourcing Plugin enable each WMS to load and embed a novel Sourcing GUI provided by the Sourcing Plugin into the WMS's own GUI suite to be presented to WMS users. The Sourcing Plugin also is configured to assume control over at least part of the hiring functionality of the WMS. It does so also by APIs derived from the Work Integration Platform. The Sourcing Plugin integrates with the WMS GUI suite in order to provide additional features and functionality to the WMS user for the purpose hiring professionals. In a preferred embodiment, the Sourcing Plugin, leveraging the Work Integration Platform and functionality in the Talent Exchange Architecture, thereby selects and controls rules for displaying or hiding profiles of job seekers received from the WIPs, as well as rules for filtering and sorting job seeker profiles, and ultimately extending work opportunities to selected individuals. Also, in a preferred embodiment, the Sourcing Plugin receives control over the entire WMS hiring functionality such that it likewise sets rules for showing and/or hiding traditional suppliers, filtering and sorting suppliers, and releasing work opportunities to the suppliers with requests that the suppliers recommend individual candidates.

The Talent Exchange Architecture can be cloud based. The architecture includes at least a database containing standardized profiles constructed from profile data received from the job seeker subscribers via their respective WIPs. The architecture also includes a database containing standardized data representative of work which contains job opportunities, RFxs and SOWs received from each WMS operating with the Work Integration Platform according to the invention. In this configuration, the WMS calls APIs hosted by the Work Integration Platform when sending data representing a new job opportunity, RFx or SOW, which a hiring company user has entered into the WMS, to the Talent Exchange Architecture. Then the Sourcing Plugin enables the user to effectively search profile data within the personal profile database of the Talent Exchange Architecture, via the Work Integration Platform, for job seekers based upon the user's search criteria. Special logic, also residing within the Talent Exchange Architecture, assists in matching prospective job seekers with job opportunities, RFxs and SOWs. Once job seekers are located, the WMS user can instruct the Sourcing Plugin to communicate a form of engagement data that represents invitations for individuals to apply for the job opportunity or respond to a RFx or SOW directly from their respective member WIPs via their personal electronic devices. Simultaneously, the WMS user can instruct the Sourcing Plugin to release similar engagement data indicative of a new work opportunity to the hiring company's traditional suppliers, whereupon the suppliers also may respond with candidates.

The Work Integration Platform remains the intermediary in the channel of all data communications between the hiring company WMS and the professionals at their respective member WIPs. Such data communications, from the hiring company side, can be of “engagement data” for purposes of rejecting candidates, requesting candidates to interview for requisitioned jobs, extending job offers, initiating and completing onboarding, negotiating a SOW and the like. On the other hand, “engagement data” from the job seeker, that is, from the WIP side, can include responses to a hiring company's requests for an interview, to extension of a job offer, to requests for onboarding, responding to an RFx, negotiating a SOW and the like. The Work Integration Platform remains the intermediary link in the channel of communication between a WMS and each WIP once a contract is in place between a hiring company and a job seeker who has become a contracted worker at the company. That is, the Work Integration Platform remains in the channel of data communication between the hiring company's WMS and the contracted worker's WIP for the transmission and reception of “administration data” representing all aspects of the contract, and any modifications thereto. For instance, from the hiring company side, “administration data” can include requests to alter the timeline of a job, or to terminate it, or company replies to submissions of time sheets, expense reports, requests for payment and the like from contracted workers. From the contracted professional's side, administration data can include the actual submissions of time sheets, expense reports and payment requests as well as responses to contract changes by the company.

The invention also contemplates that no access to the Work Integration Platform or the plugin be granted to any entity outside of each member WMS, member WIPs and the Talent Exchange Architecture.

### BRIEF DESCRIPTION OF DRAWINGS

Preferred examples of the present invention now will be described with reference to the accompanying drawings, in which:

FIG. 1 illustrates a hiring company with a Work Management System (WMS).

FIG. 2 illustrates a Work Intermediation Platform (WIP).

FIG. 3A shows a system in accordance with the present invention that integrates into communication, at least one WMS and plural WIPs.

FIG. 3B illustrates directions of Application Program Interface (API) calls in accordance with the present invention.

FIG. 3C is a more detailed view of the Talent Exchange Architecture shown in FIG. 3A.

FIG. 3D is a detailed view illustrating particular functionalities in the Plugin application or agent shown in FIG. 3A.

FIG. 3E is a view, similar to FIG. 3C, of the Work Integration Platform shown in FIG. 3A.

FIG. 3F illustrates document files communicated within the system of FIG. 3A.

FIG. 4 is a flowchart illustrating a sign-up procedure for WIP membership within the networked system of the present invention.

FIG. 5A gives illustrative examples of information and controls within a series of graphical user interfaces produced at the WMS side.

FIG. 5B is a schematic illustration of a graphical user interface embedded in the WMS side interfaces in accordance with the present invention.

FIG. 5C gives illustrative examples of information and controls provided within a series of interfaces produced at the WIP side.

FIG. 6A shows further illustrative examples of graphical user interfaces generated at the WMS side, and FIG. 6B likewise illustrates examples of such interfaces at the WIP side.

FIGS. 7A and 7B are a sequence diagram illustrating sourcing of a contract job.

FIG. 8 is a sequence diagram illustrating review of a contract job opportunity.

FIG. 9 is a sequence diagram illustrating review and rejection of candidate.

FIG. 10 is a sequence diagram illustrating transmission of a request for a job interview.

FIG. 11 is a sequence diagram illustrating review of a request for an interview.

FIG. 12 is a sequence diagram illustrating making a contract job offer.

FIG. 13 is a sequence diagram illustrating review of a contract job offer.

FIG. 14 is a sequence diagram illustrating withdrawal of a contract job offer.

FIG. 15 is a sequence diagram illustrating decline of a previously-accepted job offer.

FIG. 16 is a sequence diagram illustrating initiation of onboarding.

FIG. 17 is a sequence diagram illustrating review of onboarding requirements.

FIG. 18 is a sequence diagram illustrating completion of onboarding requirements.

FIG. 19 is a sequence diagram illustrating creating a job timeline change request.

FIG. 20 is a sequence diagram illustrating reviewing a job timeline change request.

FIG. 21 is a sequence diagram illustrating creating a job extension request.

FIG. 22 is a sequence diagram illustrating reviewing an extension request.

FIG. 23 is a sequence diagram illustrating truncating a contract job.

FIG. 24 is a sequence diagram illustrating terminating a contract job.

FIGS. 25A and 25B together are a sequence diagram showing preparation and submission of a timesheet.

FIG. 26 is a sequence diagram illustrating review of a submitted timesheet.

FIG. 27 is a sequence diagram illustrating preparation and submission of an expense report.

FIG. 28 is a sequence diagram illustrating review of a submitted expense report.

FIG. 29 is a sequence diagram illustrating preparation and submission of a Milestone payment request.

FIG. 30 is a sequence diagram illustrating review of a submitted Milestone payment request.

FIG. 31 is a sequence diagram illustrating preparation and submission of a Unit of Measure payment request.

FIG. 32 is a sequence diagram illustrating review of a submitted Unit of Measure payment request.

FIG. 33 is a sequence diagram illustrating creation of an RFx.

FIG. 34 is a sequence diagram illustrating review of an RFx.

FIGS. 35A and 35B are sequence diagrams illustrating response to an RFx.

FIG. 36 is a sequence diagram illustrating creation of a SOW.

FIG. 37 is a sequence diagram illustrating review of a SOW.

FIGS. 38A and 38B are sequence diagrams illustrating response to a SOW.

FIG. 39 is a sequence diagram illustrating subsequent review of a SOW.

FIG. 40A is still another illustrative example of graphical user interfaces at the WMS side with information and controls for creating each of an RFx or a SOW, and FIG. 40B likewise illustrates graphical user interfaces available at the WIP side for responding to an RFx or a SOW.

FIG. 41 is a sequence diagram illustrating creation and/or updating of a professional's profile.

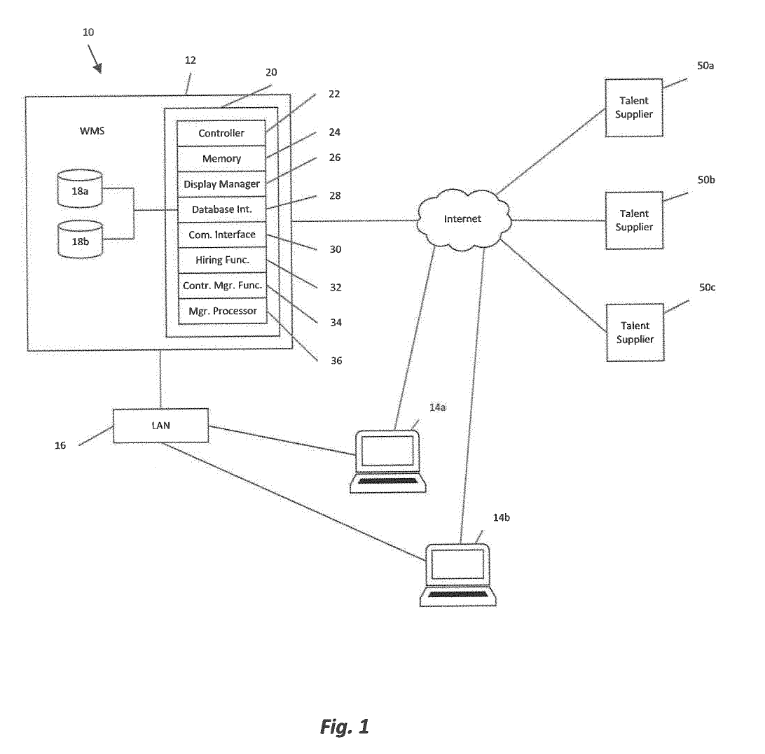

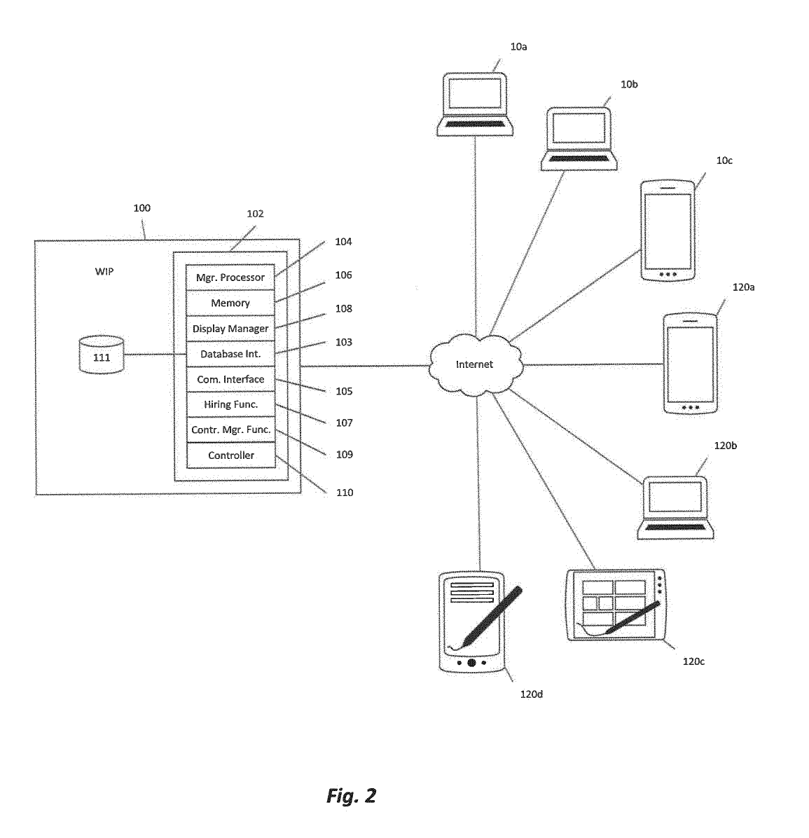

### DETAILED DESCRIPTION OF THE PREFERRED EMBODIMENTS

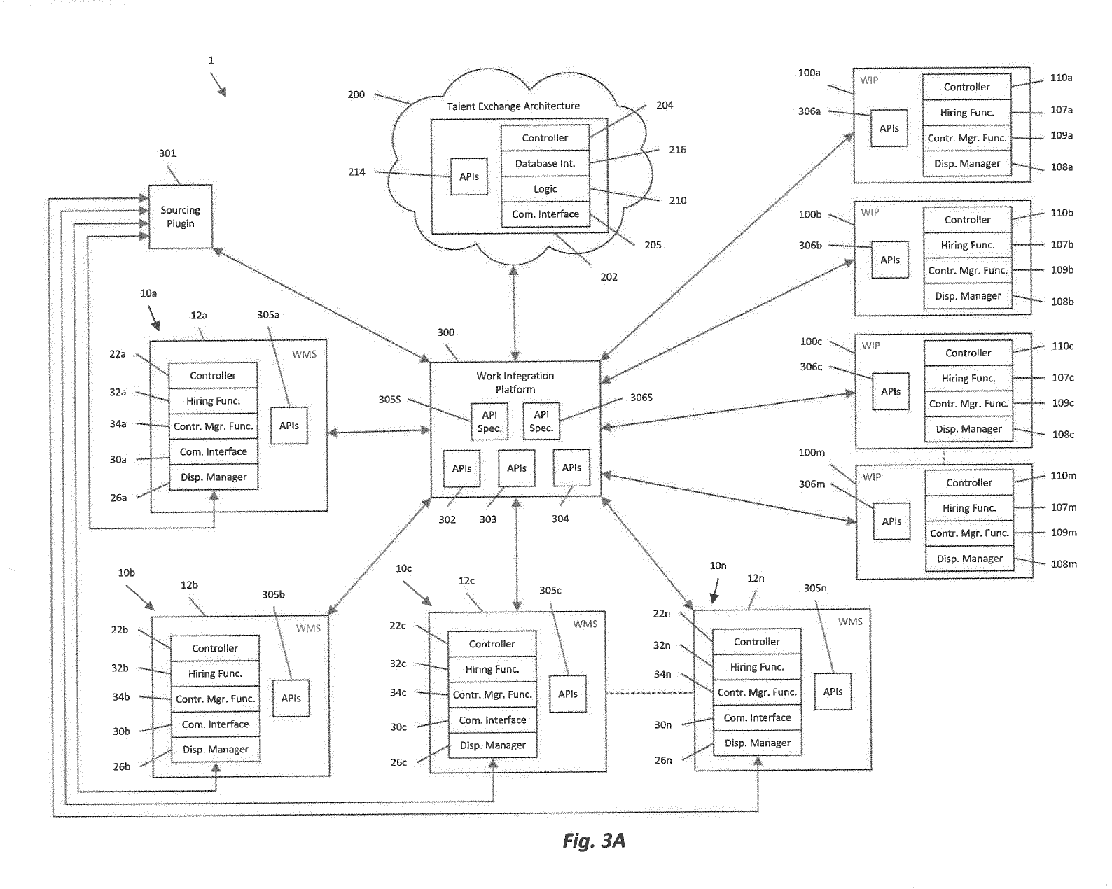

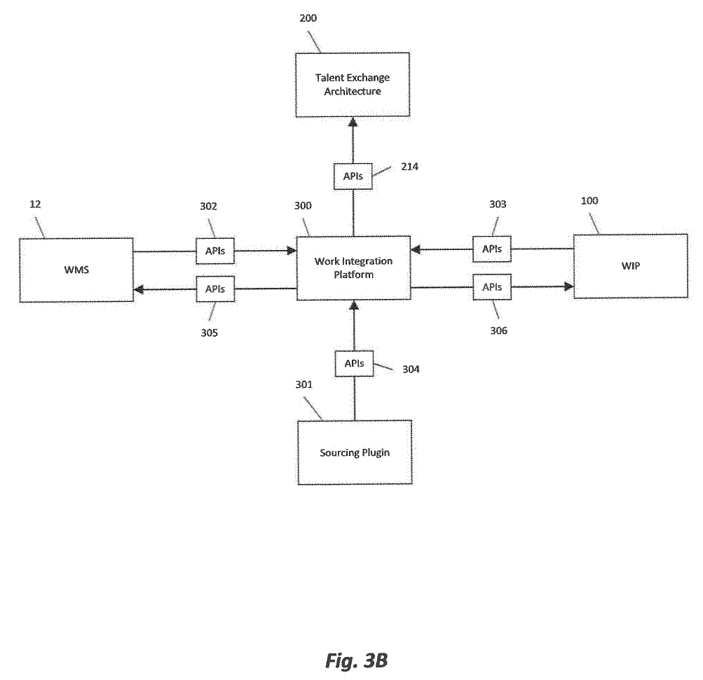

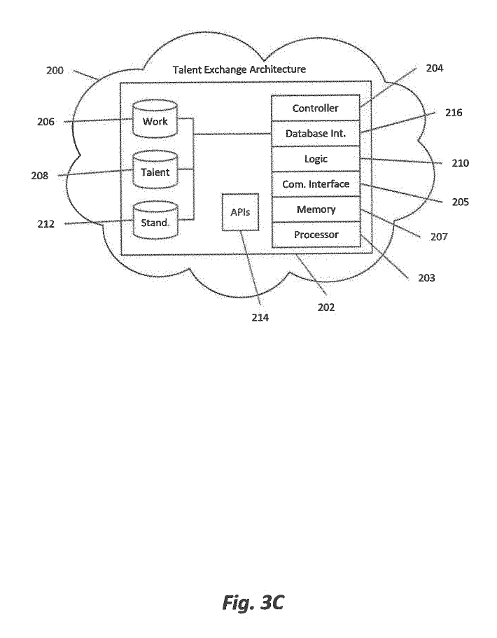

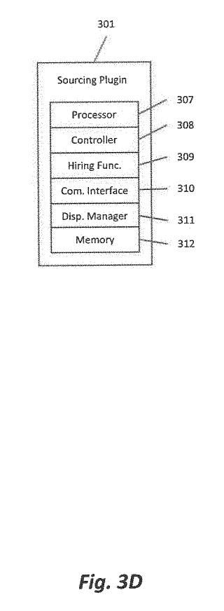

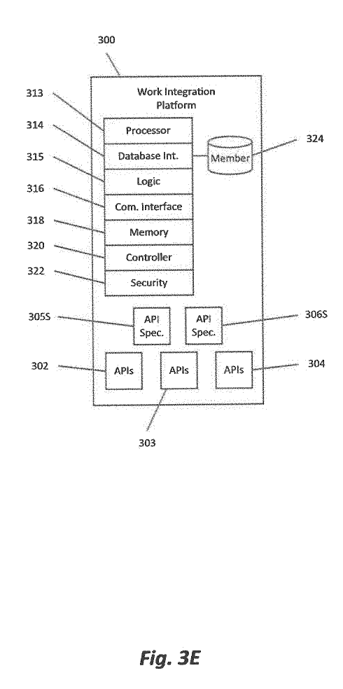

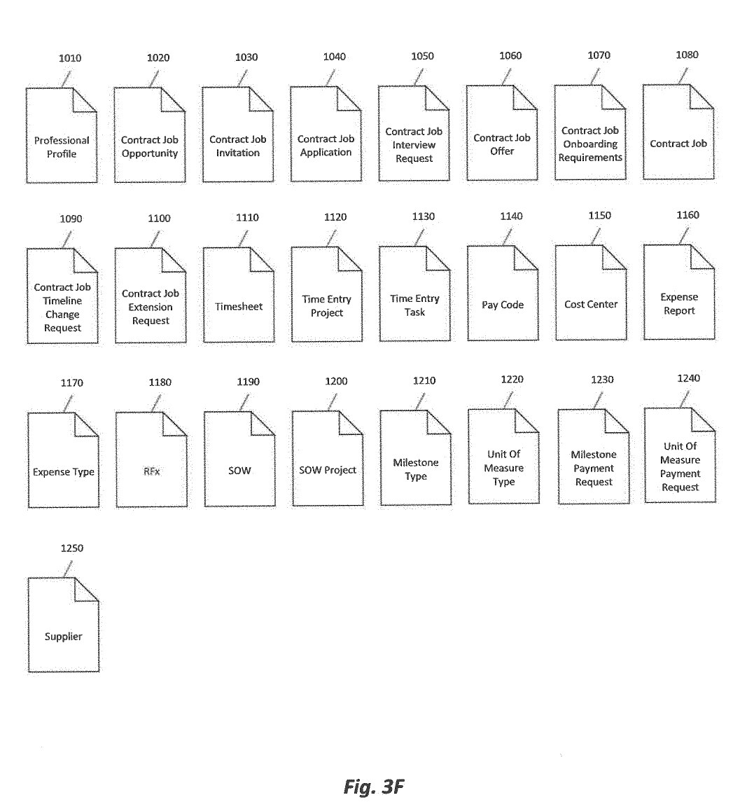

FIG. 3A is a high level diagram showing a preferred system 1 configuration according to the invention. The invention introduces new Talent Exchange Architecture 200, a “Sourcing Plugin” 301, and a Work Integration Platform 300 that together open and maintain desired new communication paths between at least one hiring company 10 and one or more of the WIPs over the internet. FIG. 3A uses notations 10a, 10b, . . . 10n for the multiple hiring companies in the network, notations 12a, 12b, . . . 12n for their respective WMSs, and notations 100a, 100b, . . . 100m for the plural WIPs. For simplicity, however, reference usually will be made hereinafter to “WMS 12”, “WIP 100”, “client device 120” and “platform 300” whereby such reference can mean the ith WMS of the set of WMSs 12a-12n, and likewise the ith WIP of WIPs 100a-100n and any of the client devices 120a, 120b, etc. connecting to a WIP. In the same way the (ith) controller 22 for the ith WMS, or the (ith) controller 110 for the ith WIP will be referred to simply as “controller 22”, or “controller 110” etc. It is emphasized that a potentially large number of WMSs and WIPs will be involved in the network of the invention, and a still larger plurality, likely thousands or millions of job-seeking professionals, could be involved as subscribers on the WIPs.

Work Integration Platform 300 establishes a network of member WIPs among WIPs 100a, 100b, . . . 100m by offering to preselected WIPs API specifications 306S that enable each such selected WIP to opt-in to membership. Platform 300 likewise establishes a network of member WMSs among WMSs 12a, 12b, . . . 12n by offering to preselected WMSs, API specifications 305S that enable each such selected WMS to opt-in to membership. The APIs can be written from specifications 305S and 306S of platform 300 in any conventional language such as JASON, XML and the like. In this way platform 300, in addition to its function of communication intermediary, acts as a library of API specifications that are offered to WMSs 12 and WIPs 100 for network membership. Platform 300 thereby enables each member WMS 12 to effectively interface with multiple WIPs via a single set or array of APIs structured according to specification 306S instead of an array of APIs corresponding to each different member WIP 100. Limitation to a single API array for all WIPs 100 greatly reduces the complexity and cost of WMS to WIP integration. From the WIP side, the integration platform 300 likewise enables any member WIP 100 to effectively interface with multiple WMSs via a single set or array of APIs adhering to specification 305S instead of a different API array corresponding to each different WMS to similarly reduce the complexity and cost of WIP to multiple WMS integration.

With reference to FIG. 313 now also, API calls are illustrated with reference to platform 300. It is to be understood that data transmission could be simultaneous with API calls but FIG. 3B is intended to show API call directions in the preferred embodiments. API array, hereafter referred to as APIs 302, is accessible to member WMSs 12 for the purpose of calling functionality in Work Integration Platform 300 in order to interface with any member WIP 100 and also Talent Exchange Architecture 200. Conversely, APIs 305 are embodied as a broad array of APIs that are implemented, adopted and hosted by each member WMS to allow Work Integration Platform 300 to assert control over the hiring functionality 32 and contract work management functionality 34 of each implementing member WMS 12. From the point of view of WIPs 100, Work Integration Platform 300 contains array of APIs 303 that are accessible to each member WIP for the purpose of calling functionality in the platform in order to effectively interface with any member WMS 12 and Talent Exchange Architecture 200. Then again, conversely, APIs 306 defined by specification 306S are implemented, adopted and hosted by each member WIP 100 to allow Work Integration Platform 300 to assert control over the hiring functionality 107 and contract work management functionality 109 of each such implementing WIP.

Work Integration Platform 300 also contains an array of APIs, referred to as APIs 304, that are accessible to Sourcing Plugin or “agent” 301 for the purpose of calling functionality in the platform in order to provide communication capability between the agent and member WMSs, member WIPs and exchange architecture 200. Talent Exchange Architecture 200 itself contains APIs 214 that makes the architecture accessible to Work Integration Platform 300 for the purpose of calling functionality in the architecture. For purposes of this discussion, an API “call” originates from a server, referred to as the calling server, which is utilizing an API of another server, referred to as the target server, which implements, adopts and hosts the API specification. The API call by the calling server effectively commands the target server to perform some action or logic. As defined by the target server's API specification, an API call may result in data being returned by the target server to the calling server at the completion of a synchronous API call. An example of a return of data via synchronous API calls is given herein when the Sourcing Plugin 301 calls APIs 304 in Work Integration Platform 300 to obtain matching professionals for a work opportunity, which call causes Work Integration Platform 300 to call APIs 214 in Talent Exchange Architecture 200 to retrieve the matching professional profiles.

Talent exchange architecture 200, as also seen in isolation in FIG. 3C, preferably is cloud based and includes a server 202 having master processor 203, controller 204, network communications interface 205 and memory 207. Server 202 has a database hereinafter referred to as the work opportunity depository 206, a second database hereinafter called the talent depository 208, and a standardization database 212. It also is shown as hosting APIs 214. Database interface 216 provides access to depositories 206, 208, and 212. In the preferred embodiment, server computer 202 also is configured to provide matching logic 210, or to have access to such logic.

Sourcing Plugin or agent 30, shown in isolation in FIG. 3D, can be embodied as a plugin compatible with each host WMS 12. It has a processor 307, dedicated hiring functionality 309, a network communications interface 310, a display manager 311 and a memory 312. In the preferred embodiment, display manager 311 generates what will be referred to as a “Sourcing GUI”. In the preferred embodiments, the Sourcing GUI is loaded and embedded into to each member WMS12 by the WMS display manager 26. WMS display manager 26 passes necessary data to Sourcing Plugin 301 during loading to advise plugin controller 308 which contract job opportunity, RFx or SOW on which to operate. Hiring functionality 309 provides ability for WMS users at stations 14 to review professionals and suppliers and ultimately invite professionals and suppliers to engage in work. Plugin controller 308 engages the plugin's hiring functionality 309 to call APIs of platform 300 in order to access contract job opportunities, RFxs and SOWs, and respective matching professional profiles contained in architecture 200 via the platform. In response to calls to APIs 304 from plugin 301, platform 300 calls APIs 214 in exchange architecture 200 to receive engagement data inclusive of such opportunities, RFxs, SOWs, and profiles.

Work Integration Platform, in FIG. 3E, has a master processor 313, network communications interface 316 and memory 318. Database interface 314 provides access to database 324 which stores WMS and WIP membership data including security credentials. Logic 315 determines the functional workflow routing across the integrated WMS, WIP and Talent Exchange Architecture system 1. Controller 320 calls the appropriate WMS APIs 305, WIP APIs 306, and Talent Exchange Architecture APIs 214 based on logic 315. Security 322 controls authentication, authorization and access to the integration platform 300, Sourcing Plugin 301, exchange architecture 200, member WMSs and member WIPs. Security 322 thus effectively controls which servers may communicate with each other and controls what types of data may be communicated between them.

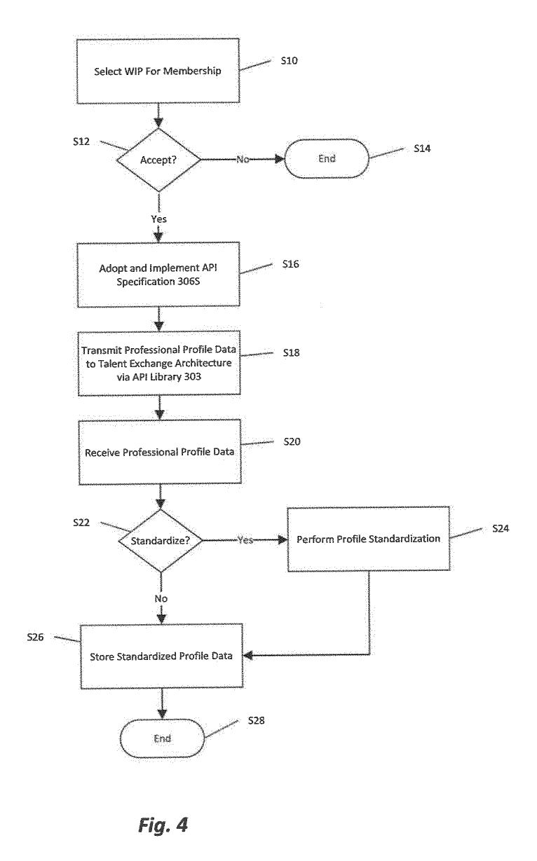

FIG. 4 is a simplified flow chart illustrating an exemplary opt-in procedure for WIPs 100 and the communication with architecture 200 thereafter. In step S10, certain of WIPs 100a-100m are selected for membership. A supervisor of each such selected WIP 100 decides whether to accept membership in the network as offered by architecture 200 at step S12. If this decision is in the negative, the process ends at step S14. Otherwise, the selected WIP downloads API specification 306S from platform 300 and implements and adopts corresponding APIs 306 that are operative with the selected WIP in step S16 such that communication channels for specified communications can be established between each selected WIP 100, platform 300 and architecture 200. Next, in step S18, each selected WIP 100 transmits the profile data file 1010 for each of its respective subscriber job seekers, who have authorized such profile data transfer, to architecture 200 for storage in talent depository 208. A preferred profile data file 1010 depicted in FIG. 3F includes each job seeker's professional data representing the professional's name, contact information, job title or titles, prior roles, skills, experience, education, availability, pay rate, and the like in addition to data for identifying the particular WIP from which the file originated. Preferably, the profile data file also contains additional data indicative of the job seeking professional's hobbies, interests, and prior projects. In a preferred embodiment, the profile file also contains still other data representations for the professional's commuting preference, inclination for relocation and the like.

It is expected that the professional profiles 1010 as published by individuals in their respective WIP accounts often will include widely differing terminology for the same concepts. That is, different job seekers will describe the same sought positions differently. Similarly, they are likely to describe similar skills and/or experiences differently. Hence, when data representing these descriptions are accepted at architecture 200, via APIs 214, processor 203 and logic 210 will cause all profile data in file 1010 to be compared with the standardized data in database 212 at step S22, and when necessary use natural language processing and neural networks contained in, or embodied by logic 210 in step 524 to determine corresponding standardized data for the profile data. The same standardization process will be applied for abbreviations, synonyms, acronyms, misspellings and the like so that the same terminology and format for profile data will be used in all profile data files stored in talent depository 208. Standardized profile data for each job seeking professional thus is stored in talent depository 208 in step S26 whereafter the process ends in step 528. The use of standardized profile data enables logic 210 to perform better matching of profiles to work. The professional profile to work opportunity matching logic contained in logic 210 improves each member WMSs in system 1 by providing a consistent matching algorithm across all professional profiles, regardless of the profile's source WIP 100. This, in turn, improves each hiring company's ability to hire professionals for work opportunities.

We now consider system security in more detail. Sourcing Plugin 301 is accessible only to an authorized WMS 12. Preferably, Sourcing Plugin 301 uses both role-based and account-based security models to grant access to its host WMS. In this scenario, each WMS 12 must be provided with a valid account authorizing it to access the Sourcing Plugin 301. In a preferred configuration, OAuth 2.0 is used to grant WMS 12 system level access. In such configuration, WMS 12 requests an OAuth 2.0 token from the Work Integration Platform security 322 by specifying the correct identifier, secret key and OAuth scope. If authentication and authorization is granted, WMS 12 passes the OAuth token to Sourcing Plugin 301 in order to load the Sourcing GUI into the WMS's native GUI suite. Further, in this preferred configuration, all data transmissions between each WMS 12 and platform 300, between the Sourcing Plugin 301 and platform 300, architecture 200 and platform 300, and between the each WIP 100 and platform 300 rely upon HTTPS and TLS 1.0, or higher versions of either, and utilize OAuth 2.0 for authentication and authorization. Even under this system of authorization, essentially only engagement data pertaining to job opportunities, RFxs and SOWs and administrative data pertaining to management of workers under contract are permitted to be transmitted between WMS 12 via platform 300. All other proprietary company data remains separated in WMS 12 from data that may be aggregated or shared with job searching professionals and with contractually engaged professionals.

With particular reference again to FIG. 3A, platform 300 is depicted as communicating with the controller 22 of each WMS 12 via APIs 305 to take over control of at least part of the hiring functionality 32 and contract work management functionality 34. Platform 300 responds to incoming calls to APIs 303 from any of the member WIPs and incoming calls to APIs 304 from Sourcing Plugin 301 by exercising control over WMS functionalities 32 and 34. Upon transfer of control of functionalities 32 and 34 from WMS master controller 22 to platform 300, the platform acts as the intermediary between each WMS 12 and architecture 200, the intermediary between Sourcing Plugin 301 and each WMS 12 and as the intermediary between each WMS 12 and each member WIP 100 within the network established by the invention. Platform 300 also is depicted as communicating with the controller 110 of each WIP 100 via APIs 306 to take over control of at least part of the hiring functionality 107 and contract work management functionality 109. Platform 300 responds to incoming calls to APIs 302 from any of the member WMSs and incoming calls to APIs 304 from Sourcing Plugin 301 by exercising control over WIP functionalities 107 and 109. Upon transfer of control of functionalities 107 and 109 from WIP master controller 110 to platform 300, the platform acts as the intermediary between such WIP 100 and architecture 200, the intermediary between Sourcing Plugin 301 and the WIP, and as the intermediary between such WIP and each member WMS 12 within the network established by the invention.

A specific example of an action causing transfer of control from WMS controller 22 to platform 300 starts with the creation and publication of a new job opportunity by hiring company 10. This is independent of activities on WIPs 100a-100m initiated by the individual job seekers in their accounts. At the hiring company side, a hiring manager or other user staff member of company 10 enters at workstation 14, work opportunity data representative of each new job into database 18a. WMS controller 22 then can call APIs 302 on platform 300 to command the platform to channel transmission of the work opportunity data to architecture 200 by calling architecture APIs 214 for processing and storage in work opportunity depository 206. Upon receipt of this work opportunity data at architecture 200, the architecture's controller 204 performs data standardization using natural language processing and neural networks contained in logic 210 and the standardized data contained in database 212 to determine the corresponding standardized data representing the work opportunity, whereafter the standardized work opportunity data is entered into depository 206. Afterwards, a hiring company user operating Sourcing Plugin 301 can view the work opportunity and traditional suppliers 50a-50c in the Sourcing GUI embedded in the WMS GUI suite by plugin 301, and subsequently invite the suppliers to submit candidates. The Sourcing GUI attributed to the Sourcing Plugin responds to the WMS user's invitation action causing the controller 308 to call APIs 304 on platform 300, to which the platform responds by assuming control of WMS hiring functionality 32 via WMS APIs 305 in order to release the work opportunity data directly to traditional suppliers 50a-50c.

Matching logic 210 applies algorithms for matching standardized professional profile data transmitted from the multiple member WIPs 100 with the standardized work opportunity data originating from plural equipped WMS systems 12. Logic 210 quantifies the degrees of similarity between predetermined items of professional data within each professional's personal profile data file 1010, and predetermined corresponding items in each work opportunity data file 1020. For instance, the professional's education, experience, skills, job title and desired pay rate are quantized and compared with a quantization of stated requirements for each of these items in the work opportunity data. The logic 210 compares the quantized data from the profile data and from the work opportunity data in order to calculate a probability that job seekers represented in its talent depository 208 could fulfill the requirements of a given stored work opportunity. Logic 210 also selectively can quantify additional parameters such as the job seeker's geographical location, relocation preferences, commuting preferences and the like and thus include data indicative of these items in its calculation of the probability. Still further, as part of its probability calculations, matching logic 210 could take into account the likelihood that a given job seeker could qualify for multiple work opportunities at a same hiring company or even at a different such company. Logic 210 compares the calculated probability with a threshold match probability to identify each candidate for the work opportunity. The overall match probability could be set, for example, at 90%, which is a composite of each of the probabilities for the data points quantized and compared between the professional profile data and the work opportunity data. In a preferred implementation, matching logic 210 is embodied by a neural network which receives the work opportunity data and professional profile data as input and generates a list of one or more professionals according to principles of artificial intelligence in order to determine which professional or professionals would be most likely to fulfill the requirements of a given work opportunity. Also, the rules by which matching logic 210 determines the probabilities are dynamic. That is, they are adjusted as work requirements, skill levels and the like change and improve. Logic 210 continuously computes the match probabilities between all work opportunities and all professional profiles as they are added or updated in Talent Exchange Architecture 200 in order to make the computed match probabilities available to Sourcing Plugin 301 via platform 300.

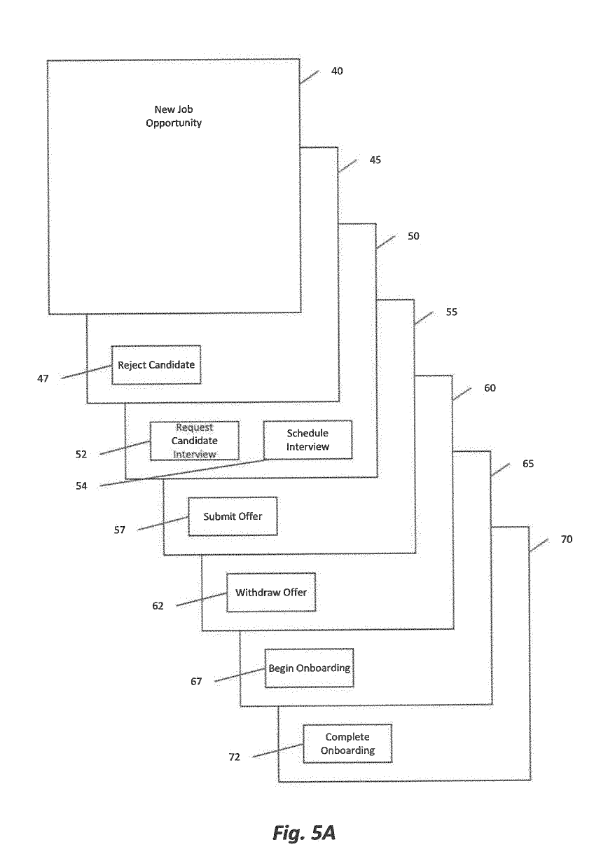

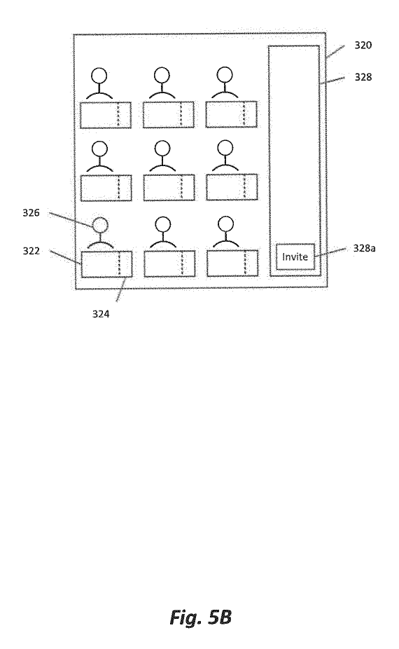

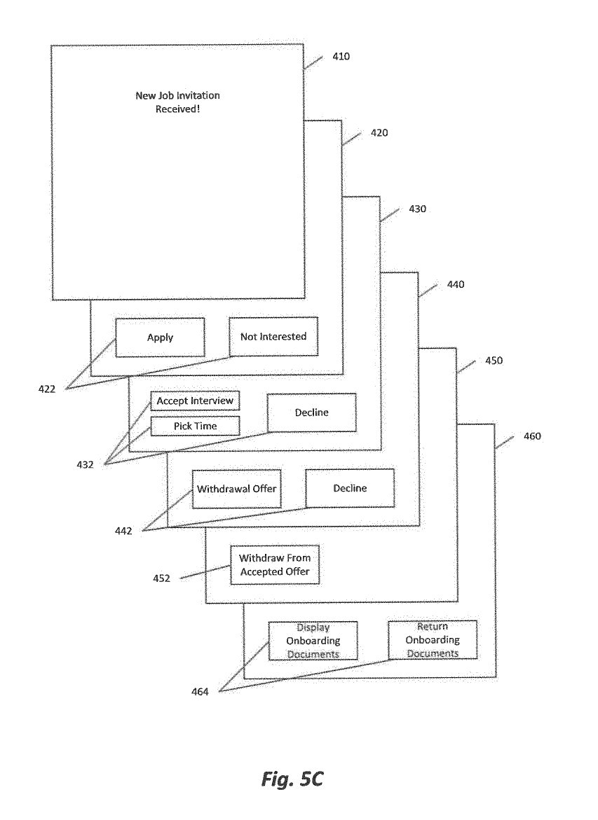

In preferred system 1, it now should be understood that WMS 12 is improved by embedding Sourcing GUI 320 into the WMS's otherwise native GUIs. Alternatively, other WMS native GUIs could be replaced by GUIs created by system control over WMS display manager 26 and hiring functionality 32. FIG. 5A assists in showing exemplary graphical user interfaces native to WMS 12. These interfaces are created by WMS display manager 26, i.e. the display functionality, as controlled by controller 22. While front end interface 40 is only schematically shown in FIG. 5A, it will be apparent to those of ordinary skill that this interface includes messages and controls to prompt WMS user entries for designating a new job opportunity, for entering the necessary skills and experiences for the job opportunity, and for designating other necessary requirements such as needs for background checks, admission/identity badges, security clearances and the like to create a new job opportunity. Work opportunity data representing the new position, and the skills, experience, and necessary requirements therefor in the job opportunity are forwarded to appropriate company management personnel by WMS 12 for approval. When management approval is given, WMS 12 calls, platform 300 APIs 302 to command the platform to receive the approved work opportunity data created at WMS 12 and to transmit this data to architecture 200 via a call from the platform to APIs 214 whereupon the architecture's controller 204 standardizes the data by using logic 210 and accessing database 212. The standardized work opportunity data is provided to logic 210 for comparison of the data to the professional profile data stored in depository 208. Meanwhile, the WMS user is now ready to initiate a talent search to fill the approved job opportunity.

FIG. 5B schematically shows preferred Sourcing GUI 320 which is a front end interface for hiring company users to view, contact and engage job seekers that could fulfill work opportunities. GUI 320 provides hiring company users the ability to view, contact and engage traditional suppliers. By being embedded into the WMS GUI suite by control over display manager 26, GUI 320 improves the hiring company user's access to functionality provided by GUI 320. Plugin 301 calls platform APIs 304 to cause the platform to call architecture APIs 214 to access work opportunity data and matching professional profile data from architecture 200. In a preferred embodiment, display manager 311 configures GUI 320 to present multiple professional profiles in rows and columns with fields 322 showing each professional's skills and qualifications. Preferred interface 320 prominently shows the match probability calculated by logic 210 for each candidate in fields 324. In the preferred embodiment, GUI 320 also includes an image field 326, which can display a facial image for each professional. In interface 320, identification information from selected traditional suppliers also is shown.

Interface 320 is generated to have a number of user-operational controls, generally 328. These controls provide for filtering professional profiles by status such as between preferred profiles and non-preferred profiles. Filtering also is done according to preferred payment arrangements such as accepting professionals as independent contractors, or contractors on a W2 form. Controls for filtering by keywords, controls for sorting among profiles by different match percentages, controls for searching by name also are provided, as are controls for selecting all profiles, dismissing a matched profile and saving further action for later. In general, an exemplary, but as one of ordinary skill in the art would understand, non-definitive list of criteria for screening professionals at either the level of matching logic 210, or at the hiring company user level at GUI 320, includes filtering talent profiles according to name, job title, role, project, skills, keywords, work classification, experience, education, talent availability, commuting preference, relocation preference, desired pay rate, pay rate type, matching percentage, standard key words, standard skills, standard job titles and standard roles.

Hiring managers or like users of hiring company 10 review the professional profiles on GUI 320 and make their selection from among the presented professionals. As apparent to those of ordinary skill in the art, a preferred example of GUI controls 328 also could permit these users to introduce additional keywords and search terms to platform 300 for purposes of narrowing a search. Platform 300 transmits these additional profile keywords to matching logic 210 which, in turn, adjusts the parameters used in its probability calculation, recalculates the matching probabilities and again selects from among the professional profile data files to present a slate of professional profiles for GUI 320.

Once hiring company personnel select individual professionals from among the professionals presented on GUI 320, they operate interface control 328a and thereby instruct platform 300 via APIs 304 to send a form of engagement data that we will refer to as invitation data directly to each selected job seeker's account at his or her WIP 100 via APIs 306. Hiring company personnel also are able to select traditional suppliers as presented on GUI 320 by operating interface control 328a and thereby instruct platform 300 via APIs 304 to send engagement data as invitation data directly to their WMS via an API call to APIs 305 of their WMS by the platform.

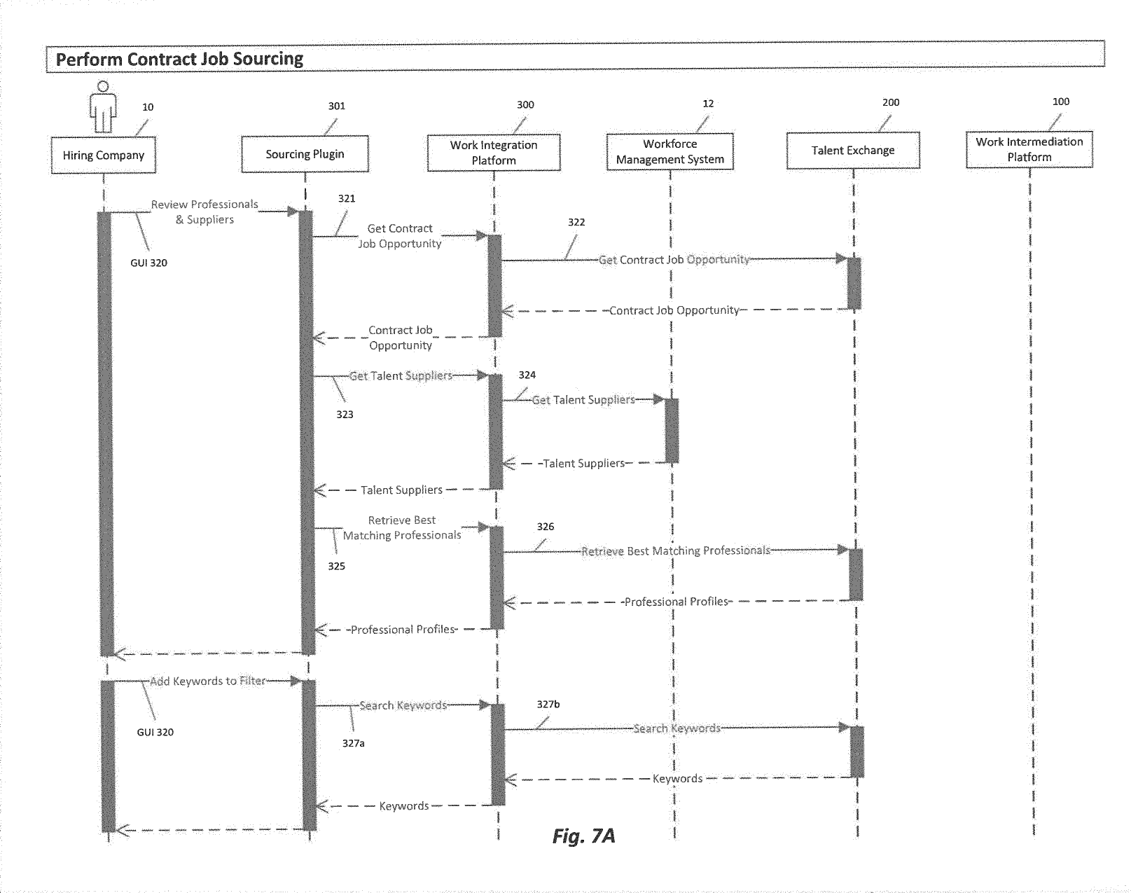

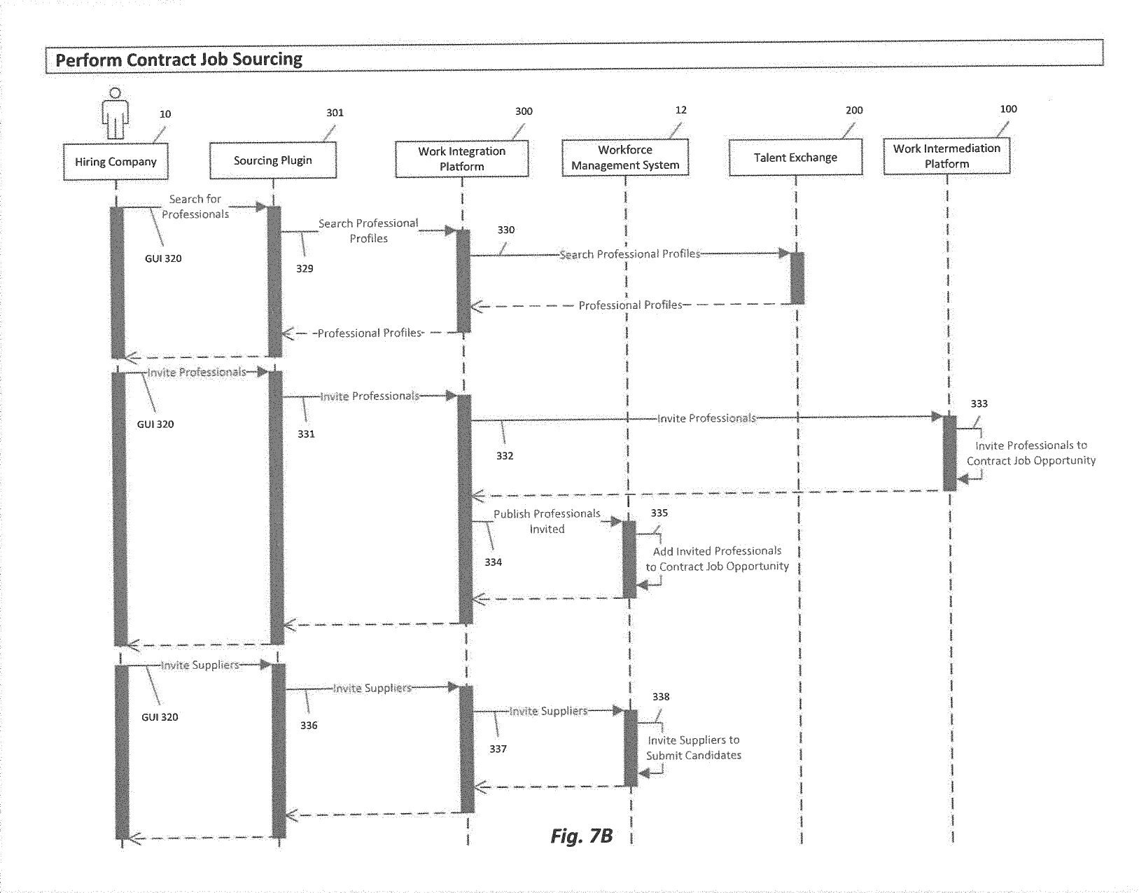

FIGS. 7A and 7B are the first in a series of sequence diagrams showing operation incorporating the principles hereinbefore discussed. The data communications depicted in the diagrams are to be understood as accomplished synchronously or asynchronously. Discussions of the sequence diagrams also will refer to FIG. 3B illustrating the role of platform 300 and the APIs in enabling and directing the communications and their content among each WMS 12, each WIP 100, and Talent Exchange Architecture 200. Further, such discussions will continue to refer to FIGS. 3F, 5A, 5B and SC, and other drawings showing user interfaces that ultimately lead to use of the APIs and platform 300.

FIGS. 7A and 7B show contract job sourcing. The WMS user selects a particular contract job opportunity in a native WMS GUI. This user action results in a transfer of control from WMS processor 22 to Sourcing Plugin 300, which causes the WMS display manager 26 to load Sourcing Plugin GUI 320 for that specific job opportunity. Controller 308 of plugin 301 acts to retrieve the desired contract job opportunity by sending data 321 describing a Contract Job Opportunity 1020 (FIG. 3F) to platform 300 by calling APIs 304. Platform 300 responds to the call to APIs 304 by retrieving data representing Opportunity 1020 by sending corresponding data 322 to architecture 200 by calling architecture APIs 214. The API 214 call commands architecture processor 203 to respond by using interface 216 to access database 206. Sourcing Plugin 301 likewise retrieves traditional suppliers by communicating data 323 describing a collection of Suppliers 1250 (FIG. 3F) from platform 300 again via APIs 304, which call causes platform 300 to retrieve suppliers according to data 324 from the user's WMS 12 via APIs 305. As thereby controlled by platform 300, WMS 12, retrieves such data by accessing its database 18a. The Sourcing Plugin 301 also retrieves data representative of matching professionals by communicating data 325 describing a collection of Professional Profiles 1010 (FIG. 3F). Data 325 is communicated through the channel through platform 300, via APIs 304, which when called by Plugin 301, causes platform 300 to retrieve professional profile data according to corresponding data 326 from architecture 200 via APIs 214. Architecture processor 204 accesses database 208 to retrieve as data, the matching professional profiles for the specified contract job opportunity. The plugin's display manager 311 displays data 321, 323 and 325 to the WMS user for review.

Sourcing Plugin 301 presents the professional profiles as user recognizable data in GUI 320 by which the WMS user considers the professionals presented. Sourcing Plugin 301 responds to user controls 328 within GUI 320 to examine any one of the professionals in more detail, such as by clicking on a professional's image in the interface to enlarge the image and the professional's credentials over a backdrop of other profiles. The user at workstation 14 can reduce the number of candidates presented in GUI 320 by inputting keyword data 327 by interface 320 controls 328 at workstation 14. Sourcing Plugin 300 responds to such keyword input by transmitting the keyword input data to platform 300 with data 327a via APIs 304 to which platform 300 responds by transmitting data 327b to architecture 200, via APIs 214, whereupon controller 202 causes logic 210 to retrieve actual keywords (keyword matches) according to data 327b from database 212. Once the keywords have been selected and presented to the user at GUI 320, the user performs a search with user controls 328 to which Sourcing Plugin 301 responds by sending search data 329 representing the user's search criteria to platform 300 via APIs 304. Platform 300 transmits corresponding search data 330 to architecture 200, via APIs 214, whereupon controller 204 causes logic 210 to perform comparison processing in accordance with the search criteria, and then returns professional profiles as data from database 208. Sourcing Plugin 301 responds to the professional profile data from architecture 200 by reconfiguring GUI 320 presented at workstation 14 to present a narrowed list of profiles.

Control 328a in group 328 of GUI 320 permits the WMS user to invite selected professionals to apply for the job opportunity. The user's operation of control 328a generates engagement data in the way of invitation data 331 (Contract Job Invitation 1030 FIG. 3F) that Sourcing Plugin 301 transmits to platform 300 via APIs 304. Platform 300 transmits corresponding invitation data 332 (Contract Job Invitation 1030 FIG. 3F) destined for the one or more WIPs whose subscribers provided the selected professional profiles via calls to APIs 306. Platform 300 accordingly transmits similar invitation engagement data 334 (Contract Job Invitation 1030 FIG. 3F) to the user's WMS for the purpose of recording which professional-invitees were invited to apply to the contract job opportunity 335. Once professionals that are WIP subscribers have been invited, a notification 333 of each invitation preferably is displayed on each invitee's account and client device 120. The hiring company user is also able to invite suppliers to submit candidates to the contract job opportunity by using control group 328a which causes Sourcing Plugin 301 to transmit another form of invitation data 336 to platform 300 via APIs 304. Platform 300 responds by transmitting corresponding invitation data 337. via APIs 305, to command WMS 12 controller 22 and hiring functionality 32 to notify the hiring company's traditional suppliers about the option to submit candidates to contract job opportunity 335.

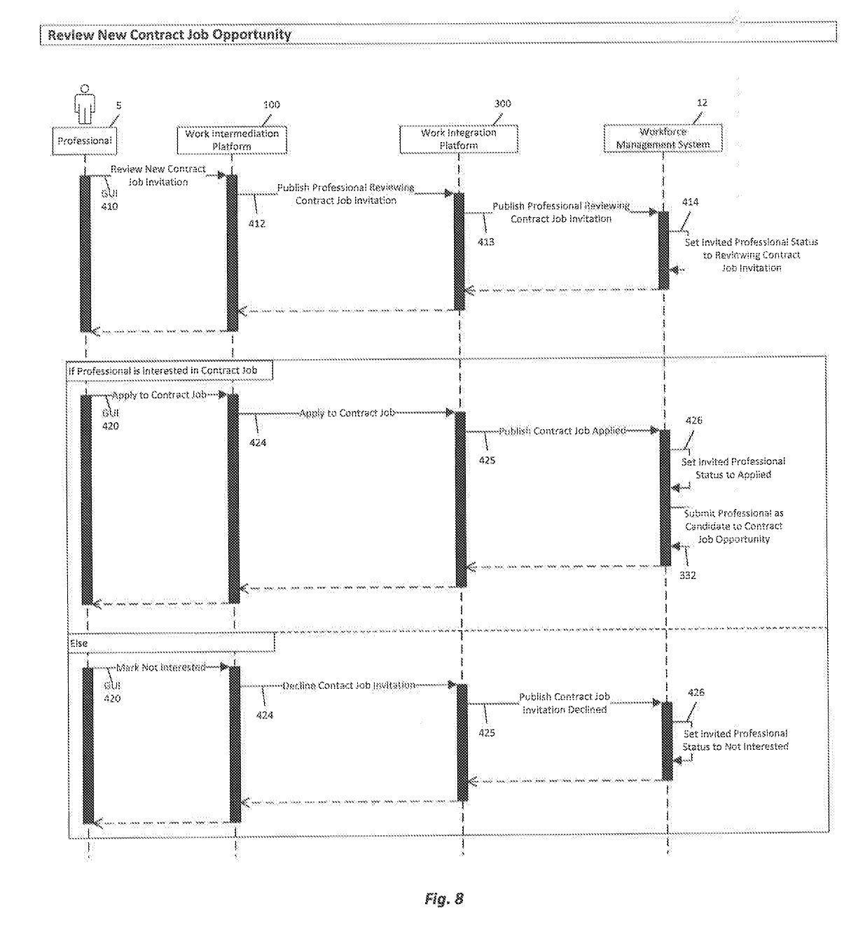

FIG. 8 depicts action at the WIP side in response to the contract job sourcing actions at the WMS side. For convenience, from FIG. 8 onward, a job-seeking professional-subscriber at his or her WIP will be referred to with reference character 5.

In FIG. 8, WIP subscriber (professional) 5 has been selected by company 10 for invitation to apply for a new job opportunity sourced as shown in FIGS. 7A and 7B. That is, professional 5 has received invitation data 329 at his or her client device 120 via his or her WIP 100. Subscribing professional 5 thus accesses his or her WIP account by personal device 120 to find front end GUI 410, schematically shown in FIG. 5C. Platform 300, by calls to WIP side APIs 306, exercises control over WIP hiring functionality 107 and display management functionality 107 to populate GUI 410 with information represented by the transmitted invitation data 329 from platform 300. In the preferred embodiment, WIP 100 creates and transmits, via calls to APIs 303, status data 412, indicating that the professional is reviewing or has reviewed the invitation, back to platform 300. The API 303 call commands platform 300 to transmit corresponding status data 413 to WMS 12 via APIs 305. Upon receipt of such status data 413, WMS 12 notifies the user by notification 414 that the invitation is being or has been reviewed. Similarly, as also seen in FIG. 8 and FIG. 5C, the professional operates controls 422 of GUI 420, to the rear of interface 410, to instruct WIP 100 to transmit data 424 (Contract Job Application 1040 FIG. 3F) indicative of his or her interest with respect to the job to platform 300 by calling platform APIs 303. Platform 300 responds by transmit transmitting data 425 (Contract Job Application 1040 FIG. 3F) to WMS 12 by calling WMS APIs 305, whereupon the platform assumes control over WMS display functionality 26 to set a status engagement indicator 426 to indicate that the professional has applied for the job, or alternatively that he or she is not interested in the job. A professional that has applied to a job opportunity will be referred to as a candidate up until the point at which the professional is awarded the contract job.

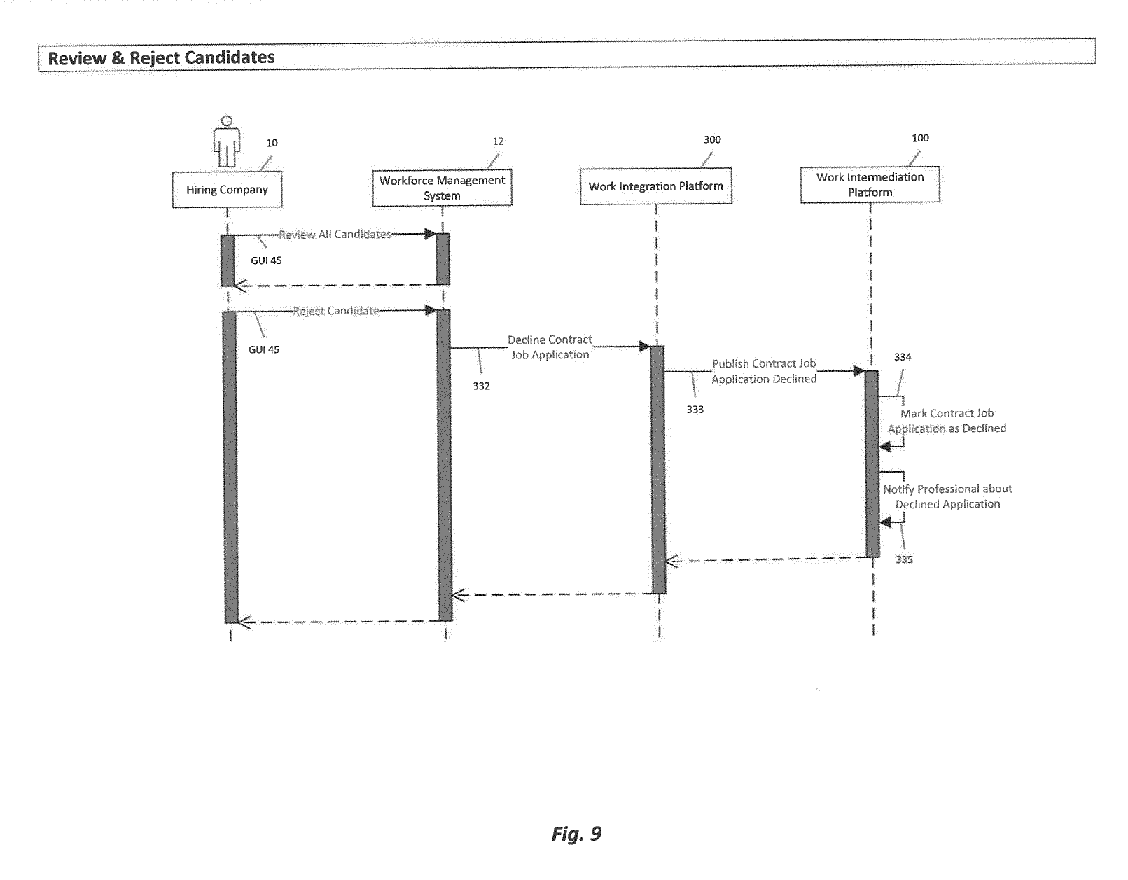

FIG. 9 and rear GUI 45 (FIG. 5A) relate to data transactions following a candidate's decision to apply to the job at the hiring company side. These transactions are enabled by APIs 302 and 306. When a candidate is rejected, the WMS user operates controls 47 whereupon WMS 12 transmits to platform 300 engagement data 332 indicating that the candidate's application has been declined. Platform 300 communicates the declined status directly to the candidate's WIP 100 so that the WIP, upon receipt of the declined status, can enter the candidate's job application 334 as declined, and notify the candidate directly by notification 335 via the candidate's account and personal device 120.

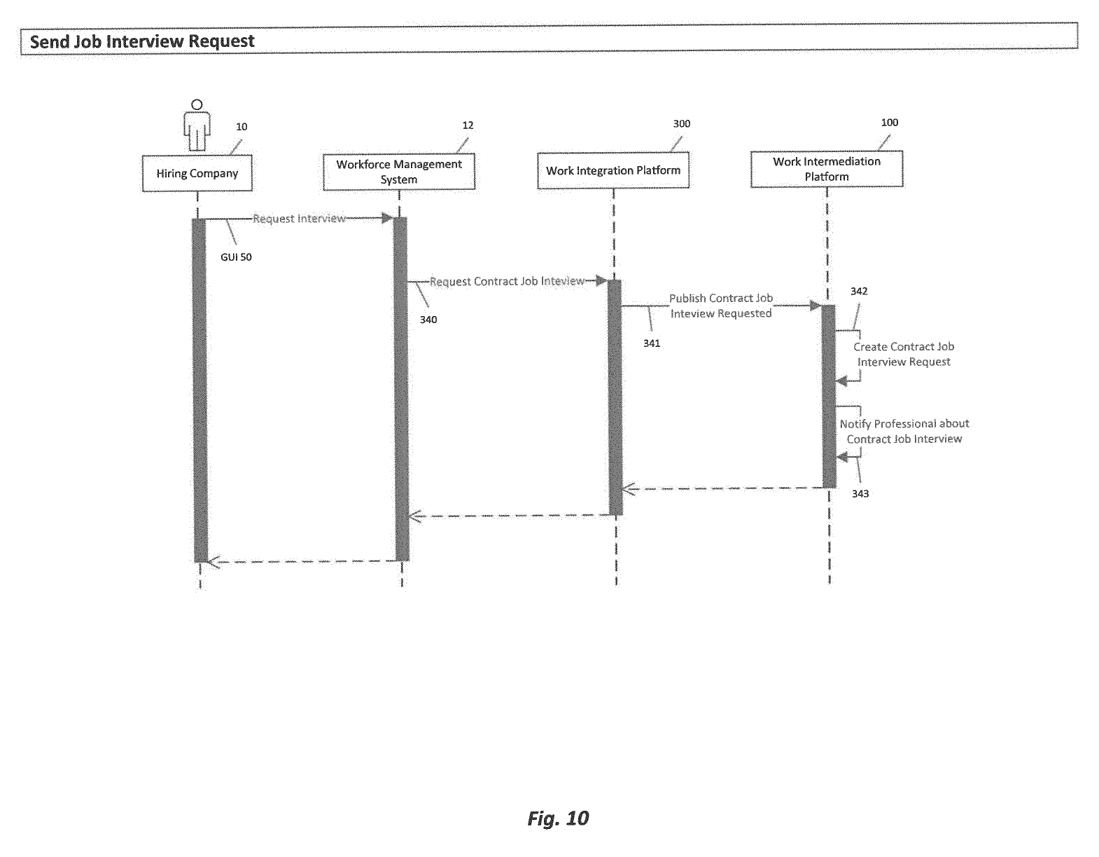

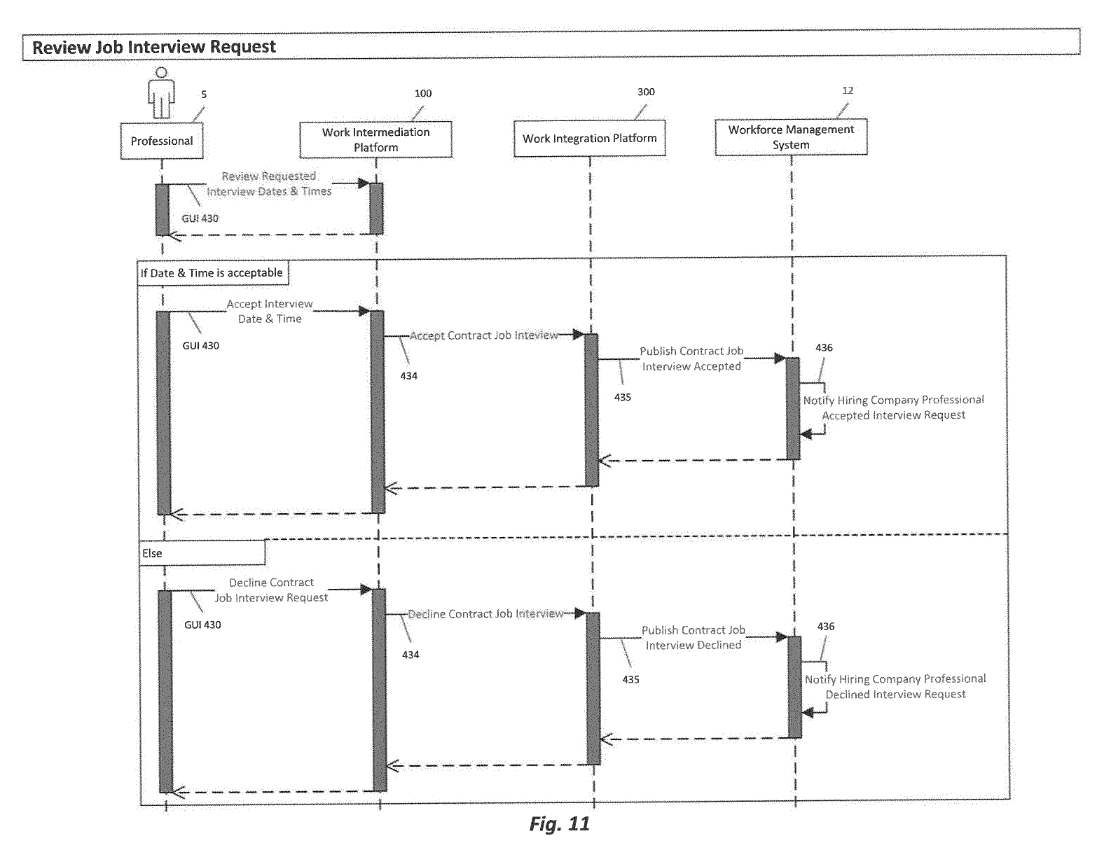

On the other hand, as shown in FIG. 10, with FIG. 5A, when hiring company 10 approves of a particular candidate, the WMS user can operate control 52 of user interface 50 to instruct WMS 12 to transmit data 340 representing a Contract Job Interview Request 1050 (FIG. 3F) via APIs 302, to platform 300. Platform 300 responds by communicating interview request data 341 to the candidate's WIP 100 via APIs 306. The candidate's WIP 100, in response to receipt of the interview request data 341, publishes the interview request on the candidate's account on device 120 as notification 342. Proposed dates and times for the interview request as entered by controls 54 are included within notification 342. FIG. 11, with FIG. 5C, in turn, shows transactions in furtherance of the interview. If a proposed date and time are acceptable to professional 5, the candidate agrees to the interview proposal at his or her WIP account by operating controls 432 of interface 430 accordingly, whereupon, WIP 100 transmits data 434 indicative of the professional's acceptance or decline to platform 300 via APIs 303. Platform 300 transmits the candidate's interview request decision to WMS 12 with data communication 435 via APIs 305. Notification 436 of acceptance or decline is published at work station 14 of the hiring company WMS.

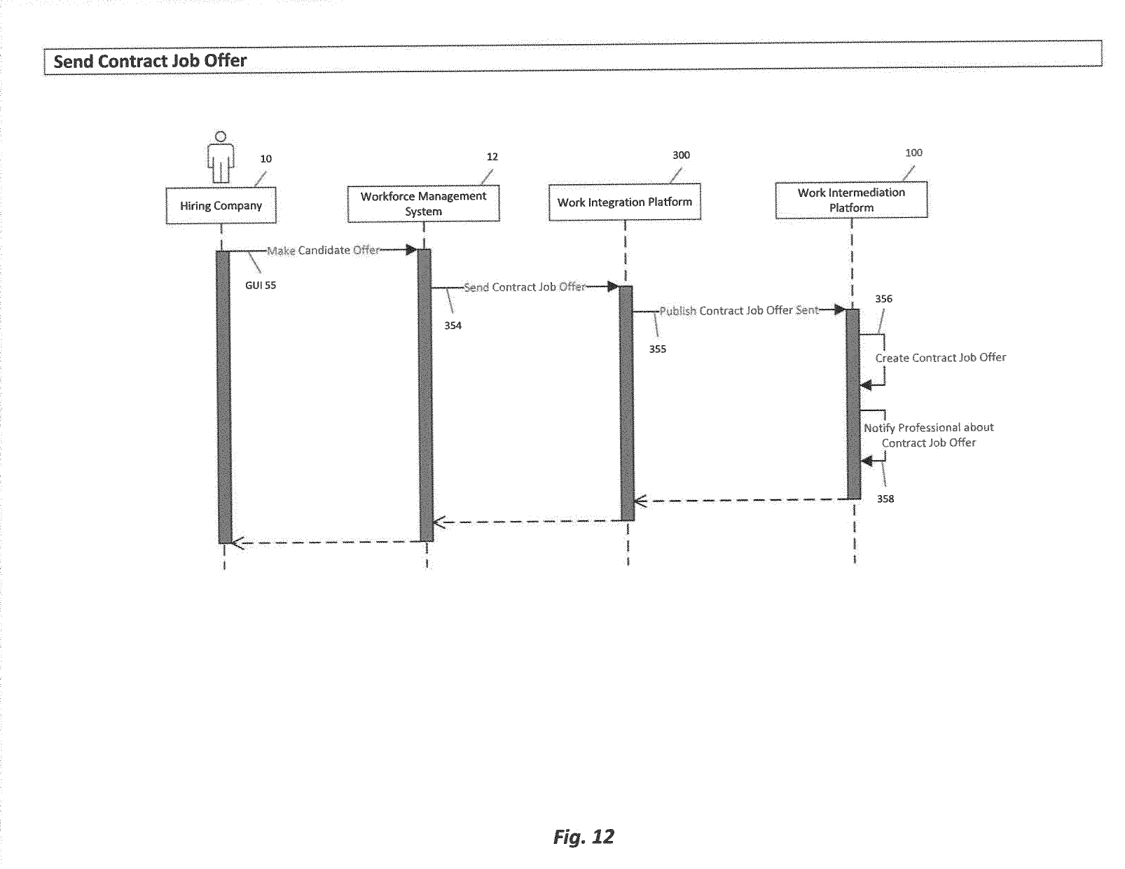

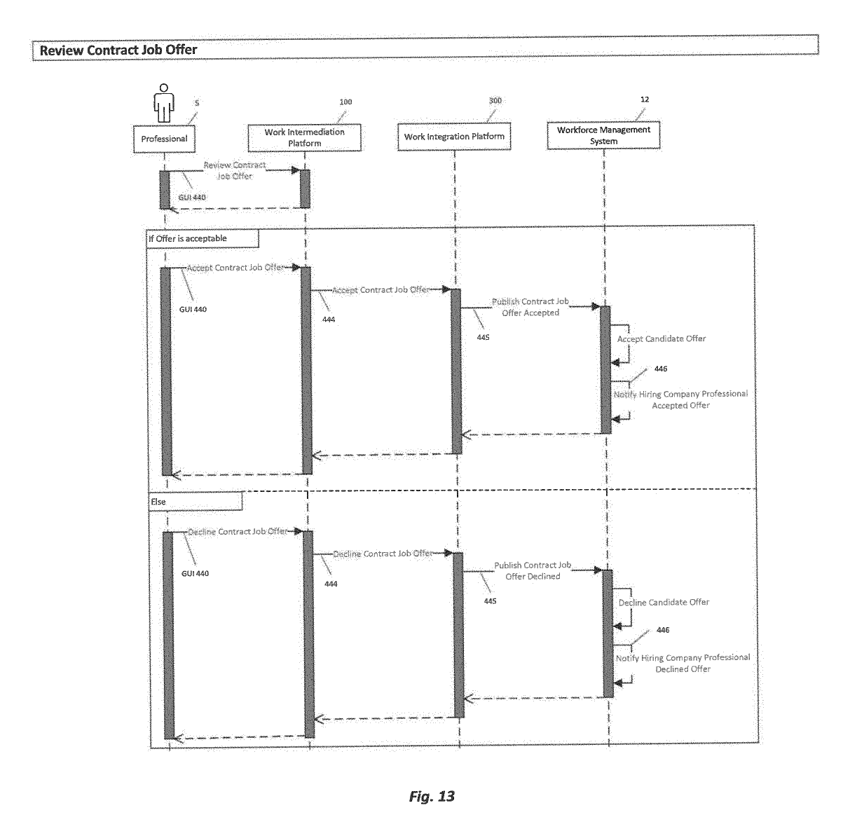

FIG. 12, and FIG. 5A showing rear interface 50 continue engagement data transactions involved in engagement of professional 5. Once a successful engagement interview has been completed, for example, and company 10 decides to make an offer to candidate 5, a company user operates control 57 causing WMS 12 to transmit engagement data 354 representing Contract Job Offer 1060 (FIG. 3F) to platform 300 via APIs 302. Platform 300 responds by transmitting the offer data 355 to the professional's account on WIP 100 via APIs 306. The professional's WIP 100 responds to receipt of the offer data 355 by creating a job offer 356 in electronic form and then posting a notification 358 of the existence of the offer on the professional's client device 120. WIP 100 makes offer 356 available on client device 120 where it can be stored, and if desired printed, to provide the professional with a hard copy of the offer. In FIG. 13, candidate 5 expresses acceptance or refusal of the contract job offer by operating controls 442 of GUI 440 (FIG. 5C) to cause WIP 100 to transmit data 444, indicative of the acceptance or refusal, to platform 300 via APIs 303. Platform 300 transmits the candidate's offer decision to WMS 12 with data communication 445, via APIs 305, for presentation as notification 446 at WMS work station 14.

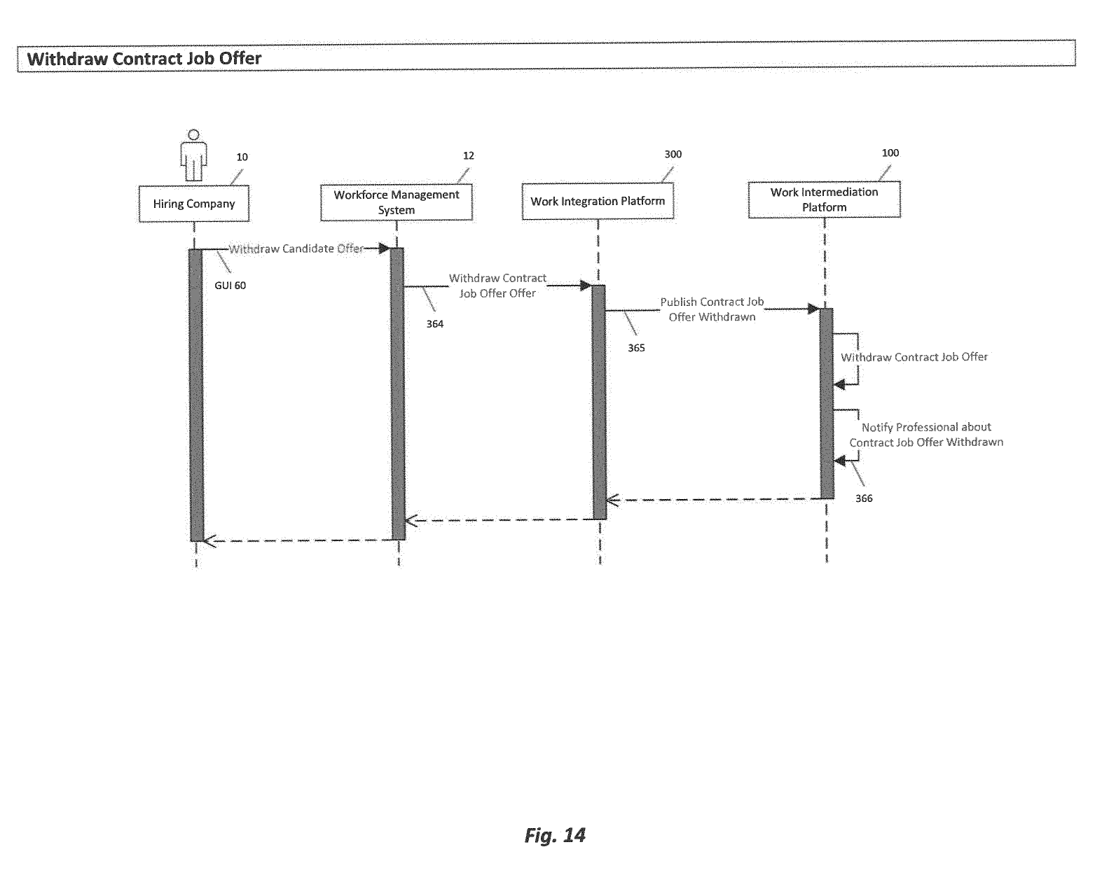

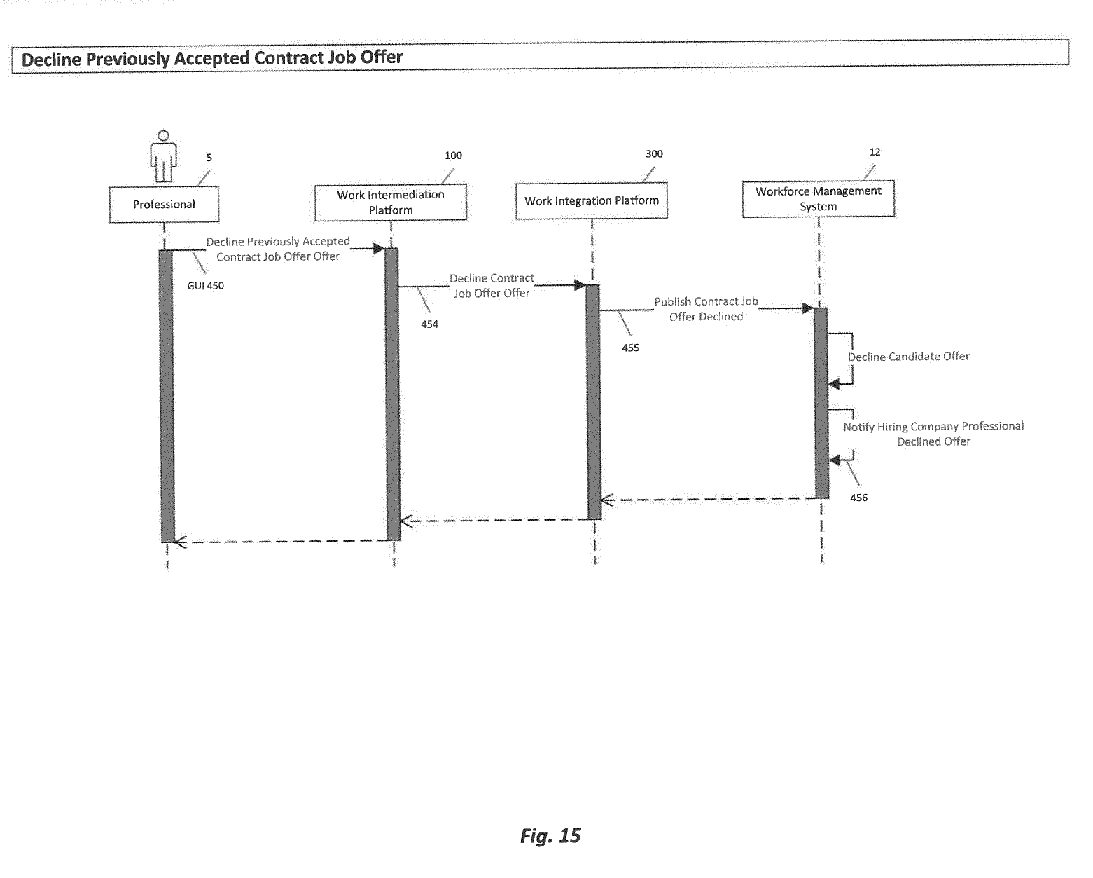

FIG. 14 and FIG. 5A show a transaction in which company 10 elects to withdraw a contract job offer before or after acceptance by the professional by using control 62 on interface 60 which causes WMS 12 to send data 364, indicative of the withdrawal, to platform 300 via APIs 302. Platform 300 transmits data 365, via APIs 306, to the candidate's WIP 100 where a notification 366 of withdrawal is posted to the candidate's account. Similarly, provision is made for a transaction in which professional 5 can decline a job offer after initial acceptance thereof. In FIG. 15, candidate 5, at the candidate's account with rear interface 450 on device 120, operates control 452 to cause WIP 100 to generate and transmit, via APIs 303, data 454 to platform 300 to signal decline of the accepted offer to company 10. Platform 300 accordingly publishes declined offer data 455 to WMS 12, via APIs 305, for notification 456 of the professional's action.

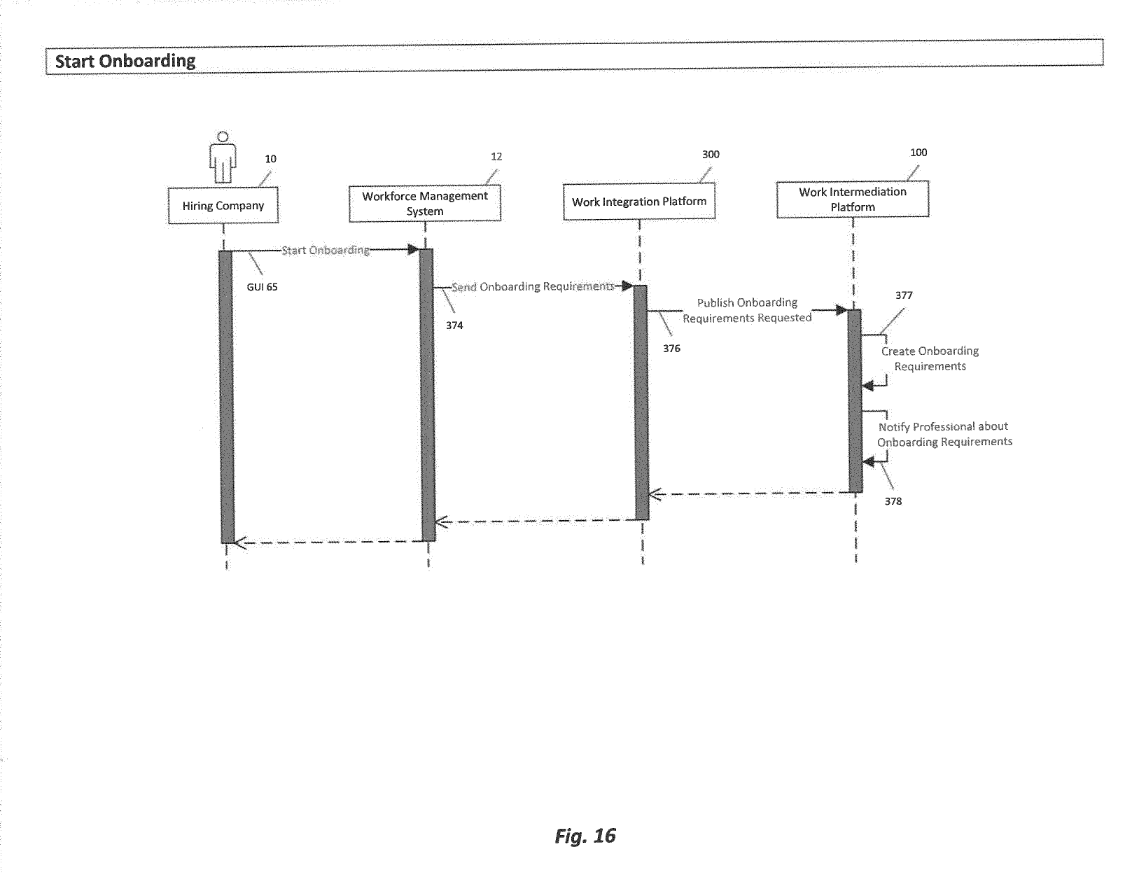

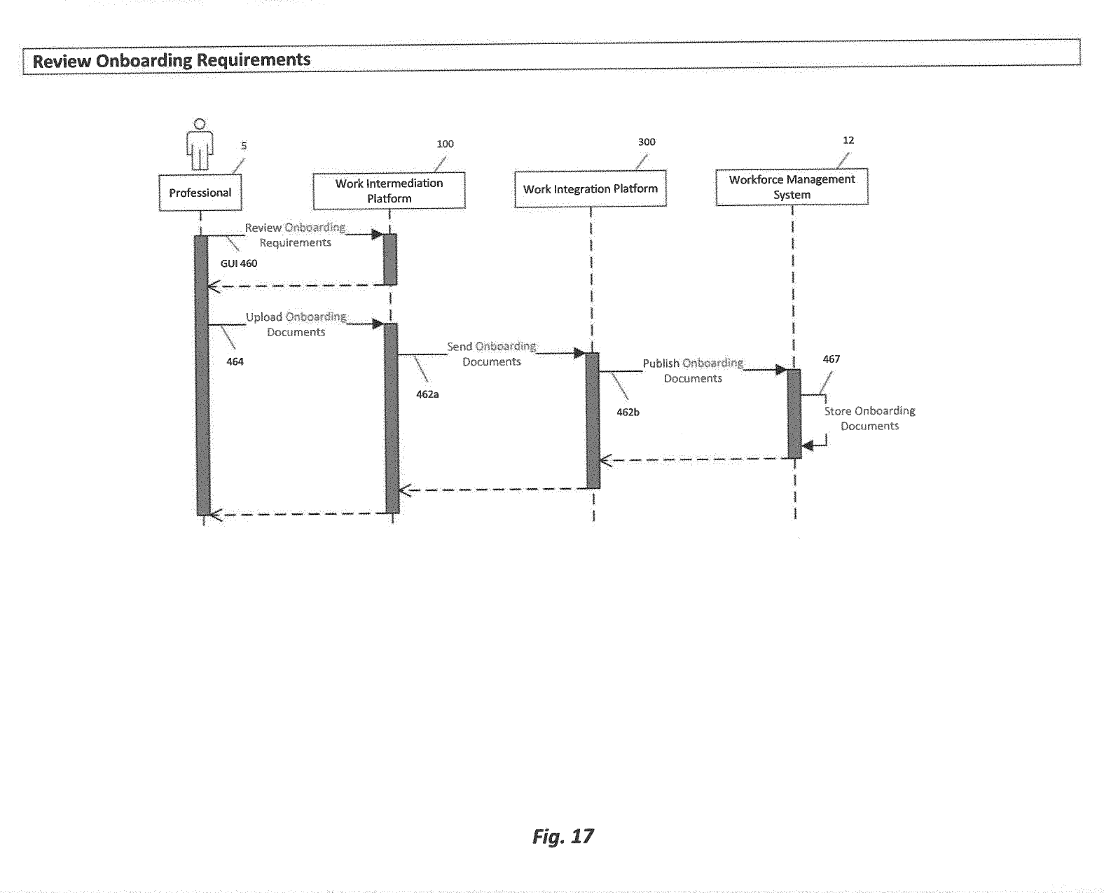

Next, FIG. 16 sequences transactions following acceptance of a job request, namely, the initiation of onboarding. Approval for onboarding is given at the work station 14 via rear interface 65 (FIG. 5A) and controls 67 at WMS 12, and is transmitted as data 374, representing Contract Job Onboarding Requirements 1070 (FIG. 3F), by WMS 12 to platform 300 via APIs 302. Platform 300 transmits data 376, via APIs 306, to the professional's WIP 100 which causes WIP 100 to create onboarding requirements 377. WIP 100 displays a notification 378 on client device 120 that the onboarding requirements have been sent. The requirements, presented in electronic form 377, are available on client device 120 at interface 460 shown in FIG. 5C. Thereafter, FIG. 17 depicts the continuation of onboarding from the professional's perspective. Candidate 5 reviews the onboarding requirements 377 while presented in GUI 460 on device 120. Candidate 5 uploads the required documentation 462 from the client device into WIP 100. Thus, if the onboarding documentation is satisfactory, candidate 5 operates interface controls 464 to instruct WIP 100 to transmit data 462a representative of the uploaded onboarding documents to platform 300 via APIs 303. Platform 300 transmits data 462b representative of received onboarding documentation to WMS 12, via APIs 305, which causes WMS 12 to store the onboarding documents 467.

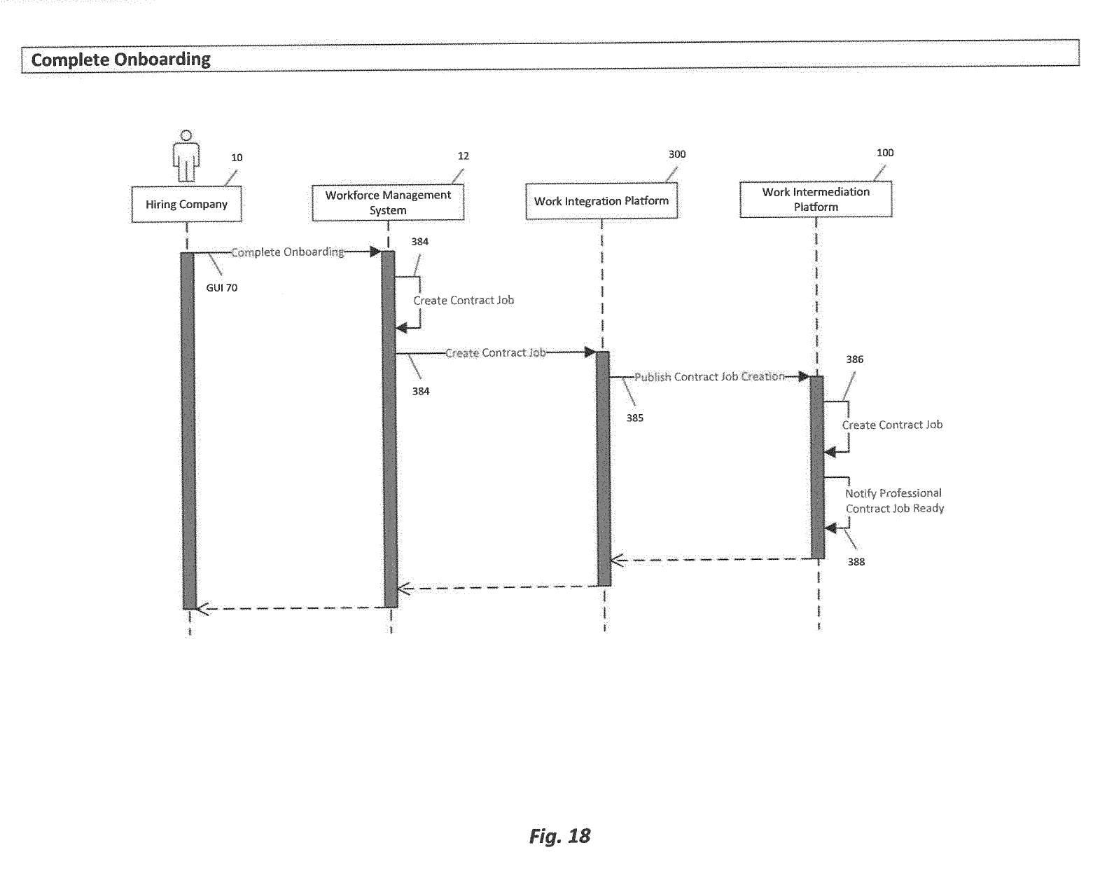

Engagement data flow thereafter continues with FIG. 18 wherein company personnel, having received and reviewed the onboarding documentation 467, complete onboarding on interface 70 with operation of controls 72 which instruct WMS controller 22 and hiring functionality 32 to access database 18a and generate a formal contract. Data 384 representative of an actual contract are provided to platform 300 via APIs 302. Platform 300 transmits the contract data 385, containing Contract Job 1080 (FIG. 3F), to the professional's WIP 100, via APIs 306, such that WIP 100 is controlled to produce an electronic version 386 of a formal contract represented by the transmitted data 384 at client device 120. Notification 388 appears at the professional's WIP account to apprise professional 5 of the created contract 386.

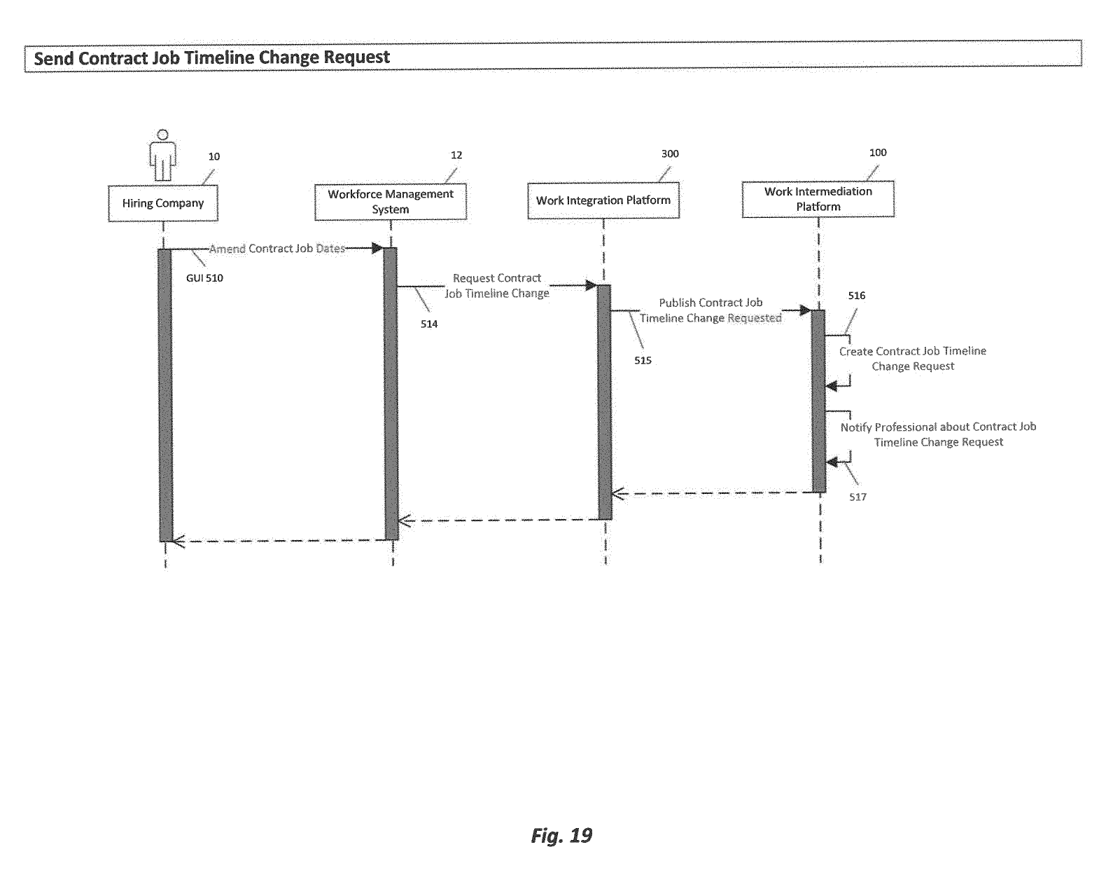

The system 1 of the present invention further contemplates that, from time to time, changes in a contract job may become necessary. Such will be seen from FIGS. 19-24. The system continues to rely upon platform 300 as the intermediary for transmissions between each WMS 12 and each WIP 100, which transmissions of “administration data” will be generated as necessary to represent transactions done during the life of a contract job. These transmissions likewise occur over the channels established by APIs 302, 303, 305, 306 that place platform 300 between WMS 12 and WIP 100.

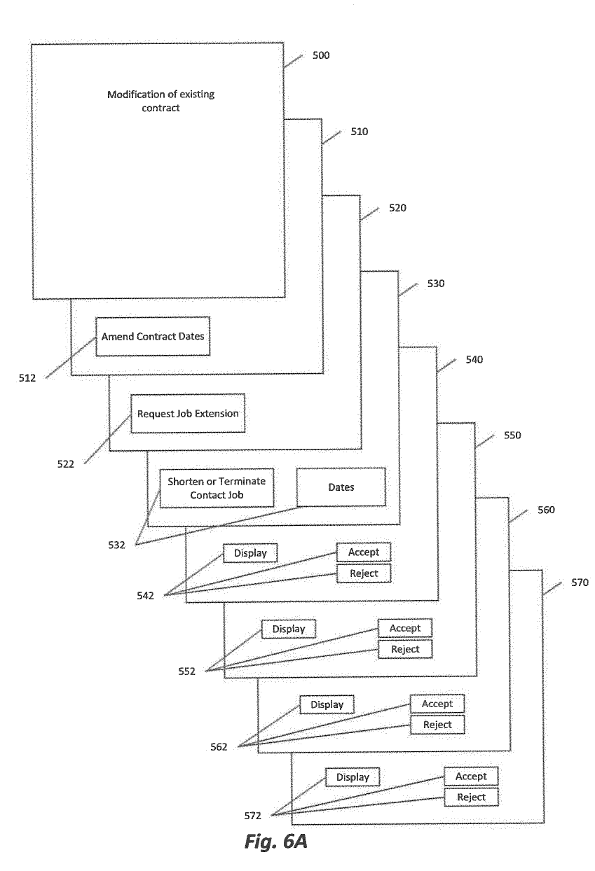

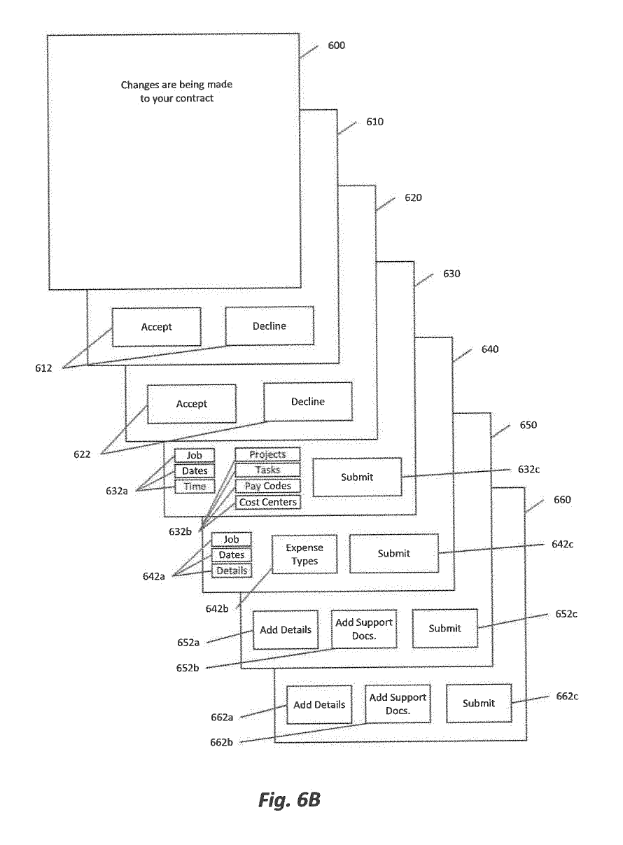

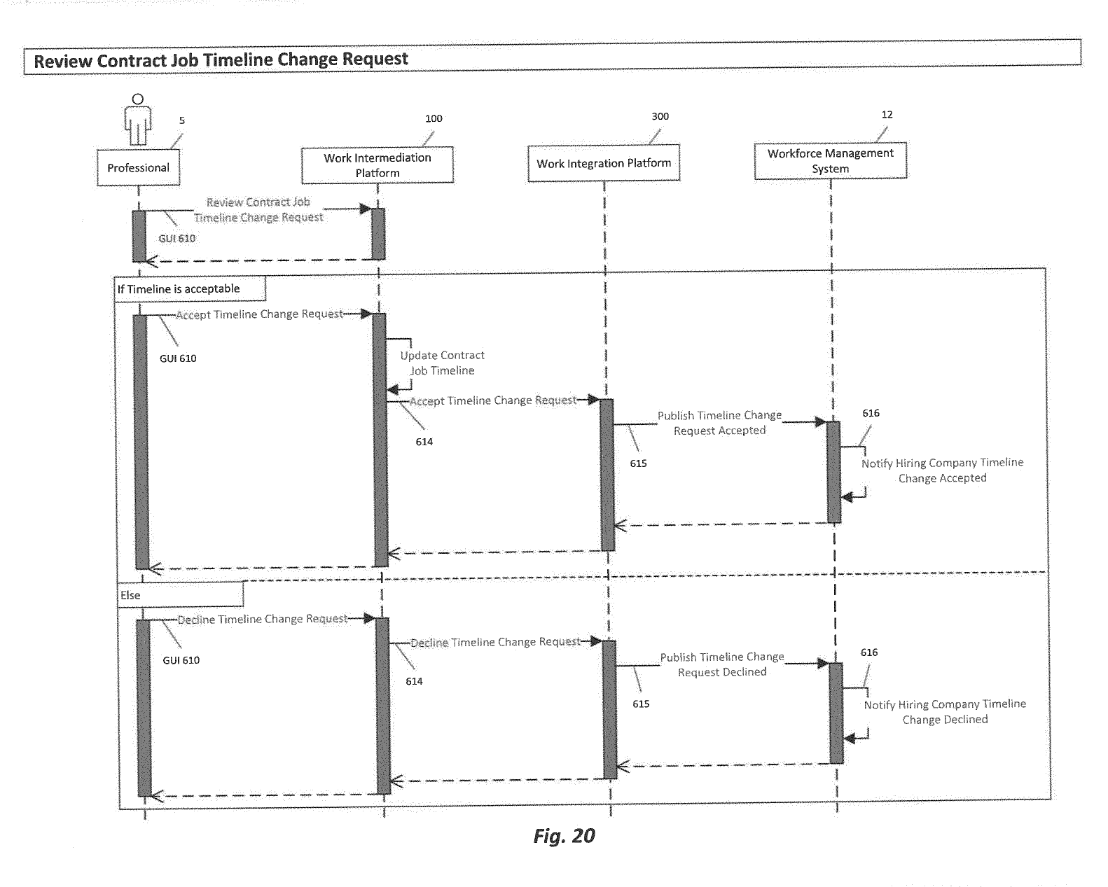

First, reference is made to FIG. 6A that shows another front end WMS GUI 500. Interface 500 offers an exemplary menu of common contract changes. For instance, rear interface 510 and FIG. 19 show an example of amendment of contract job dates. On work station 14, the WMS user enters a contract job timeline change request via controls 512 which cause WMS 12 to send data 514, representing a Contract Job Timeline Change Request 1090 (FIG. 3F), to platform 300. Platform 300 transmits corresponding data 515 to the WIP account of a professional under contract via APIs 306. WIP 100 responds to receipt of the transmitted timeline change request data 515 by registering the change request. creating an electronic version 516 of a formal change request and posting a notification 517 therefor in the WIP account of the contracted professional 5. In these examples, GUI 600 is a front end WIP interface apprising the contracted professional 5 that the professional's company 10 is requesting a contract change. Rear interface 610 corresponds to notification 517 of FIG. 19. Next, FIG. 20 shows review of the timeline change notification request by professional 5, and the professional's action at controls 612 in response. If the contracted professional 5 agrees to the change, WIP 100 automatically updates the contract timeline to accommodate the change. In this case, professional 5 expresses agreement to the timeline change at his or her WIP account by operating controls 612 of interface 610 accordingly, whereupon, WIP 100 transmits data 614 indicative of the professional's acceptance or decline to platform 300 via APIs 303. Platform 300 transmits the professional's decision to WMS 12 with data communication 615 via APIs 305. Notification 616 of acceptance or decline is caused to be published at work station 14 of the hiring company WMS.

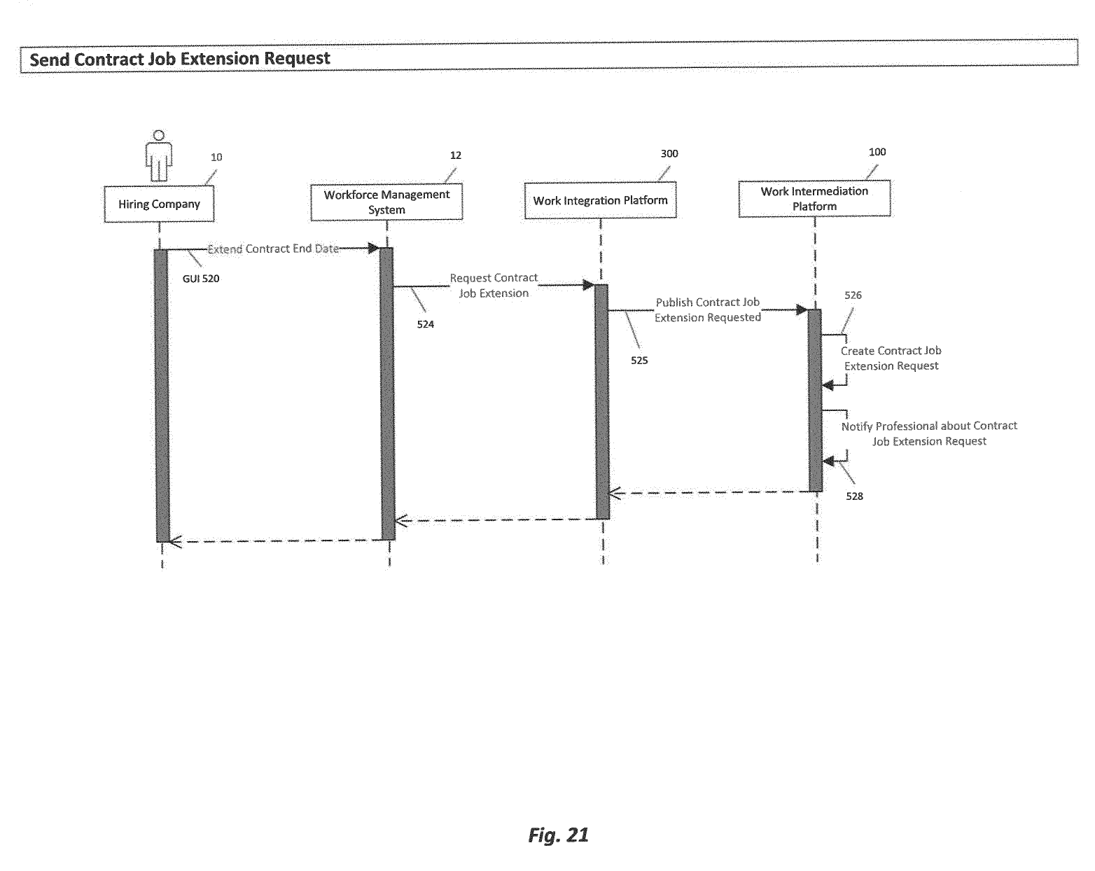

FIGS. 6A, 6B and 21 continue with commonplace transactions originating from change requests. FIG. 21 demonstrates data transmission for a request by hiring company 10 to extend contract work. At work station 14, the WMS user accesses rear interface 520 with controls 522 to enter a request for contract job extension which causes WMS 12 to send data 524, containing Contract Job Extension Change Request 1100 (FIG. 3F), to platform 300. Platform 300 transmits data 525 to the WIP account of a professional under contract via APIs 306. WIP 100 responds to receipt of the transmitted extension change request data 525 by registering the extension request, creating an electronic version 526 of the formal extension request and posting a notification 528 by interface 620 on the professional's device 120 to apprise the contracted professional of the request.

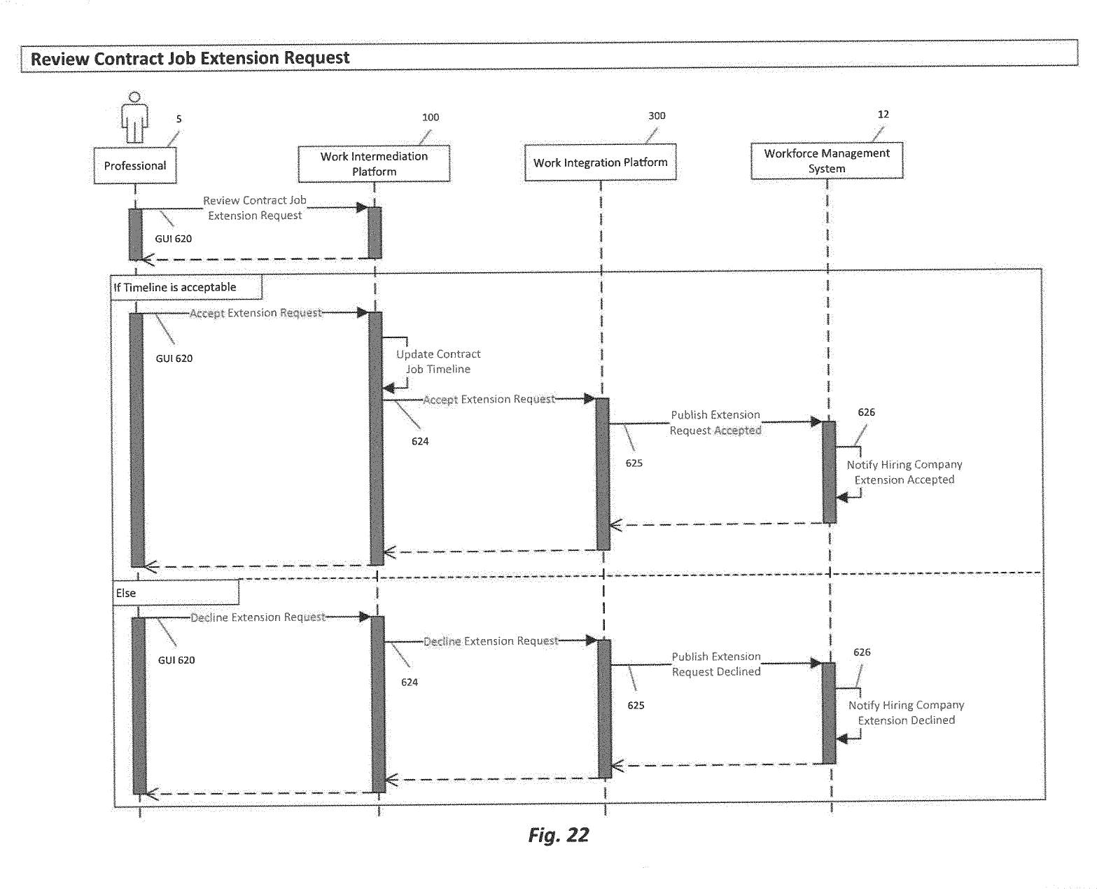

As seen from FIG. 22, professional 5 reviews the extension request and responds accordingly by accepting or rejecting the request via interface controls 622. If the contracted professional 5 agrees to the extension, WIP 100 automatically updates the contract timeline to accommodate the extension. The Professional 5 indicates agreement to the timeline change at his or her WIP account by operating controls 622 of interface 620 accordingly, whereupon, WIP 100 transmits data 624 indicative of the professional's acceptance (or decline) to platform 300 via APIs 303. Platform 300 transmits the professional's decision to WMS 12 with data communication 625 via APIs 305. Notification 626 of acceptance (or decline) is published at work station 14 of the hiring company WMS.

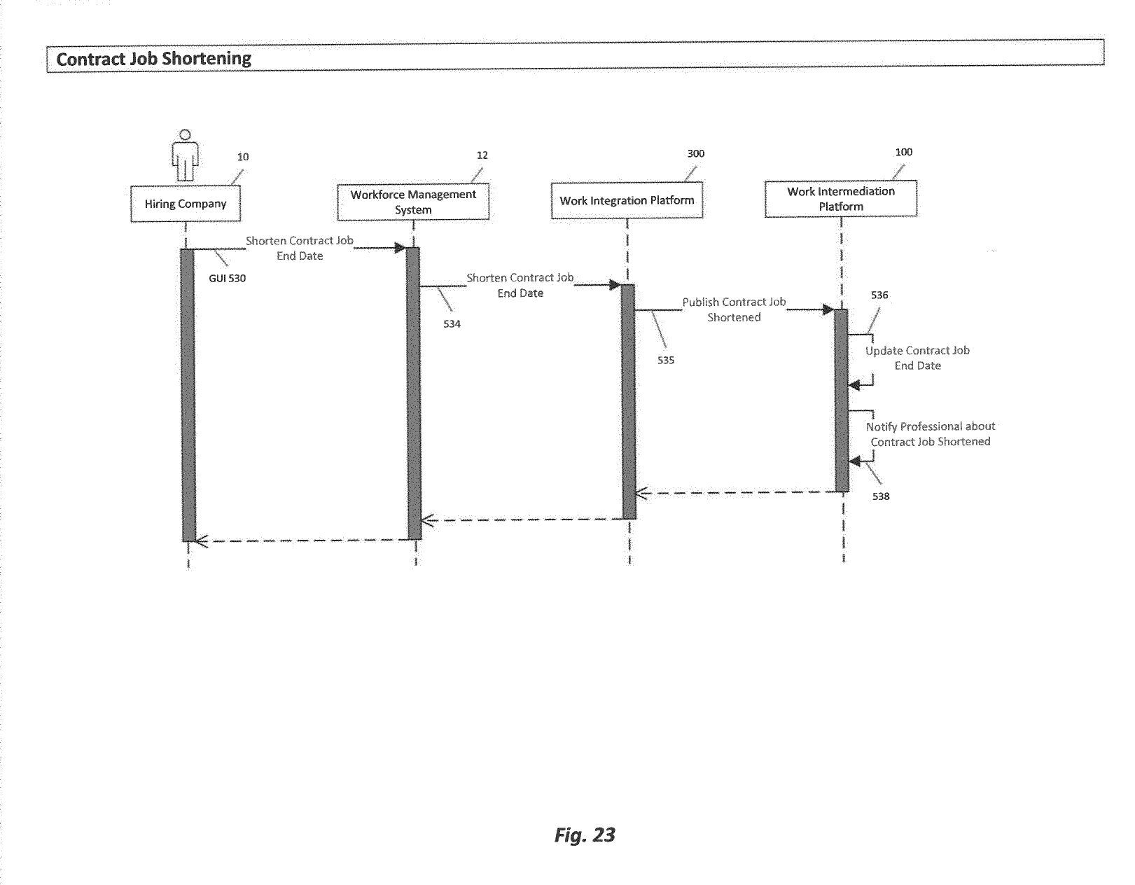

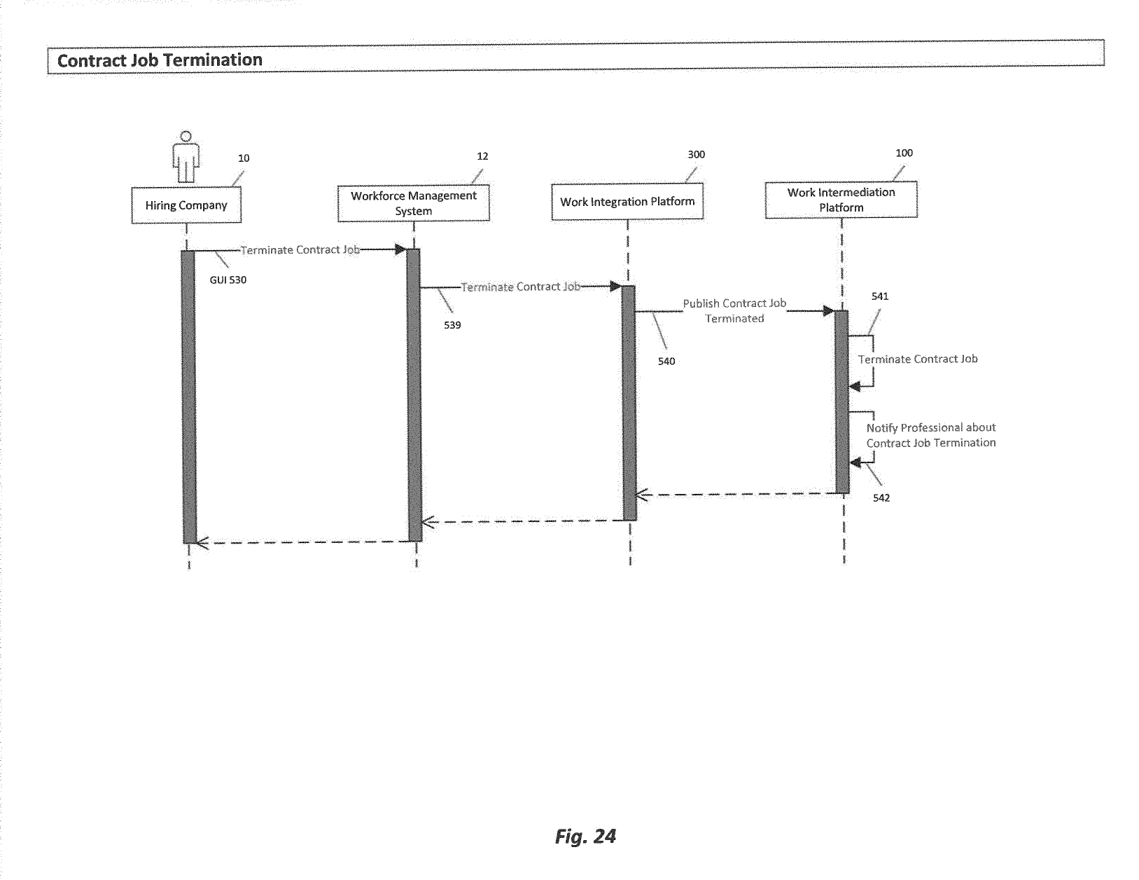

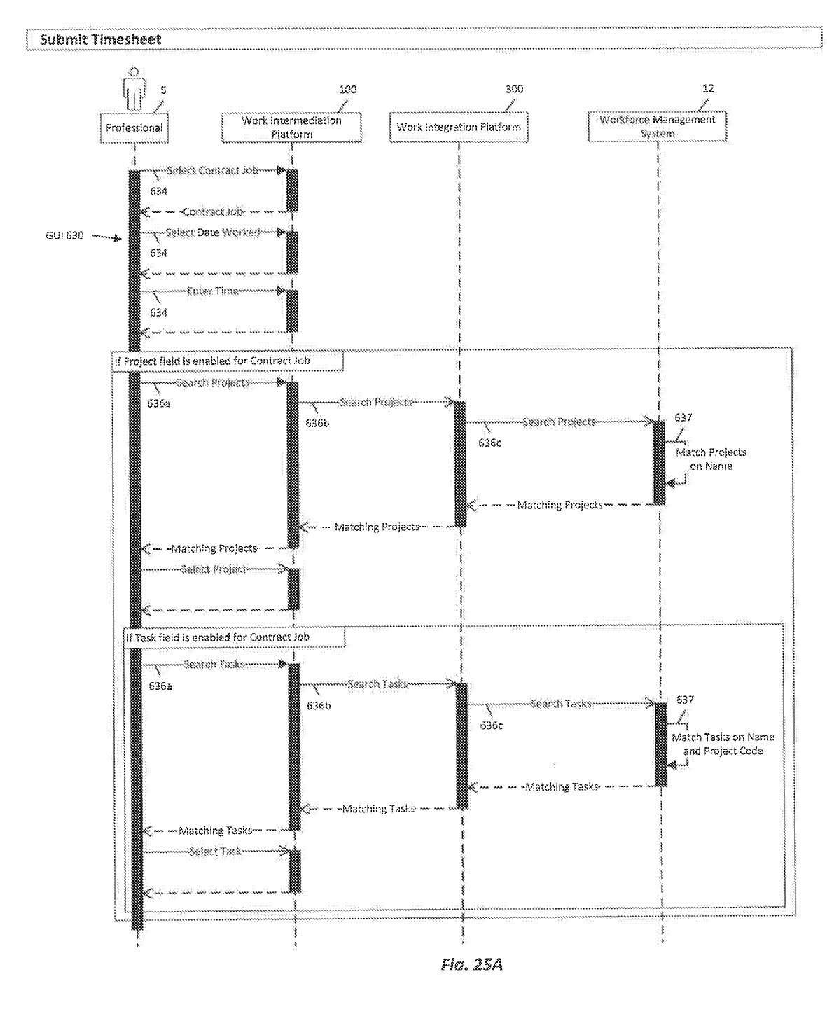

FIG. 23 depicts action by hiring company 10 to shorten a contract job. For this administrative data transaction, the WMS user accesses rear interface 530 and operates controls 532 to cause WMS 12 to transmit data 534 indicative of the hiring company's decision to truncate the job to platform 300. Platform 300 transmits data 535 to the professional's WIP 100 to update the contract job end date 536 and provide for notification 538 on the professional's device 120. At the same time, WIP 100 registers the new contract end date 535. The WMS initiated data transaction of FIG. 24 is similar to that of FIG. 23. In the preferred embodiments, this transaction also involves WMS interface 530 and controls 532. Here, controls 532 cause WMS 12 to transmit data 539 indicative of the hiring company's decision to terminate the job to platform 300. Platform 300 transmits data 540 to the professional's WIP 100 to terminate the contract job 541 and provide for notification of termination 542 on the professional's WIP account at the professional's device 120.

As is now understood, the networked system of the present invention remains instrumental in administration of an ongoing job, throughout the life of the contract. It further provides for channeling several other species of data pertaining to contract administration between professional 5 under contract and hiring company 10.

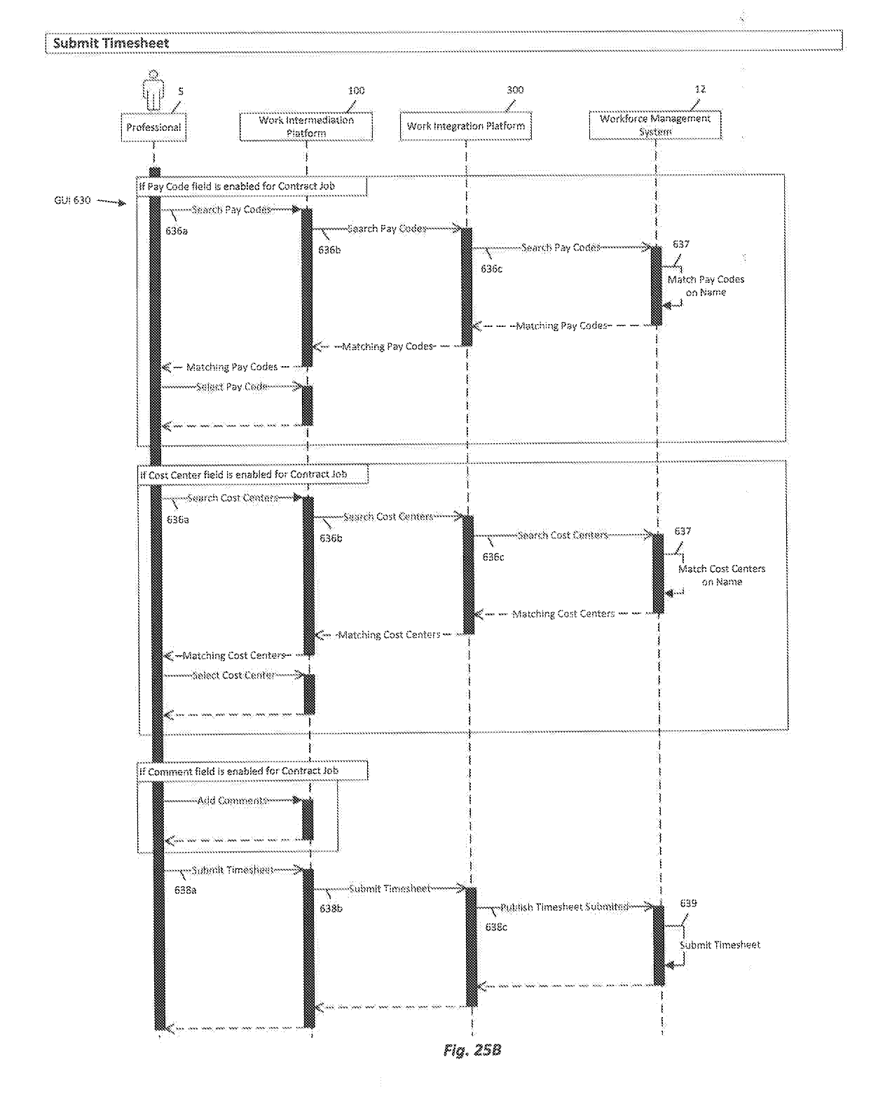

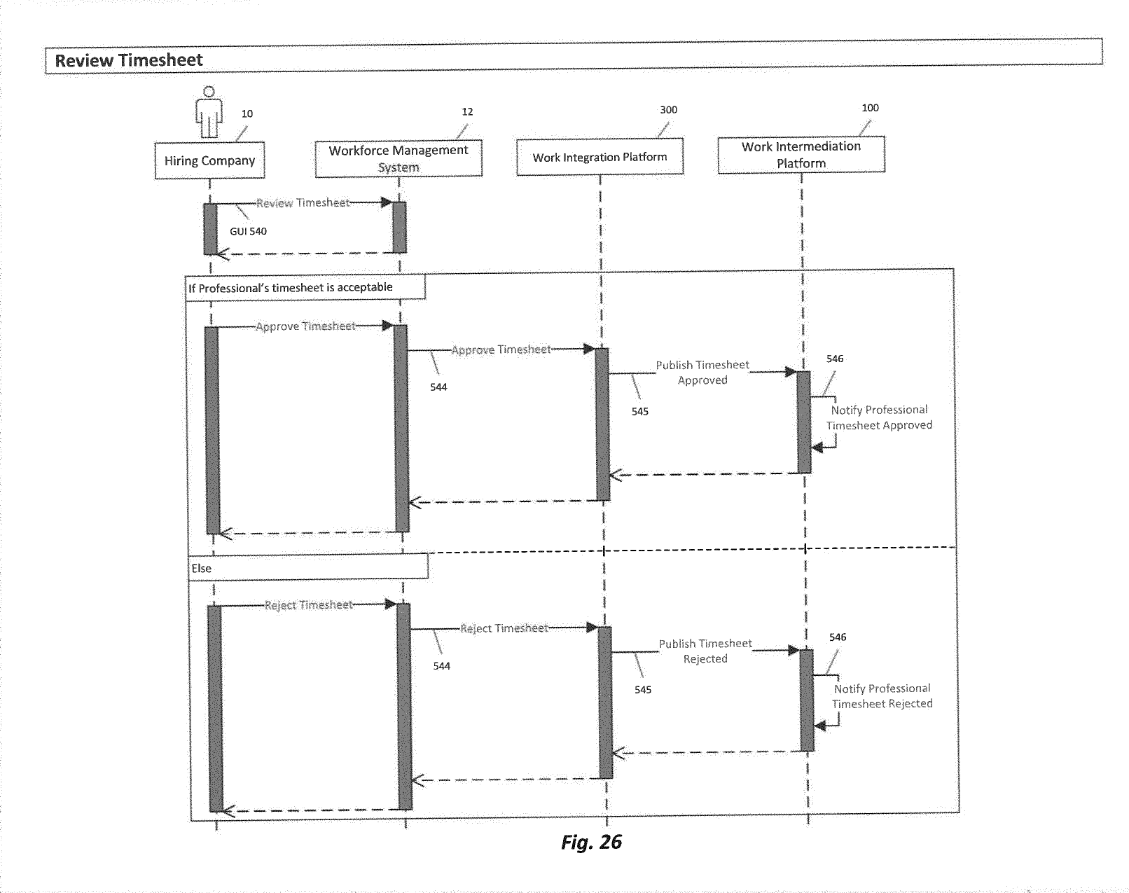

FIGS. 3F, 6A, 6B, 25A, 25B and 26 illustrate timesheet submissions and review. For timesheet submission, professional 5 accesses WIP interface 630 to enter as administrative data 634, a particular job, the dates, and the time worked during the job for which the professional wishes to submit a timesheet. In the preferred implementation, interface 630 provides three distinct sets of controls, a first set 632a of search controls for data accessible directly from the professional's WIP 100, a second set of 632b of search controls for querying WMS 12, via platform 300 and APIs 303, 305, of the company at which the professional is employed, and a third set 632c for governing actual submission of administrative data representative of a completed timesheet to WMS 12. Control set 632a channels transmissions of administrative data 634 only between the contracted professional's personal device 120 and WIP 100. Control set 632b, by contrast, causes WIP 100 to transmit the user entered search criteria data 636a indicative of any or all of projects, tasks, pay codes and cost centers to platform 300, via APIs 303, as data 636b. Platform 300 responds by transmitting data 636c to WMS 12 for matching the search criteria with corresponding project, task, pay code and cost center data stored in WMS database 18a. Platform 300 thereafter receives matching data 637 (Time Entry Project 1120, Time Entry Task 1130, Pay Code 1140 or Cost Center 1150) from WMS 12 and transmits this back to the professional's personal device 120 via his or her WIP 100 by using APIs 306. Thereafter, the professional completes an electronic version of a timesheet 638a and operates controls 632c to cause WIP 100 to transmit data 638b (Timesheet 1110 FIG. 3F) representing the completed timesheet to platform 300, via APIs 303, with information from the selection of project, task, pay code and cost center data and, if desired, any added comments. Platform 300 transmits particular administrative data 638c representing the timesheet to WMS 12 where data 639 (Timesheet 1110) is presented for review at the company side. FIG. 26, accordingly, shows activity at the company side upon receipt of data representing the submitted timesheet (Timesheet 1110). The submitted timesheet (Timesheet 1110) is reconstructed in interface 540 at WMS 12 for approval or rejection accordingly. Controls 542 are provided to enable company 10 to transmit data 544 indicative of its decision to platform 300 via APIs 302. Platform 300 responds by transmitting data 545 to the submitting professional's WIP 100. WIP 100 responds by posting notification 546 on the professional's device 120 to advise of approval or rejection of timesheet (Timesheet 1110).

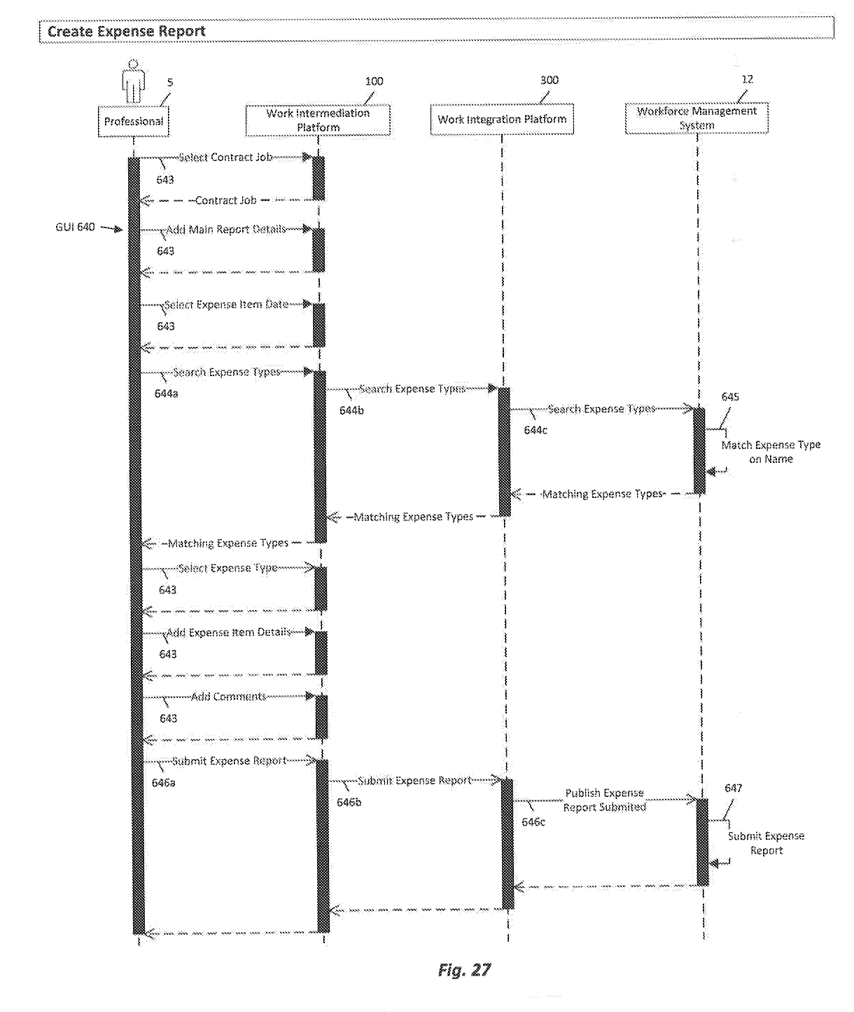

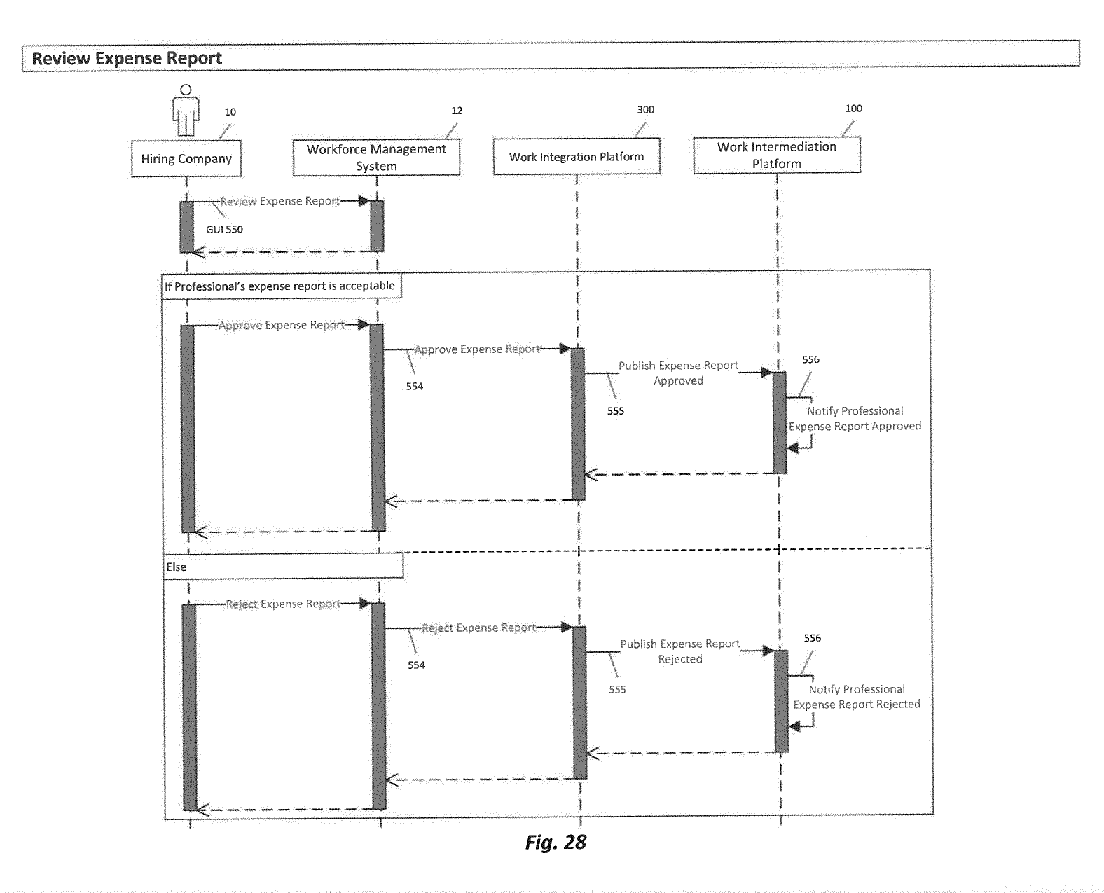

FIGS. 3F, 6A, 6B, 27 and 28 depict a procedure, similar to that for timesheet construction and submission, for expense reporting. At the contracted professional's side, professional 5 selects WIP interface 640 to designate the appropriate contract job at WIP 100 and enters, as administrative data, necessary expense data 643 such as the date an expense was incurred, the type of expense, and details of the incurred expense. As with controls 632a for timesheet submission, the interface controls 642a are between only the professional's personal device 120 and the professional's WIP 100. Control set 642b, by contrast, causes WIP 100 to transmit the user entered search criteria data 644a indicative expense type to platform 300, via APIs 303, as data 644b. Platform 300 responds by transmitting data 644c to WMS 12 for matching the search criteria with corresponding expense type data stored in WMS database 18a. Platform 300 thereafter receives matching data 645 (Expense Type 1170) from WMS 12 and transmits this back to the professional's personal device 120 via his or her WIP 100 using APIs 306. Thereafter, the professional completes an electronic version of an expense report 646a and operates controls 642c which causes WIP 100 to transmit data 646b (Expense Report 1160) representing the completed report to platform 300 via APIs 303. Platform 300 responds by transmitting data 646c to WMS 12 where the expense report data 647 (Expense Report 1160) is presented for review at the company side. FIG. 28, accordingly, shows activity at the company side upon receipt of data 646c representing the submitted expense report 647 (Expense Report 1160). The expense report (Expense Report 1160) is reconstructed in interface 550 at WMS 12 for approval or rejection accordingly. Controls 552 are provided to enable company 10 to transmit data 554 indicative of its decision to platform 300 via APIs 302. Platform 300 responds by transmitting data 555 to the submitting professional's WIP 100. WIP 100 responds by posting notification 556 on the professional's device 120 to advise of approval or rejection of expense report (Expense Report 1160).

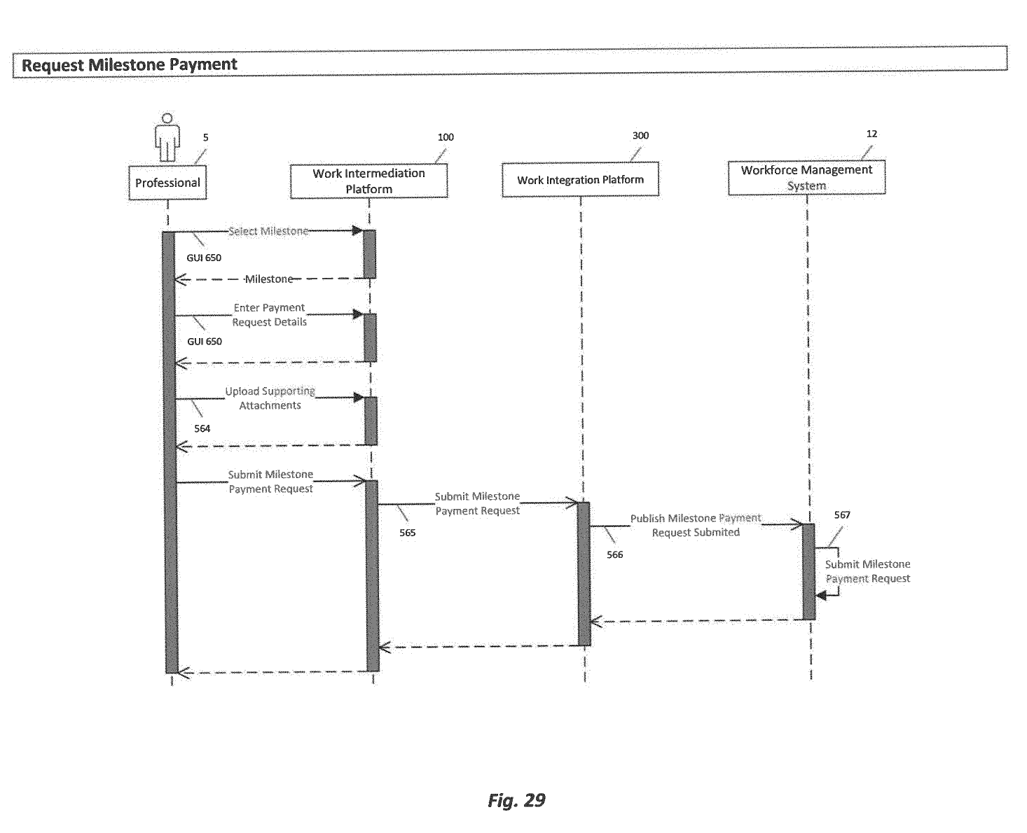

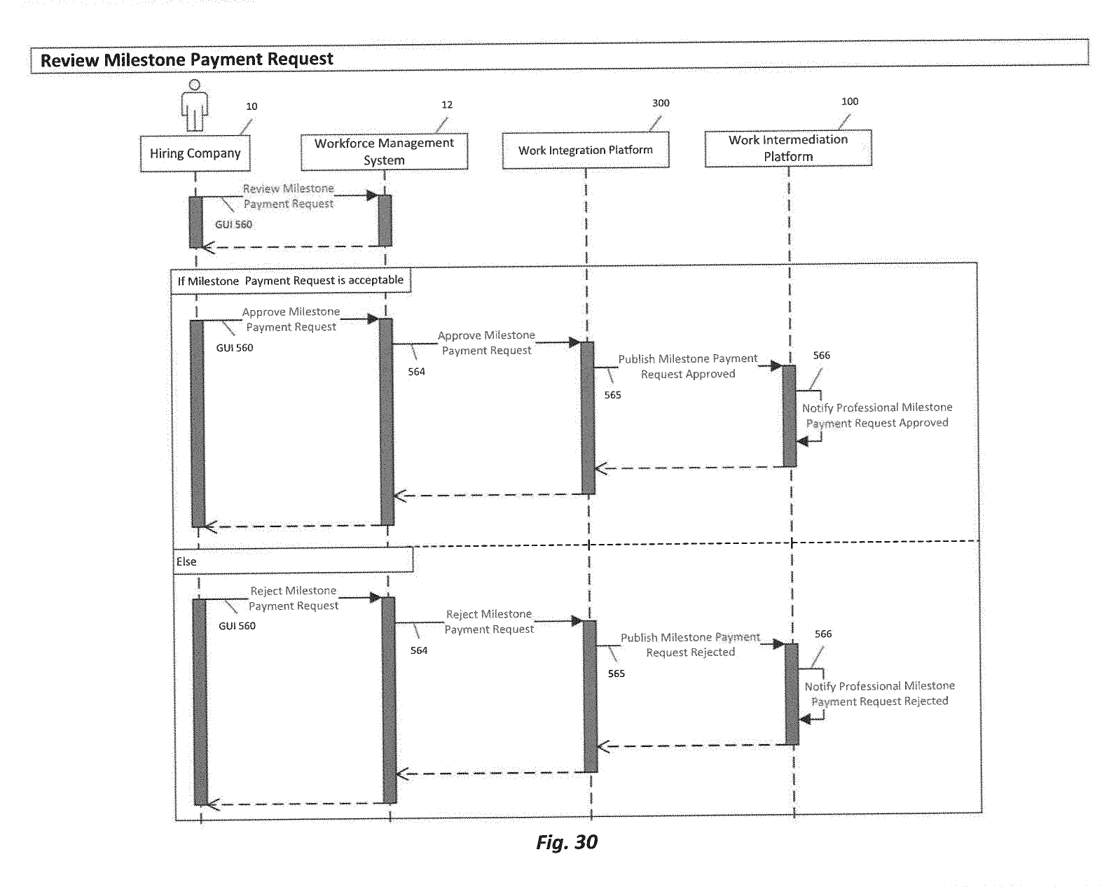

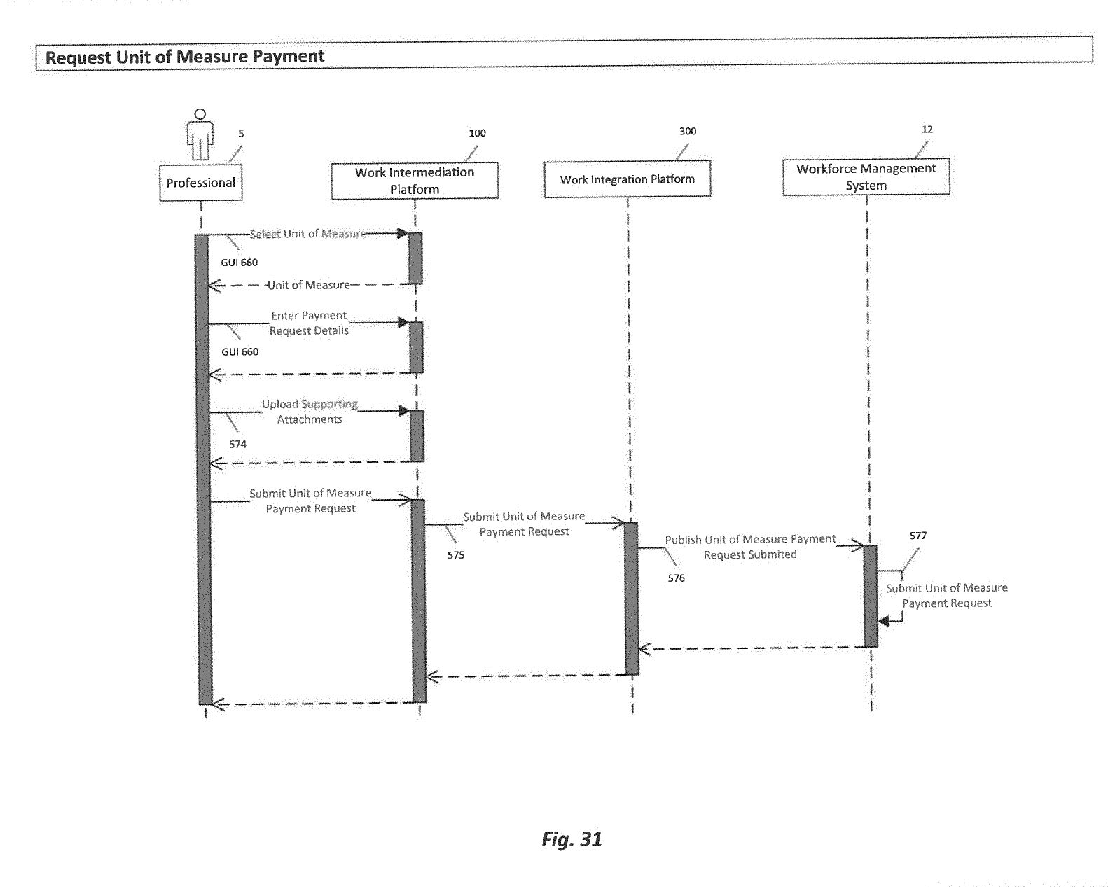

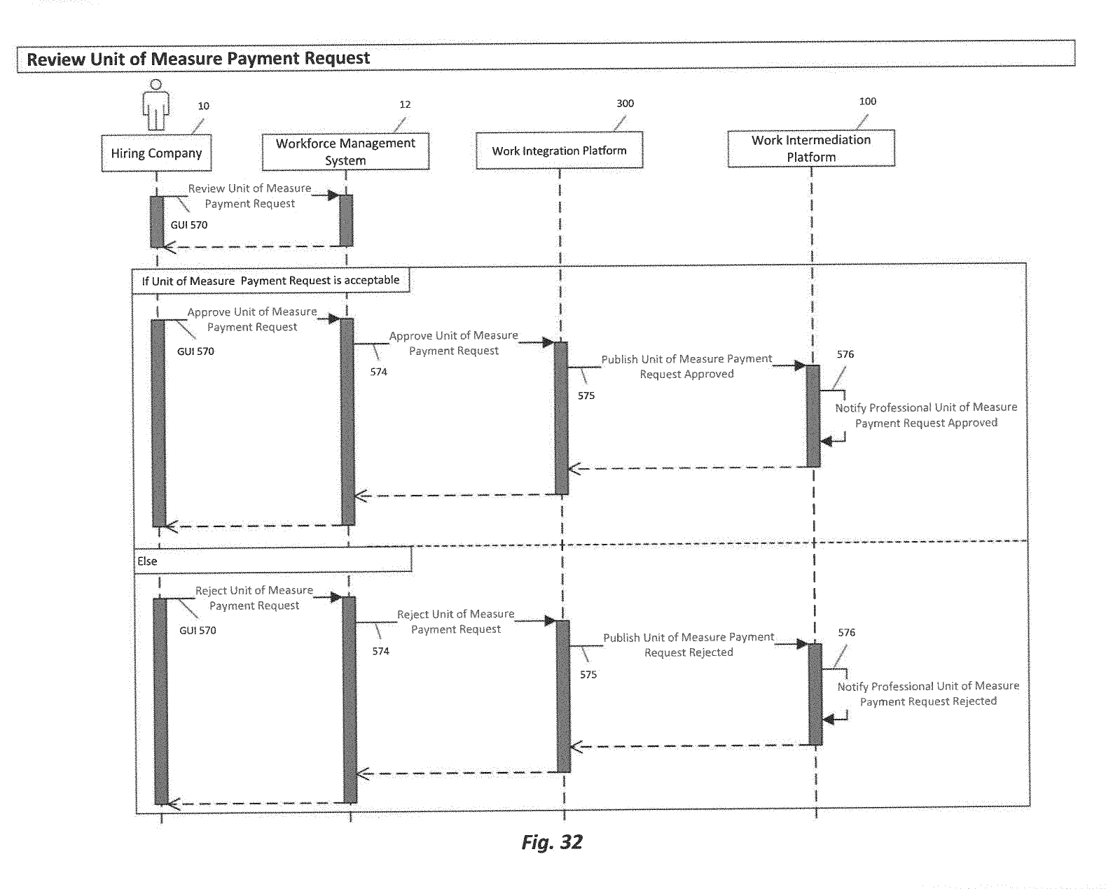

Reference now will be made to FIGS. 29-32, and handling of specific payment requests from the contracted professional in connection with an ongoing or completed contract job. These transactions are similar to that for timesheet and expense report submission. FIGS. 29 and 30 illustrate milestone payment requests while FIGS. 31 and 32 pertain to unit of measure payment requests. Each of these payment request processes, as well as other payment request processes known to those of ordinary skill in the art, begins with plural transmissions between only professional 5 at the professional's client 120 and the professional's WIP 100.

In FIG. 29, professional 5 uses GUI 650 to communicate directly with the professional's WIP 100 and accordingly operates controls 652a for entering details related to the milestone payment request. Controls 652b enable professional 5 to upload receipts and other documents as attachments 564 in support of the request. Thereafter, professional 5 operates controls 652c to instruct WIP 100 to transmit data 565, representing Milestone Payment Request 1230 (FIG. 3F), to platform 300 via APIs 303. Platform 300 then transmits data 566 representing the milestone payment request and any supporting documentation to WMS 12 via APIs 305 to record the milestone payment request 567 (Milestone Payment Request 1230). Then, as depicted in FIG. 30, the milestone payment request (Milestone Payment Request 1230) is reconstructed in interface 560 at WMS 12 for approval or rejection accordingly. Controls 562 are provided to enable company 10 to transmit data 564 indicative of its decision to platform 300 via APIs 302. Platform 300 responds by transmitting data 565 according to APIs 306 to the submitting professional's WIP 100. WIP 100 responds by posting notification 566 on the professional's device 120 to advise of approval or rejection of milestone payment request (Milestone Payment Request 1230).

In FIG. 31, professional 5 uses GUI 660 likewise to communicate directly with the professional's WIP 100 and accordingly operates controls 662a for entering details related to a unit of measure payment request. Controls 662b enable professional 5 to upload receipts and other documents as attachments 574 in support of the unit of measure payment request. Thereafter, professional 5 operates controls 662c to instruct WIP 100 to transmit data 575, containing Unit of Measure Payment Request 1240 (FIG. 3F), to platform 300 via APIs 303. Platform 300 then transmits data 576 representing the unit of measure payment request and any supporting documentation to WMS 12 via APIs 305 whereupon the WMS records the unit of measure payment request 577 (Unit of Measure Payment Request 1240). Then, as depicted in FIG. 32, the unit of measure payment request (Unit of Measure Payment Request 1240) is reconstructed in interface 570 at WMS 12 for approval or rejection accordingly. Controls 572 are provided to enable company 10 to transmit data 574 indicative of its decision to platform 300 via APIs 302. Platform 300 responds by transmitting data 575 via APIs 306 to the submitting professional's WIP 100. WIP 100 responds by posting notification 576 on the professional's device 120 to advise of approval or rejection of unit of measure payment request (Unit of Measure Payment Request 1240).

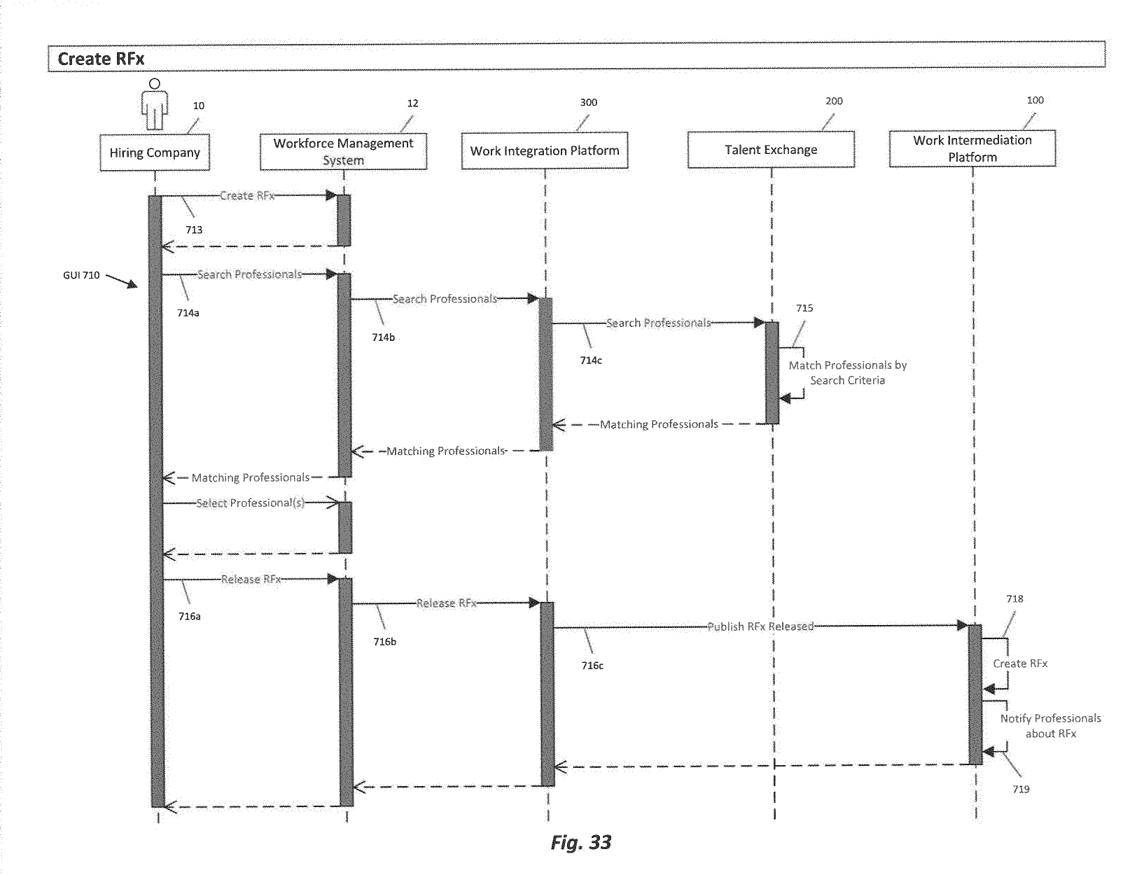

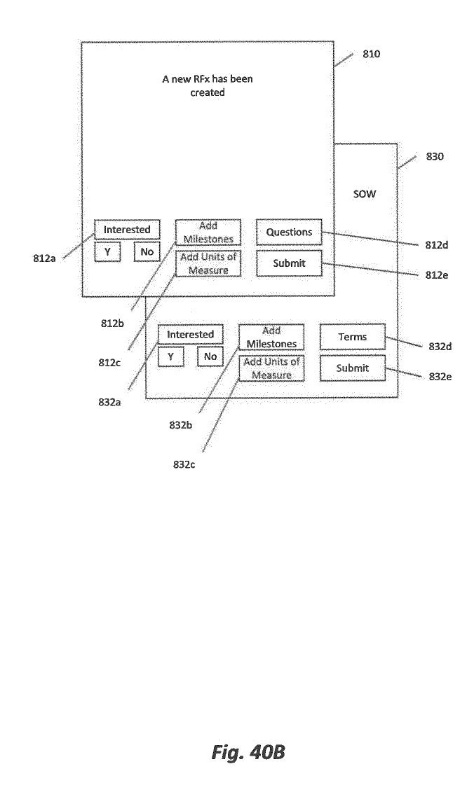

Next, FIGS. 33 and 40A illustrate the creation and release of an RFx, (request for information), to selected professionals at their respective WIPs. The WMS user creates RFx 713 with controls 712a on WMS interface 710. Controls 712b enable the WMS user to perform a talent search for qualified professionals in architecture 200 by transmitting user entered search criteria 714a as criteria data 714b to platform 300 via APIs 302. Platform 300 transmits corresponding criteria data 714c to architecture 200 which uses logic 210 to match professional profiles based on the search criteria and return them as data 715 (Professional Profile 1010 FIG. 3F). WMS user selects one or more professionals by using control 712c to release the RFx 716a which causes WMS 12 to transmit RFx data 716b to platform 300 via APIs 302. Platform 300 transmits corresponding RFx data 716c to the WIPs of the selected professionals via APIs 306. WIP 100 creates RFx 718 and notifies the selected professionals on their client devices 120 concerning the new RFX in notification 719.

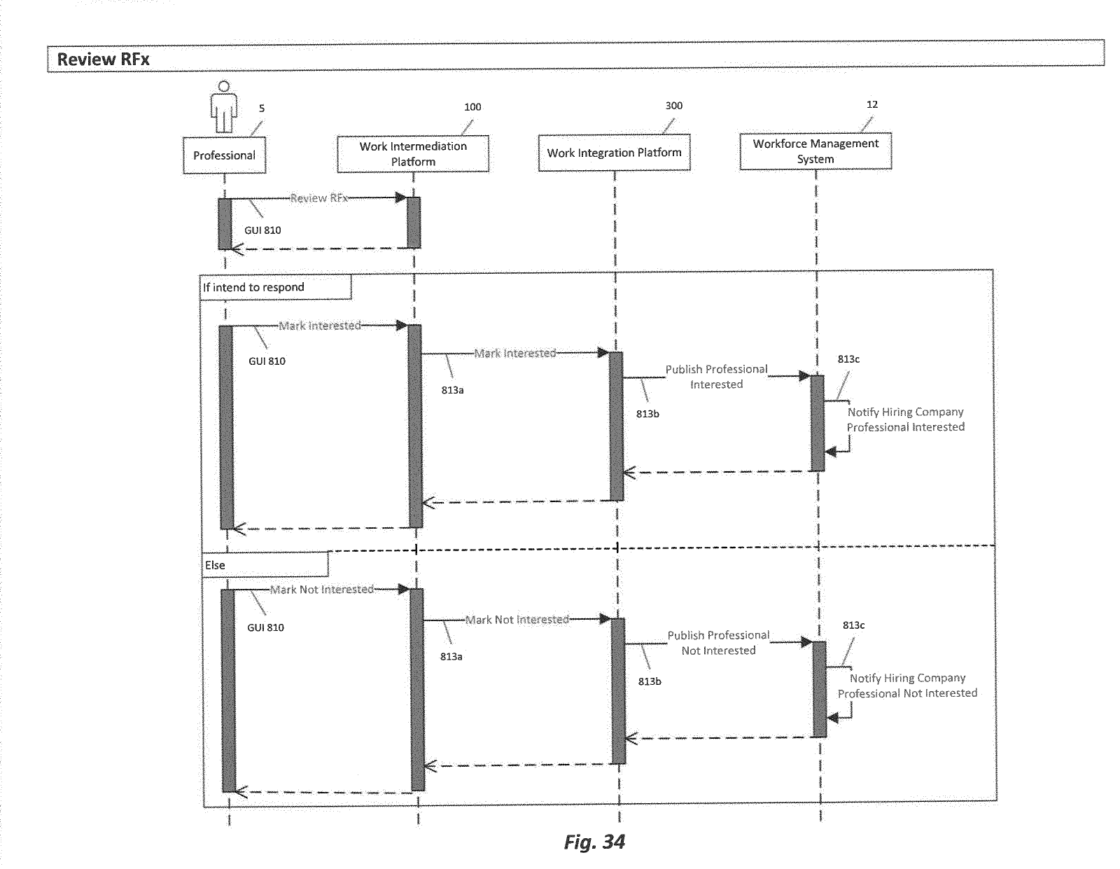

In FIGS. 34 and 40B, professional 5 uses WIP GUI 810 to review the released RFx before deciding to respond. Controls 812a are provided to enable professional 5 to indicate if they are interested or not interested. Controls 812a cause WIP 100 to transmit data 813a, indicative of the professional's interest, to platform 300 via APIs 303. Platform 300 transmits data 813b, via APIs 305, to the WMS 12 that originated the RFx. The originating WMS 12 responds by posting notification 813c on the WMS user's account to indicate the intent of the professional to respond to the RFx.

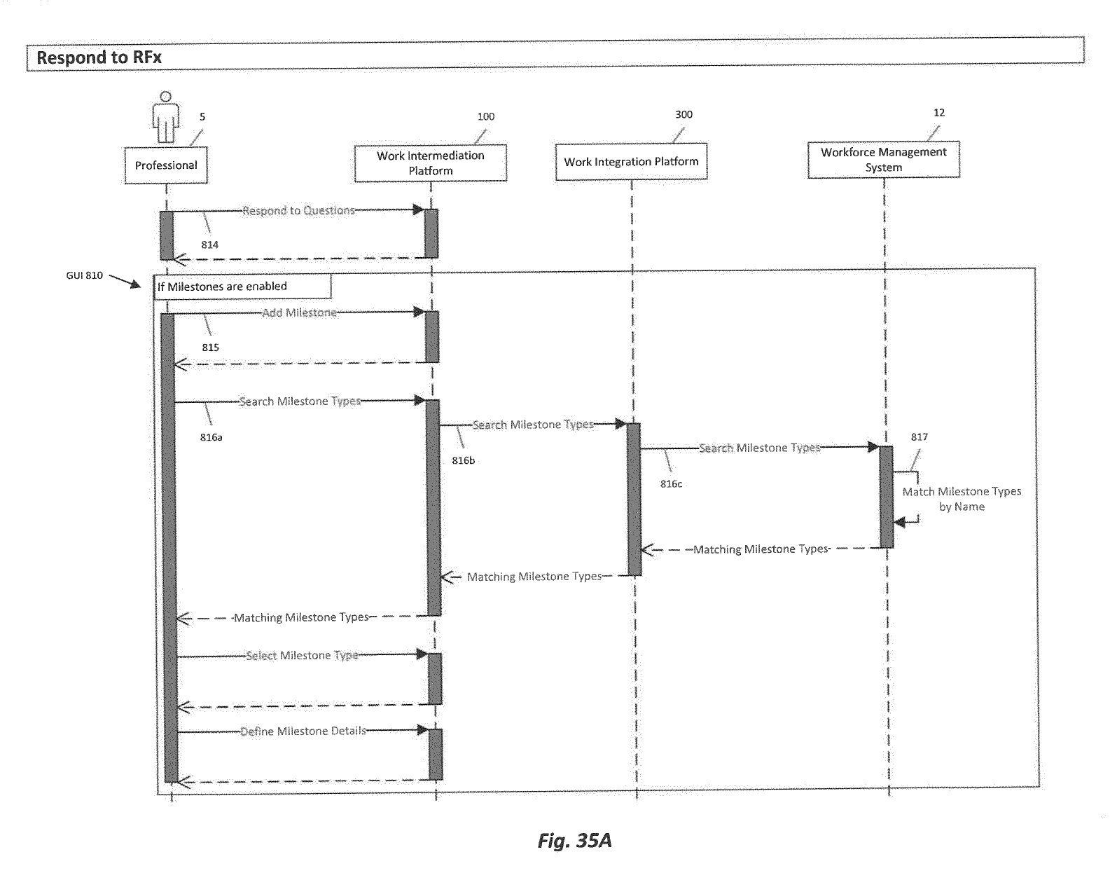

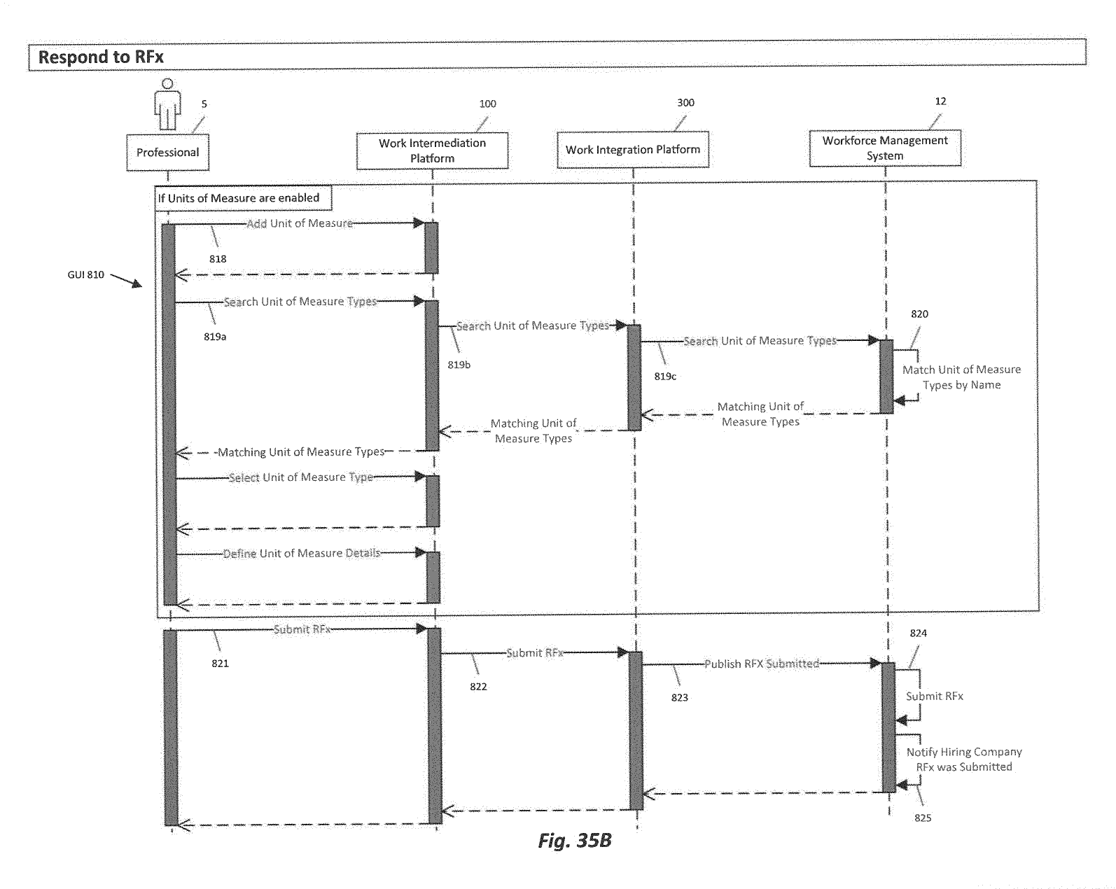

If the professional is interested in the RFx, advance is made to the process of FIGS. 35A and 35B. Controls 812d on interface 810 permit each professional to respond to general questions directly from their respective client devices 120 to their respective WIPs 100. Milestones can be a part of the selected professional's RFx reply. Through operation of controls 812b, each professional can search for milestone types by entering search data 816a into GUI 810 which causes WIP 100 to transmit data 816b to platform 300 via APIs 303. Platform 300 transmits corresponding search criteria data 816c to WMS 12, via APIs 305, where milestone types are matched to the search criteria and returned in data 817 (Milestone Type 1210 FIG. 3F). Each professional may select a milestone type and enter additional milestone details into GUI 810. Units of measure can be a part of the selected professional's RFx reply. Through operation of controls 812c, each professional can search and match unit of measure types by entering search data 819a into GUI 810 which causes WIP 100 to transmit data 819b to platform 300 via APIs 303. Platform 300 transmits the corresponding search criteria data 819c to WMS 12, via APIs 305, where milestone types are matched to the search criteria and returned in data 820 (Unit of Measure Type 1220 FIG. 3F). Each professional may select a unit of measure type and enter additional unit of measure details into GUI 810. Control 812e enables each professional to submit their RFx response 821 which causes WIP 100 to transmit data 822, representing the RFx (RFx 1180 FIG. 3F), to platform 300 via APIs 303. Platform 300 transmits data 823 to WMS 12, via APIs 305, where the RFx response 824 is submitted before the hiring company user to notify the user of the submitted RFx by notification 825.

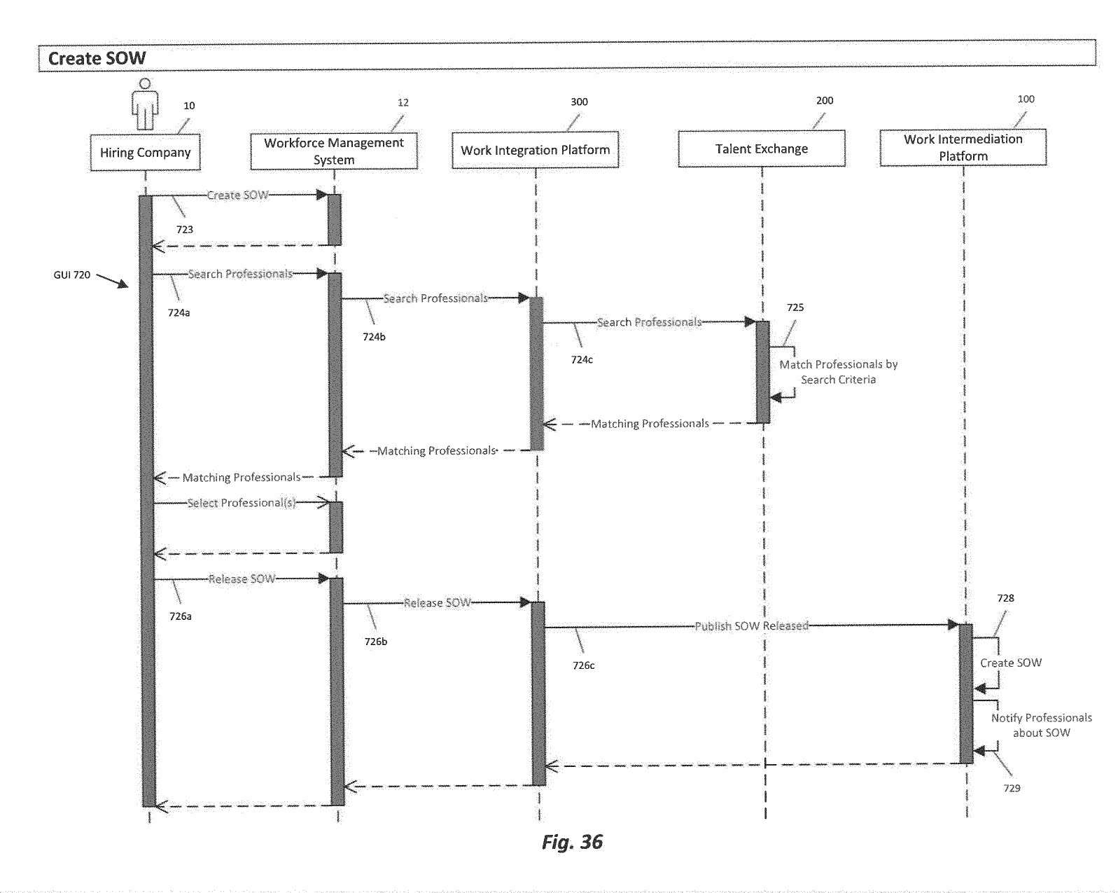

Next, FIGS. 36 and 40A illustrate the creation and release of a statement of work (SOW) to selected professionals at their respective WIPs. The WMS user creates SOW 723 with controls 722a on WMS interface 720. Controls 722b enable the WMS user to perform a talent search for qualified professionals in architecture 200 by transmitting user entered search criteria 724a as data 724b to platform 300 via APIs 302. Platform 300 transmits data 724c to architecture 200 which uses logic 210 to match professional profiles based on the search criteria and return them as profile data 725 (Professional Profile 1010 FIG. 3F). WMS user selects on one or more professionals by using controls 722c to release the SOW 726a which causes WMS 12 to transmit data 726b indicative of the SOW to platform 300 via APIs 302. Platform 300 transmits data 726c to the WIPs of the selected professionals via APIs 306. Each receiving WIP 100 creates SOW 728 and notifies the professional on their client device 120 about the new SOW by notification 729.

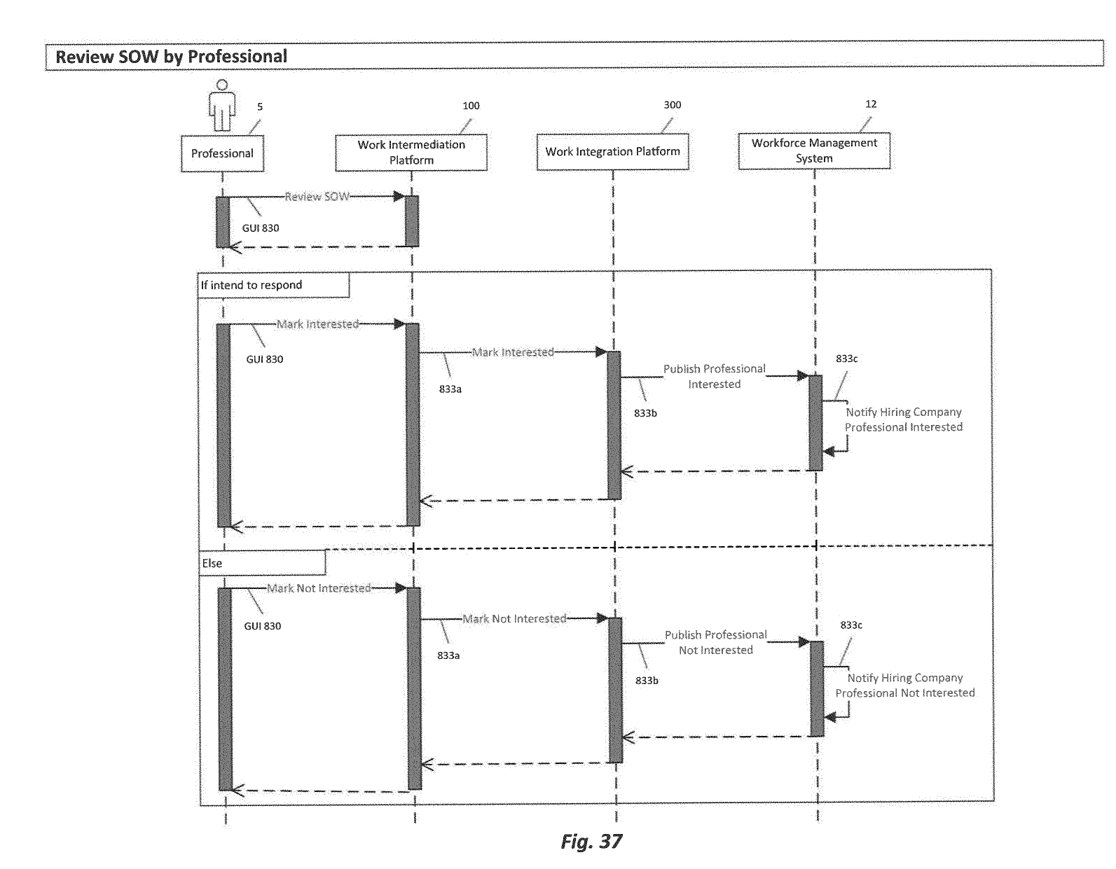

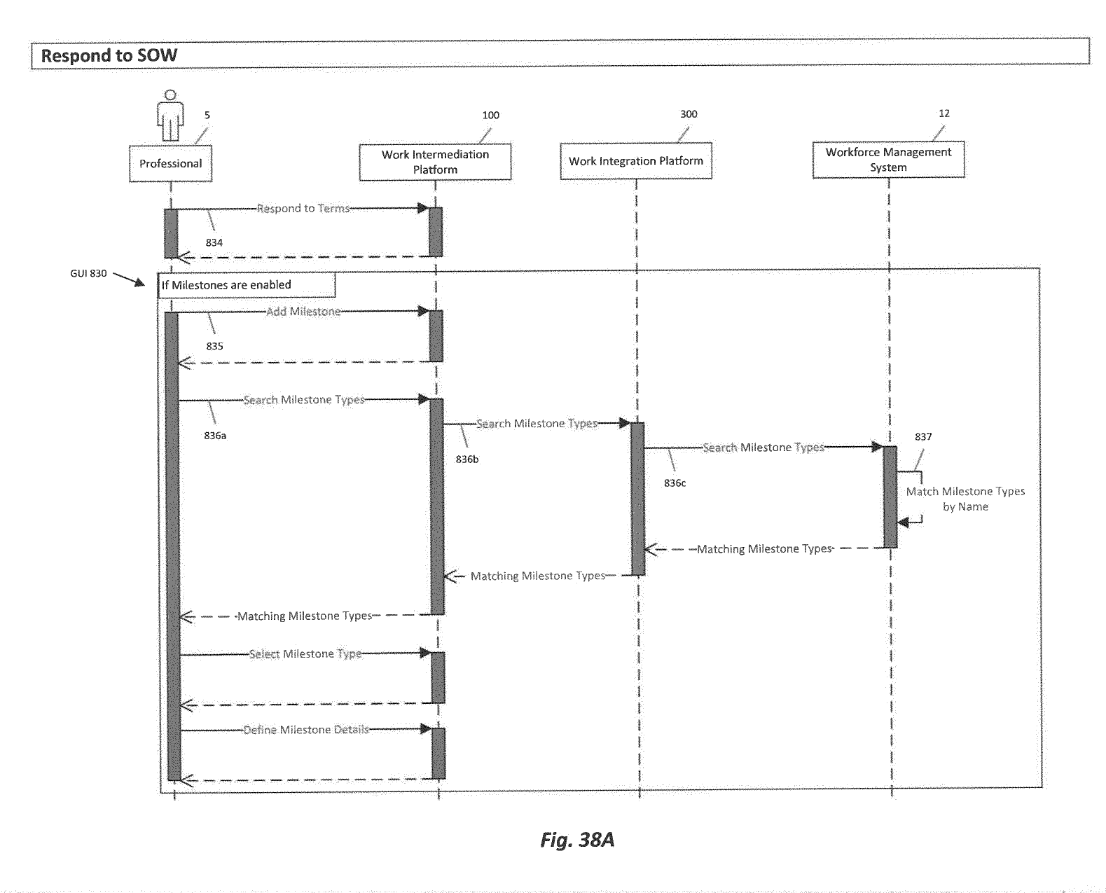

In FIGS. 37 and 40B, professional 5 uses WIP GUI 830 to review the released SOW 728 before deciding to respond. Controls 832a are provided to enable professional 5 to indicate if they are interested or not interested, and which causes WIP 100 to transmit data 833a, indicative of the professionals interest, to platform 300 via APIs 303. Platform 300 transmits corresponding data 833b, via APIs 305, to the WMS 12 that originated SOW 728. WMS 12 responds by posting notification 833c on the WMS user's account to indicate the intent of the professional to respond to the SOW.

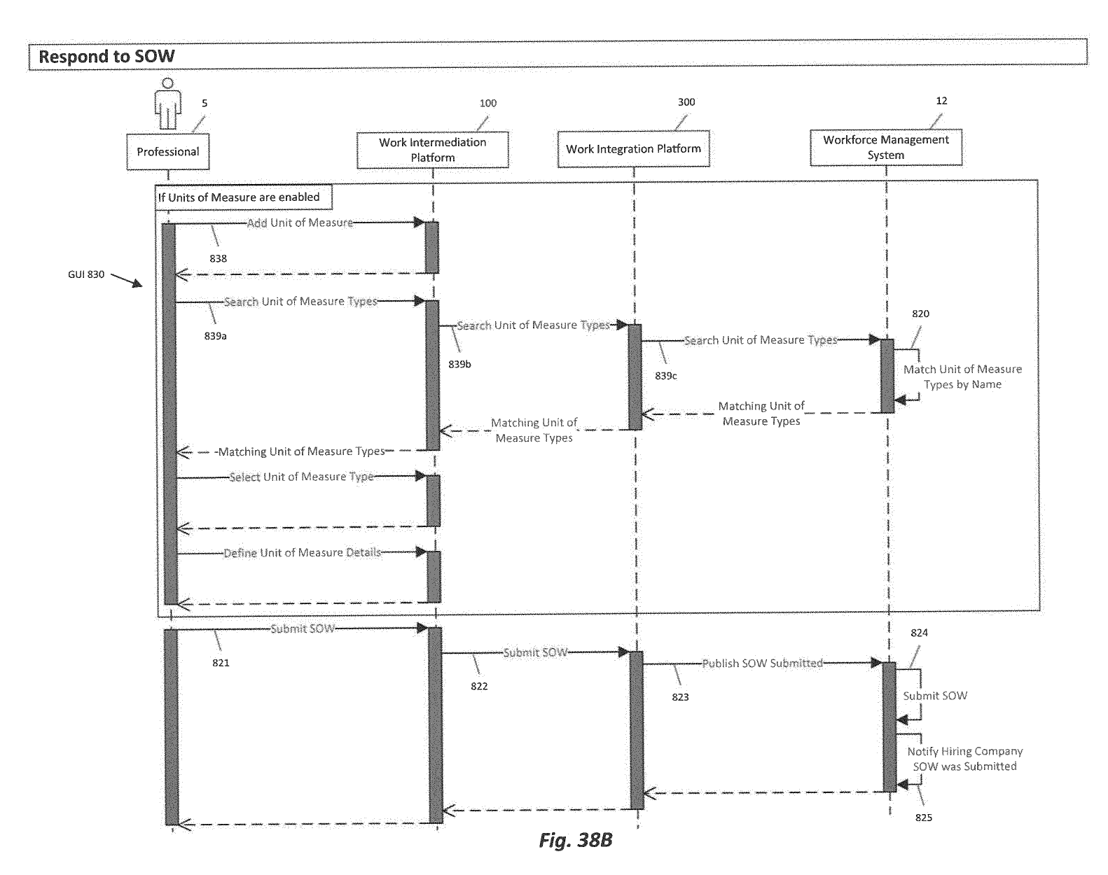

If the professional is interested in the SOW, advance is made to the process of FIGS. 38A and 38B. Controls 832d on interface 830 permit each professional to respond 834 to terms directly from their respective client devices 120 to their respective WIPs 100. As with a RFx reply, milestones can be a part of the selected professional's SOW reply. Through operation of controls 832b, each professional can search for milestone types by entering search data 836a into GUI 830 which causes WIP 100 to transmit data 836b to platform 300 via APIs 303. Platform 300 transmits the search criteria data 836c to WMS 12, via APIs 305, where milestone types are matched to the search criteria and returned in data 837 (Milestone Type 1210 FIG. 3F). Each professional may select a milestone type and enter additional milestone details into GUI 830. Units of measure 838 likewise also can be a part of the selected professional's SOW reply. Through operation of controls 832c, each professional can search and match unit of measure types by entering search data 839a into GUI 830 which causes WIP 100 to transmit data 839b to platform 300 via APIs 303. Platform 300 transmits the search criteria data 839c to WMS 12, via APIs 305, where milestone types are matched to the search criteria and returned in data 820 (Unit of Measure Type 1220 FIG. 3F). Each professional may select a unit of measure type and enter additional unit of measure details into GUI 830. Control 832e enables each professional to submit their SOW response 821 which causes their respective WIP 100 to transmit data 822 representing the SOW (SOW 1190 FIG. 3F) to platform 300 via APIs 303. Platform 300 transmits data 823 to WMS 12, via APIs 305, where the SOW response is presented 824 to the hiring company whereupon the company's user is notified about the submitted SOW in notification 825.

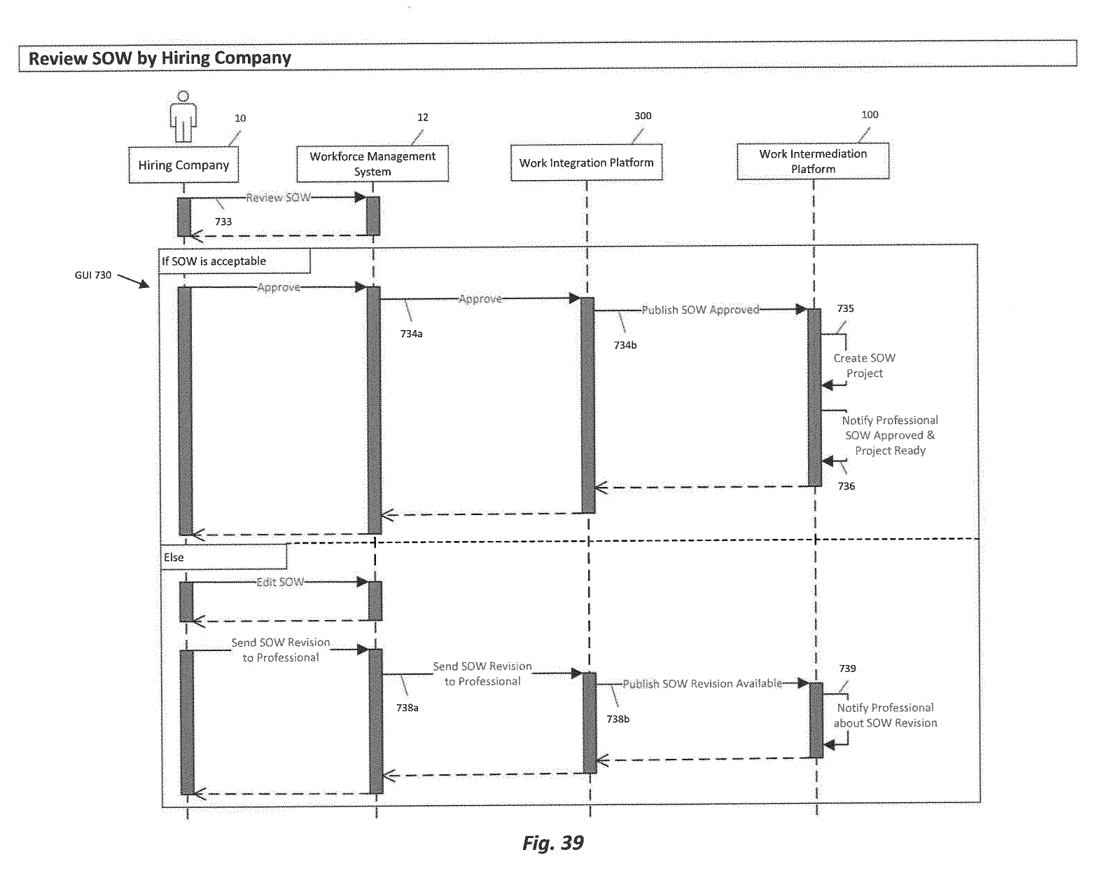

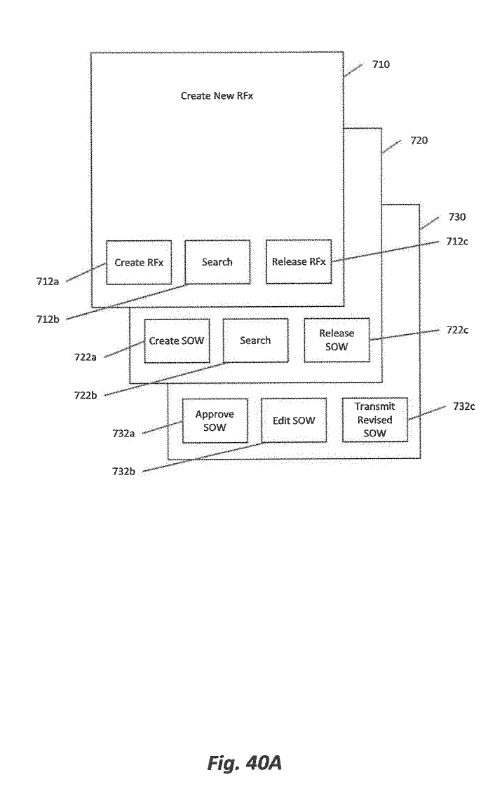

FIG. 39 illustrates further contemplated transactions in the SOW process. Here, hiring company 10 reviews an electronic SOW document 733 that was previously submitted by a professional. Thereafter, hiring company 10 calls upon interface 730 to signal its intentions via controls 732a, 732b, and 732c. Control 732a is operable to cause WMS 12 to send acceptance data 734a as engagement data to platform 300 via APIs 302. Platform 300 transmits data 734b to the submitting professional's WIP 100, via APIs 306, where the WIP creates the sow based project (SOW Project 1200) and notifies the professional with notification 735 that the SOW has been approved and the project is ready. Alternatively, if hiring company 10 is not satisfied with all of a professional's responses, controls 732b are operated to permit the WMS user to revise the SOW, whereafter controls 732c are operated to cause WMS 12 to transmit data 738a representing the revised SOW to platform 300 via APIs 302. Platform 300 transmits data 738b to the submitting professional's WIP 100, via APIs 306, where the professional is notified with notification 739 that the SOW has not been accepted and a revision is available for review.

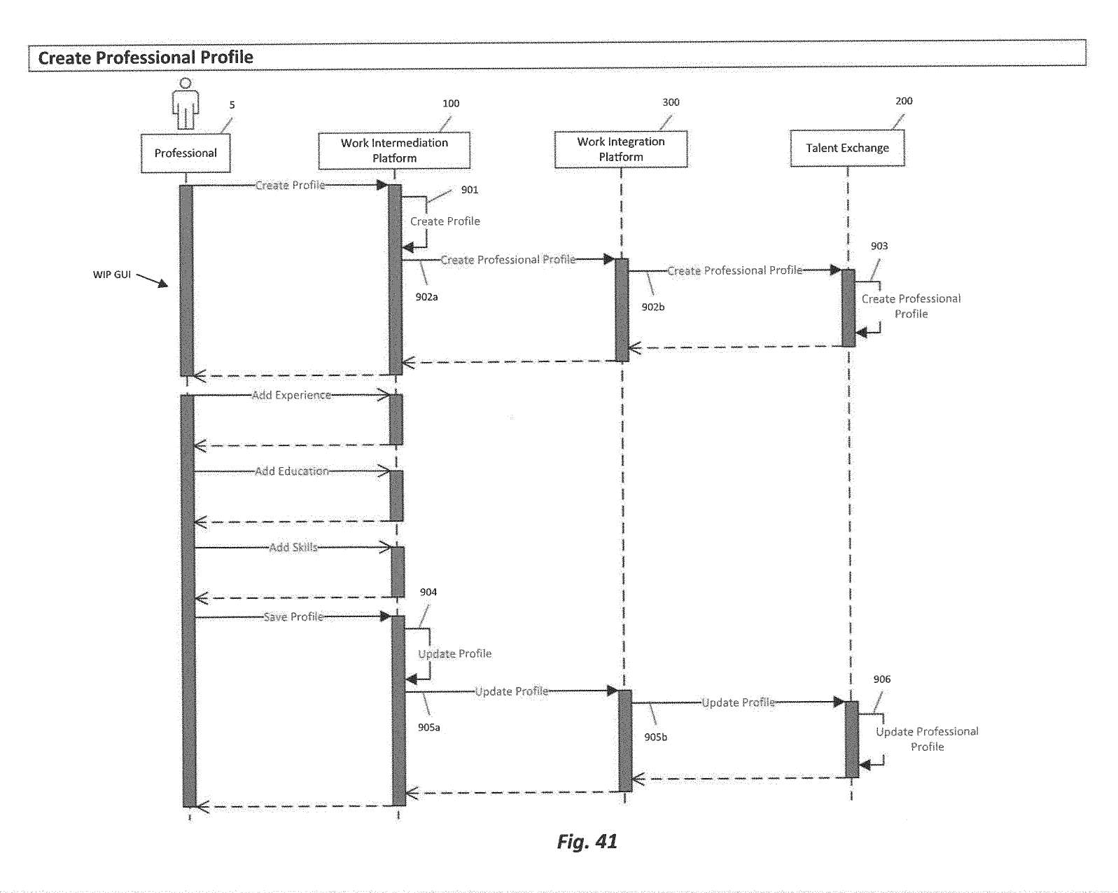

Before closing, we refer to FIG. 41 and return to creation and also updating of personal profiles from the point of view of professional 5. The present invention preferably does not disturb the professional's private interactions with his or her WIP and so each professional can establish a professional profile in their WIP 100 in accordance with their WIP's original WIP-to-client device communication protocols. Professionals who have authorized their respective WIPs to share their profile data with architecture 200 for purpose of engaging in work, cause their WIP, who is also a member of the network established by the invention, to transfer their profile data after creation 901 or updating 904 to platform 300 as profile data 902a, 905a (Professional Profile 1010 FIG. 3F) via APIs 303. Platform 300 transmits corresponding profile data 902b, 905b to architecture 200, via APIs 214, where the profile is created 903 or updated 906 in database 208.

By enabling a fully interconnected system of WMSs 12 and disparate WIPs 100, the invention improves the hiring functionality and contract management functionality contained in each member's WMS server by providing the ability to access, interact with, hire, and manage contract professionals from previously unavailable talent pools without the need to directly integrate with any WIP and without interrupting the hiring company's customary referral relationships with its authorized talent suppliers. The Work Integration Platform controller 320 and logic 315 provide additional benefit to the WMS server by abstracting any API differences in Work Integration Platform 300 and WIP communication for scenarios where, for the Platform, it is chosen to implement any part of a pre-existing WIP API specification that overlaps with APIs 303 or API specification 306S. The Talent Exchange Architecture 200, via the Sourcing Plugin 301 and Work Integration Platform 300, further expands the hiring functionality of a member's WMS server by providing the ability to match professionals from multiple member WIPs to work opportunities by the use of the Talent Exchange Architecture's logic 210 and standardization database 212. Conversely the invention improves the hiring functionality and contract management functionality contained in the each member's WIP server by providing the ability to engage in previously unavailable work opportunities from multiple member WMSs and manage their contracts without the need to directly integrate with any WMS. The Work Integration Platform controller 320 and logic 315 likewise provide additional benefit to the WIP server by abstracting any API differences in Work Integration Platform and WMS communication for scenarios where, for the Work Integration Platform, it is chosen to implement any part of a pre-existing WMS API specification that overlaps with APIs 302 or API specification 305S. Both API specifications 305S and 306S define just one set or array of APIs 305 and 306 respectively in all member WMSs and in all member WIPs, thus making a most cost-effective way of providing the desired integration through Platform 300, Plugin 301 and Architecture 200.

The foregoing embodiments and examples are illustrative rather than restrictive. Those of ordinary skill in the art will appreciate that modifications to the exemplary embodiments may be made without departing from the spirit and the scope of the invention as defined by the following claims.

What is claimed:

1. A system for selectively providing communication access in a network including the internet between plural servers respectively configured as computerized work intermediation platforms (WIPs) that are sources of profile data representative of professional profiles of individuals seeking job opportunities and a protected server configured as at least one computerized work management system (WMS) that is otherwise inaccessible to the WIPs, said system comprising:
an agent responsive to actions in filling a job opportunity by a user associated with the at least one WMS;
a talent exchange architecture hosted on a server remote from the at least one WMS and each WIP and including a profile database storing profile data sourced from the WIPs; and
an integration platform hosted on another server remote from the talent exchange architecture, the at least one WMS, and each WIP, the integration platform being responsive to:
an application programming interface (API) call from the at least one WMS by receiving engagement data or administrative data from said WMS and destined for a target one of the WIPs, and by making an API call to the target WIP to take control over hiring functionality in the server of the target WIP and transmitting the engagement or administrative data to the target WIP,
an API call from one of the WIPs by receiving engagement or administrative data from said one WIP and destined for the at least one WMS, and by making an API call to the at least one WMS to take control over hiring functionality in the server of the WMS, and transmitting the engagement or administrative data from said one WIP to the WMS, and
an API call from the agent by receiving from the agent engagement data representative of said actions by the user in filling the job opportunity, and by taking over control of the hiring functionality and display functionality of the at least one WMS to cause the WMS to display to the user, a graphical user interface (GUI) generated by the agent and representing professionals and their qualifications for fulfilling the job opportunity based upon the profile data stored in the profile database of the talent exchange architecture.

2. The system as claimed in claim 1, wherein the integration platform includes:
first API specifications offered to the said at least one WMS and to each of plural other WMSs for inclusion into membership in the network, said first API specifications defining a first sane single array of APIs when hosted by each said WMS to make said WMS a member WMS, and
second API specifications offered to each WIP for inclusion into membership in the network, said second API specifications defining a second same single array of APIs when hosted by each said to WIP make said WIP a member WIP.

3. The system as claimed in claim 2, wherein the integration platform further includes an API array associated with and callable by the agent, a single API array associated with and callable by any member WIP, and a single API array associated with and callable by any member WMS.

4. The system as claimed in claim 2,
wherein the APIs of the first array hosted by each member WMS transfers control of the hiring functionality and contract job management functionality of said each member WMS to the integration platform when called by said platform, and
wherein the APIs of the second array of APIs hosted by each member WIP transfers control of the hiring functionality and contract job management functionality of said each member WIP to said platform when called by said platform.

5. The system as claimed in claim 4, wherein the talent architecture further includes:
a work database storing job opportunity data representing plural jobs requisitioned at the at least one WMS, and
logic for comparing professional profile data from the profile database with job opportunity data from the work database and generating professional profile identification data representing professionals identified as having said qualifications necessary to fill the job opportunity.

6. The system as claimed in claim 5,
wherein the agent embeds the GUI generated thereby in native graphical user interfaces generated by the display functionality of the at least one WMS, said embedded GUI including controls operable by the WMS user to produce, as engagement data, invitation data representative of an invitation to individuals as invitees to a job opportunity, and
wherein the agent responds to user operation of said controls of said embedded GUI for producing invitation data calling said APIs of the integration platform associated with said agent and transmitting said invitation data to said platform, whereby said platform responds to said API calling and said invitation data transmitting by calling the APIs of the second array of APIs hosted on the member WIPs of all said invitees.

7. The system as claimed in claim 6, wherein the embedded GUI further includes controls operable by the WMS user to produce, as engagement data, request data including at least one of first request data representative of a request to retrieve a job opportunity, second request data representative of a request to identify talent suppliers, third request data representative of a request for retrieval of the profiles of individuals matching said job opportunity, and fourth request data representative of a keyword search request, and wherein
the agent responds to said WMS user's operation of said controls for producing said request data by calling said APIs of the integration platform associated with said agent and transmitting said request data to the platform, whereby said platform responds by:
calling said APIs in the talent exchange architecture that are associated with said platform and selectively obtaining data representative of the requested job opportunity based upon said first request data, data representative of profiles of individuals matching said job opportunity based upon said third response data, and data representative of profiles of individuals based upon said fourth request data, and
calling the APIs of the first API array in the at least one member WMS and obtaining data representative of talent suppliers based upon said second request data.

8. The system as claimed in claim 5, wherein the integration platform responds to a WIP that calls said APIs of said platform that are associated with the WIPs in order to create or update the professional profile of a job-seeking subscriber at said WIP by:
receiving professional profile data from said WIP, and
calling associated APIs in the talent exchange architecture and communicating said professional profile data from said WIP to said architecture, whereby said architecture stores said professional profile data as a profile sourced from said WIP in the profile database thereof.

9. The system as claimed in claim 4,
wherein in response to call from the at least one member WMS to the integration platform, said platform:
receives, as engagement data, at least one of data representative of the WMS user's rejection of a candidate, data representative of a request to interview an identified candidate, data representative of an offer of a job to candidate, data representative of withdrawal of an offer made to a candidate, data representative of an RFx publishable on a candidate's WIP, and data representative of a statement of work (SOW) publishable on candidate's WIP, and, as administration data, data representing onboarding, data representing change in contract job timelines, data representing contract job extension requests, data representing contract job truncation, data representing contract job termination, data representing timesheets, data representing expense reporting, and data representing payment requests, and
calls the APIs of the second array of APIs in at least one WIP to communicate said engagement data and/or said administrative data to said at least one WIP.

10. The system as claimed in claim 9, wherein in response to a call from at least one of member WIPs to the integration platform, said platform:
receives as engagement data from said at least one WIP, at least one of data representative of replies to a request for an interview, to an offer of a requisitioned job, to a published RFx and to a published SOW, and as administrative data, replies to said onboarding, change in timelines, extension request, truncation and
calls APIs of the first array in the at least one member WMS to communicate said engagement data and/or said administrative data to said WMS.

11. The system as claimed in claim 10, wherein the administration data represents timesheets and expense reports, and wherein the integration platform responds to API calls from at least one member WIP by calling APIs of the first array in the at least one member WMS to transmit to said WMS,
search data querying said WMS for data specifying at least one of projects, tasks, pay codes, cost centers, and expense types related to contract job, and
submission data representative of a completed time sheet or expense report.

12. The system as claimed in 4, wherein user actions at the at least one member WMS include creating at least one of an RFx and a statement of work (SOW), searching individuals according to search criteria based on said RFx or said SOW, and releasing said RFx or said SOW, the integration platform responding to said user actions searching individuals by calling said associated APIs in the talent exchange architecture to command said architecture to identify candidates for said RFx or SOW and to return data representative of personal profiles obtained from the profile database of said architecture to the at least one WMS, and
calling APIs, defined by the API, of the first array in at least one of the member WIPs and transmitting data representative of a created RFx or SOW to said at least one member WIPs based upon said data obtained from said profile data base.

13. The system as claimed in claim 12, wherein the integration platform responds to a call to said APIs thereof associated with the WIPs by calling APIs of the first array in the at least one member WMS to query said WMS for at least one of data specifying milestones, and data specifying unit of measure.

14. A method for selectively providing communication access in a network including the internet between plural servers respectively configured as computerized work intermediation platforms (WIPs) that are sources of profile data representative of professional profiles of individuals seeking job opportunities and a protected server configured as at least one computerized work management system (WMS) that is otherwise inaccessible to the WIPs by using a system including:
an agent responsive to actions in filling a job opportunity by a user associated with the at least one WMS;
a talent exchange architecture hosted on a server remote from the at least one WMS and each WIP and including a profile database storing profile data sourced from the WIPs; and
an integration platform hosted on another server remote from the talent exchange architecture, the at least one WMS, and each WIP, said method comprising:
at the integration platform, responding to an application programming interface (API) call from the at least one WMS by receiving engagement data or administrative data from said WMS and destined for a target one of the WIPs, and by making an API call to the target WIP to take control over hiring functionality in the server of the target WIP and transmitting the engagement or administrative data to the target WIP,
at the integration platform, responding to an API call from one of the WIPs by receiving engagement or administrative data from said one WIP and destined for the at least one WMS, and by making an API call to the at least one WMS to take control over hiring functionality in the server of the WMS, and transmitting the engagement or administrative data from said one WIP to the WMS, and
at the integration platform, responding to an API call from the agent by receiving from the agent engagement data representative of said actions by the user in filling the job opportunity, and by taking over control of the hiring functionality and display functionality of the at least one WMS to cause the WMS to display to the user, a graphical user interface (GUI) generated by the agent and representing professionals and their qualifications for fulfilling the job opportunity based upon the profile data stored in the profile database of the talent exchange architecture.

15. The method as claimed in claim 14, wherein the integration platform includes:
first API specifications offered to the said at least one WMS and to each of plural other WMSs for inclusion into membership in the network, said first API specifications defining a first same single array of APIs when hosted by each said WMS to make said WMS a member WMS,
second API specifications offered to each WIP for inclusion into membership in the network, said second API specifications defining a second same single array of APIs when hosted by each said to WIP make said WIP a member WIP,
an API array associated with and callable by the agent,
a single API array associated with and callable by any member WIP, and
a single API array associated with and callable by any member WMS.

16. The method as claimed in claim 15, using the integration platform to call
the APIs of the first array hosted by each member WMS to cause to transfer control of the hiring functionality and contract job management functionality of said each member WMS to the integration platform, and
the APIs of the second array of APIs hosted by each member WIP to cause transfer control of the hiring functionality and contract job management functionality of said each member WIP to said platform.

17. The method as claimed in claim 16, wherein the talent architecture further includes:
a work database storing job opportunity data representing plural jobs requisitioned at the at least one WMS, and
logic for comparing professional profile data from the profile database with job opportunity data from the work database and generating candidate identification data representing candidates identified as having said qualifications necessary to fill the job opportunity.

18. The method as claimed in claim 17,
wherein the agent embeds the GUI generated thereby in native graphical user interfaces generated by the display functionality of the at least one WMS, said embedded GUI including controls operable by the WMS user to produce, as engagement data, invitation data representative of an invitation to individuals as invitees to a job opportunity, and
wherein the agent responds to user operation of said controls of said embedded GUI for producing invitation data calling said APIs of the integration platform associated with said agent and transmitting said invitation data to said platform, whereby said platform responds to said API calling and said invitation data transmitting by calling the APIs of the second array of APIs hosted on the member WIPs of all said invitees.

19. The method as claimed in claim 18,
wherein the embedded GUI further includes controls operable by the WMS user to produce, as engagement data, request data including at least one of first request data representative of a request to retrieve a job opportunity, second request data representative of a request to identify talent suppliers, third request data representative of a request for retrieval of the profiles of individuals matching said job opportunity, and fourth request data representative of a keyword search request,
wherein the agent responds to said WMS user's operation of said controls for producing said request data by calling said APIs of the integration platform associated with said agent and transmitting said request data to the platform, whereby said platform responds by calling said APIs in the talent exchange architecture that are associated with said platform and selectively obtaining data representative of the requested job opportunity based upon said first request data, data representative of profiles of individuals matching said job opportunity based upon said third response data, and data representative of profiles of individuals based upon said fourth request data, and calling the APIs of the first API array in the at least one member WMS and obtaining data representative of talent suppliers based upon said second request data,
wherein in response to call from the at least one member WMS to the integration platform, said platform receives, as engagement data, at least one of data representative of the WMS user's rejection of a candidate, data representative of a request to interview an identified candidate, data representative of an offer of a job to candidate, data representative of withdrawal of an offer made to a candidate, data representative of an RFx publishable on a candidate's WIP, and data representative of a statement of work (SOW) publishable on candidate's WIP, and, as administration data, data representing onboarding, data representing change in contract job timelines, data representing contract job extension requests, data representing contract job truncation, data representing contract job termination, data representing timesheets, data representing expense reporting, and data representing payment requests, and calls the APIs of the second array of APIs in at least one WIP to communicate said engagement data and/or said administrative data to said at least one WIP, and
wherein in response to a call from at least one of member WIPs to the integration platform, said platform receives as engagement data from said at least one WIP, at least one of data representative of replies to a request for an interview, to an offer of a requisitioned job, to a published RFx and to a published SOW, and as administrative data, replies to said onboarding, change in timelines, extension request, truncation, and calls APIs of the first array in the at least one member WMS to communicate said engagement data and/or said administrative data to said WMS.

20. The method as claimed in claim 18, wherein the integration platform responds to a WIP that calls said APIs of said platform that are associated with the WIPs in order to create or update the professional profile of a job-seeking subscriber at said WIP by:
receiving professional profile data from said WIP, and
calling associated APIs in the talent exchange architecture and communicating said professional profile data from said WIP to said architecture, whereby said architecture stores said professional profile data as a profile sourced from said WIP in the profile database thereof.
